(19) United States
(12) Patent Application Publication
(10) Pub. No.: US 2009/0271283 A1
(43) Pub. Date: Oct. 29, 2009

(54) Network Media Distribution

(75) Inventors: Fred M. Fosnacht, Overland Park, KS (US); Terry R. Ecklund, Overland Park, KS (US); Derek R. Gathright, Kansas City, MO (US)

Correspondence Address: MERCHANT & GOULD PC, P.O. BOX 2903, MINNEAPOLIS, MN, 55402-0903, US

(73) Assignee: CATHOLIC CONTENT, LLC, Lenexa, KS (US)

(21) Appl. No.: 12/371,222

(22) Filed: Feb. 13, 2009

Related U.S. Application Data
(60) Provisional application No. 61/028,381, filed on Feb. 13, 2008.

(51) Int. Cl. G06Q 99/00; G06Q 30/00; G06Q 50/00; G06Q 20/00; G06F 17/30; G06F 3/048; G06F 15/16

(52) U.S. Cl. 705/26; 705/1; 705/40; 707/104.1; 715/760; 709/204; 707/3; 707/E17.014; 707/E17.044

(57) ABSTRACT

A network media distribution system includes a web server. The web server generates web data defining a plurality of web pages of a web site. Media items are stored on a media database which is accessible to the web server. The web server distributes the media items through the web site. In one example embodiment the media distribution system includes both user generated content that is distributed for free and content provided by publishers that is distributed for a fee. Methods are also disclosed.

### CROSS REFERENCE TO RELATED APPLICATIONS

This application claims priority to U.S. Provisional Patent Application No. 61/028,381 filed on Feb. 13, 2008, entitled NETWORK MEDIA DISTRIBUTION, the disclosure of which is incorporated by reference herein in its entirety.

### BACKGROUND

Increased network communication rates have made it convenient to distribute various types of media across networks such as the Internet. Various media-based web sites have become popular.

Some web sites are focused on the distribution of user-generated and uploaded content. An example is YouTube (www.youtube.com), which distributes videos that are typically generated and uploaded by users. Another example is Flickr (www.flickr.com), which distributes digital photographs that are typically generated and uploaded by users. Many such web sites do not charge users for access to the media.

Other web-based media distribution is focused toward distribution of content from commercial publishers for a fee. One example is iTunes R by Apple, Inc., through which users can purchase and download audio and video from commercial publishers.

Social networking web sites have also become popular. Examples include myspace (www.myspace.com) and facebook (www.facebook.com). These web sites often include user-generated content, such as text, digital photographs, and sometimes video.

### SUMMARY

Embodiments of the present disclosure generally relate to distribution of media across a network. Such media includes audio, video, visual, audio-visual, multimedia, interactive media, documents, spreadsheets, databases, and any other type of media capable of being represented in digital form. In one exemplary embodiment, a media distribution system distributes media oriented to a particular vertical group of users, such as users interested in exploring the rich traditions of the Catholic faith.

One aspect is a media distribution system for distributing media items across a data communication network, the system comprising: a media database device storing media items received from a publisher including at least a publisher media item and storing media items received from at least one user including at least one user generated media item; and a web server device including a processor and memory, the memory containing computer executable instructions, which when executed by the processor cause the processor to generate web page data and to communicate the web page data across the data communication network, the web server being communicatively connected to the media database, wherein the web page data generated by the processor defines at least a first media web page directed to the publisher media item and a second web page directed to the user generated media item.

Another aspect is a method of generating web page data associated with media items, the method comprising: associating a user with a first segment identifier of a plurality of segment identifiers using a web server device, the plurality of segment identifiers being associated with distinct segments of a vertical group of users; and generating web page data with the web server using the segment identifier, the web page data identifying at least one media item available from the web server.

Yet another aspect is a method of distributing media items across a network, the method comprising: packaging a plurality of media items into a single file as a kit, the plurality of media items including a first media item from a first publisher and a second media item from a second publisher; generating a web page with a web server, the web page including information about the kit; receiving payment information from a user to purchase the kit with a payment processing module; sending the kit after receiving payment with a download module; and making royalty payments to the first publisher and to the second publisher with a royalty payment module.

A further aspect is a method of identifying a media item, the method comprising: storing a plurality of media items in a media database device; associating Catholic identifiers with the plurality of media items in the media database device; prompting a user to select at least one of the plurality of Catholic identifiers from a list of the plurality of Catholic identifiers; receiving the input; and searching through the plurality of media items in the media database device to locate media items associated with the input by comparing the input to the plurality of Catholic identifiers associated with the plurality of media items.

This summary is provided to introduce a selection of concepts in a simplified form that are further described below in the detailed description. This summary is not intended to identify key or essential features of the claimed subject matter, nor is it intended to be used in any way as to limit the scope of the claimed subject matter.

### BRIEF DESCRIPTION OF THE DRAWINGS

This disclosure will now more fully describe exemplary embodiments with reference to the accompanying drawings, in which specific embodiments are shown. Other aspects may, however, be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

FIG. 1 is a block diagram of an exemplary media distribution system.

FIG. 2 is an exemplary computing system for implementing aspects of the present disclosure.

FIG. 3 is a screen shot of an exemplary login page of a web site.

FIG. 4 is a screen shot of an exemplary welcome page of the web site of FIG. 3.

FIG. 5 is a screen shot of an exemplary MyHome page of the web site of FIG. 3.

FIG. 6 is an enlarged screen shot of the featured media section of the MyHome page shown in FIG. 5.

FIG. 7 is a screen shot of an exemplary media page of the web site of FIG. 3.

FIG. 8 is a screen shot of another exemplary media page of the web site of FIG. 3.

FIG. 9 is a screen shot of an exemplary media browsing page of the web site of FIG. 3.

FIG. 10 is a screen shot of an exemplary content centered community page of the web site of FIG. 3.

FIG. 11 is a screen shot of an example visitor home page of another example web site according to the present disclosure.

FIG. 12 is a screen shot of an example new user registration page of the example web site of FIG. 11.

FIG. 13 is a screen shot of an example home page of the example web site of FIG. 1.

FIG. 14 is a screen shot of the ticker zone of the example home page shown in FIG. 13.

FIG. 15 is a screen shot of a portion of the home page shown in FIG. 13.

FIG. 16 is a screen shot of an example media browsing page of the example web site of FIG. 1.

FIG. 17 is a screen shot of an example header of the media browsing page shown in FIG. 16.

FIG. 18 is a screen shot of the browsing section of the example media browsing page shown in FIG. 16.

FIG. 19 is a screen shot of an example media page of the example web site of FIG. 1.

FIG. 20 is a screen shot of a portion of the media page shown in FIG. 19.

FIG. 21 is a screen shot of another example media page of the example web site of FIG. 1.

FIG. 22 is a screen shot of another example media page of the example web site of FIG. 1.

FIG. 23 is a screen shot of another example media page of the example web site of FIG. 11.

FIG. 24 is a screen shot of another example media page of the example web site of FIG. 11.

FIG. 25 is a schematic block diagram of another example media page of the example web site of FIG. 1.

FIG. 26 is a screen shot of an example group browsing page of the example web site of FIG. 1.

FIG. 27 is a screen shot of an example group login page of the example web site of FIG. 1.

FIG. 28A is a screen shot of an example group page of the example web site of FIG. 1.

FIG. 28B is another screen shot of the example group page shown in FIG. 28A.

FIG. 28C is another screen shot of the example group page shown in FIG. 28A.

FIG. 29 is a screen shot of a sub-group formation module of the example web site of FIG. 1.

FIG. 30A is another screen shot of the sub-group formation module shown in FIG. 29.

FIG. 30B is another screen shot of the sub-group formation module shown in FIG. 29.

FIG. 31 is another screen shot of the sub-group formation module shown in FIG. 29.

FIG. 32 is a screen shot of another example group page of the example web site of FIG. 1.

FIG. 33 is a screen shot of an example blog page of the example web site of FIG. 1.

FIG. 34 is an example blog administration page of the example web site of FIG. 1.

FIG. 35 is a screen shot of an example user profile page of the example web site of FIG. 1.

FIG. 36 is a simplified Venn diagram illustrating segmentation of a vertical group of users according to the present disclosure.

FIG. 37 is a flow chart illustrating a method of customizing a web site.

FIG. 38 is a screen shot of an example snapshot display of the example web site of FIG. 11.

FIG. 39 is a flow chart illustrating an example method of distributing a plurality of media items as a kit.

FIG. 40 is a flow chart illustrating another example method of distributing a plurality of media items as a kit.

FIG. 41 is a screen shot of an example upload page of the example web site of FIG. 11.

FIG. 42 is a screen shot of an example media editing page of the example web site of FIG. 11.

FIG. 43 is a screen shot of an example snack page of the example web site of FIG. 11.

FIG. 44 is a screen shot of an example dessert definition page of the example web site of FIG. 11.

FIG. 45 is an example of a thumbnail definition page 4500 of the example web site of FIG. 11.

FIG. 46 is a combined block diagram and flow chart illustrating a method of tagging an item to convert the item from user generated content to publisher content according to the present disclosure.

FIG. 47 is a screen shot of an example Resource Center according to the present disclosure.

FIG. 48 is a screen shot of an example media browsing page of the Resource Center of FIG. 47.

### DETAILED DESCRIPTION

With the increase in network transmission rates and vast increases in data storage capabilities, the amount of information and content available on the Internet has become enormous. The volume of available information has become a problem. For example, a user of a media site such as YouTube may find it very difficult to find desired content because it is buried among such a large volume of undesired content.

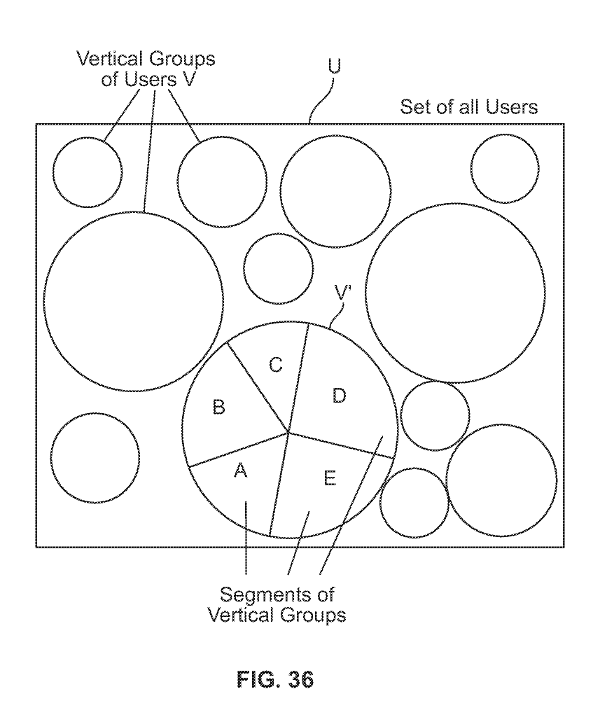

Some embodiments according to the present disclosure address this issue by providing a media distribution system that is directed toward a particular vertical group of users. A vertical group of users is a subset of a full group of users as discussed more fully herein with reference to FIG. 36. In some embodiments the vertical group shares a common interest or other characteristic. A media distribution system that is tailored to the vertical group is designed and structured to meet the specialized preferences of that group. Similarly, media content distributed by the media distribution system is typically related to the shared interest of the vertical group.

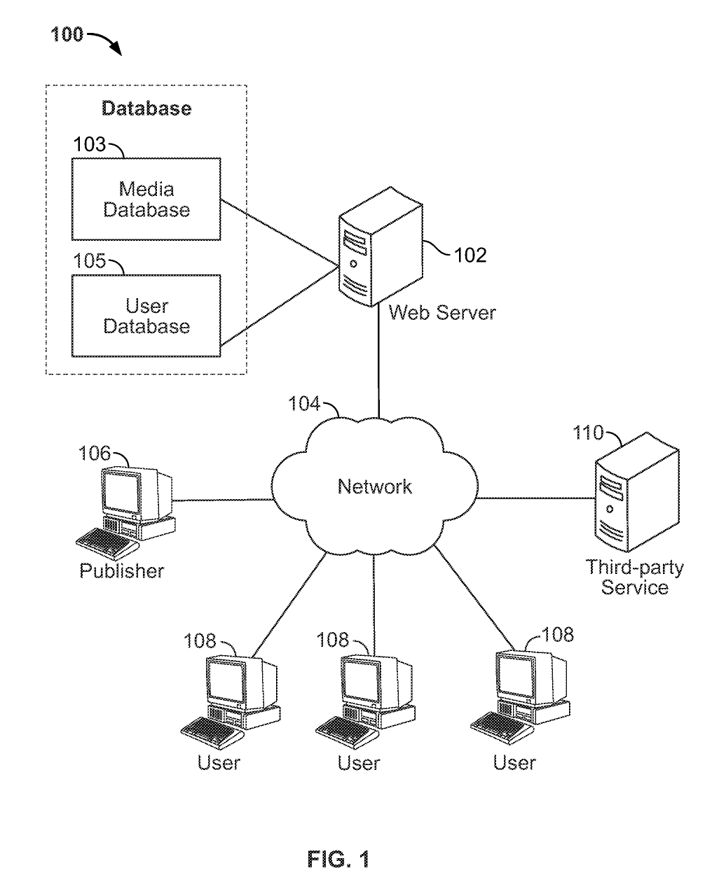

FIG. 1 is a block diagram of an exemplary media distribution system 100. Media distribution system 100 includes web server 102, network 104, publisher computing system 106, user computing systems 108, and third-party service computing system 110.

Web server 102 is a computing system that is in data communication with network 104. Web server 102 receives requests from network 104 and sends responses to the requests across network 104. In this way, web server 102 is capable of communicating with publisher computing system 106, user computing systems 108, and third-party service computing systems 110. Some embodiments include multiple Web servers 102.

Web server 102 includes media database 103. In some embodiments, media database 103 is stored in memory of web server 102, or in removable or non-removable storage of web server 102. In another embodiment, media database 103 is a database server that is in data communication with web server 102. Media database 103 stores digital data including a plurality of media items, such as audio recordings, video recordings, or other digital media. In some embodiments, media database 103 stores digital media using a group-specific data model, such as a Catholic data model. The group-specific data model enables media database 103 to store information about media items and relationships between media items in a manner that allows media items to be quickly and easily located according to particular characteristics of the group. Group-specific data models are described in more detail herein.

In some embodiments media database 103 includes a database portion where metadata and links to media items are stored and a separate file system portion where the media items themselves are stored. Media item identifiers are used to connect media items in the file system with the metadata in the database.

Web server 102 also includes user database 105. In some embodiments, user database 105 is stored in memory of web server 102, or in removable or non-removable storage of web server 102. Privacy is a major concern when storing user data. As a result, user database 105 is maintained in a database that is secured against unauthorized access. For example, user names and passwords are required for a user to access user data. Furthermore, user data is carefully protected in conformance with a Terms Of Use agreement and a Privacy Policy. For example, user data is not shared with third parties. In some embodiments some user data is displayed on a public user profile page. However, user data is used in some situations to enhance the user's experience, such as to provide more relevant content, or by customizing the display of various web site pages according to information contained in user data.

Network 104 is a data communication network that communicates digital data from one computing system to another computing system. One example of a suitable network 104 is the Internet. Network 104 can also include other networks, such as a Local Area Network, a Wide Area Network, a Wireless Network, a conventional telephone service, an Intranet, and an Extranet. One or more data communication protocols are used to communicate the digital data, such as the Transmission Control Protocol and the Internet Protocol.

Publisher computing system 106 is a computing system through which a commercial publisher communicates with network 104. In some embodiments, publisher computing system 106 is a Web server. In other embodiments, publisher is a computing system, such as a personal computer or a handheld computer. Publisher computing system 106 includes multiple computing systems in some embodiments. Further, media distribution system 100 includes multiple publishers using multiple publisher computing systems 106 in some embodiments.

User computing system 108 is a computing system through which a user communicates with network 104. In some embodiments user computing system 108 is a personal computer, a laptop computer, a tablet computer, a handheld computer, a personal digital assistant, a cell phone, or other digital devices configured to communicate digital data across network 104.

Third-party service computing system 110 is a computing system through which a third-party provides a service involving network 104. In some embodiments, third-party service computing system 110 is a Web server. In other embodiments, third-party service computing system 110 is a personal computer or other computing device configured to communicate digital data across network 104. Examples of Third-party services include third-party web servers that provide web sites, such as facebook (www.facebook.com), myspace (www.myspace.com), twitter (www.twitter.com), or other third-party services.

In some embodiments, Web server 102 stores and transmits web site data. The web site data is requested by a computing system, such as user computing system 108. In response to the request, web server 102 transmits the web site data to user computing system 108 across network 104. The web site data is received by user computing system 108, which processes the data using a browser software application, such as the INTERNET EXPLORER® internet browser by Microsoft Corporation, or other browser applications. The browser operates to display a user interface at user computing system 108 to display the web site to the user. In other embodiments, web site data is provided by Web server 102 to a publisher computing system 106 or other administrators where it is displayed on a user interface.

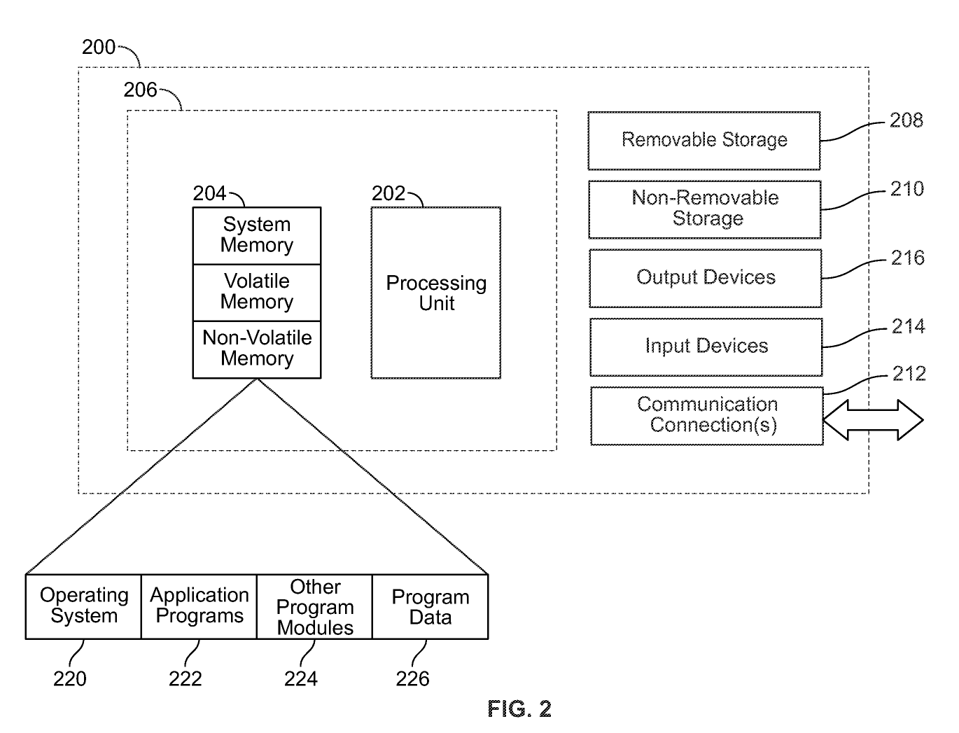

FIG. 2 is an exemplary computing system 200 for Web server 102 (shown in FIG. 1) for implementing aspects of the present disclosure. Although computing system 200 is illustrated and described as an example of Web server 102, computing system 200 is also an example of a suitable publisher computing system 106, user computing system 108, and third-party service computing system 110 (all shown in FIG. 1).

In its most basic configuration, computing system 200 typically includes at least one processing unit 202 and memory 204. Depending on the exact configuration and type of computing system, memory 204 may be volatile (such as RAM), non-volatile (such as ROM, flash memory, etc.) or some combination of the two. This most basic configuration is illustrated in FIG. 2 by dashed line 206. Additionally, computing system 200 may also have additional features/functionality. For example, computing system 200 may also include additional storage (removable and/or non-removable) including, but not limited to, magnetic or optical disks or tape. Such additional storage is illustrated in FIG. 2 by removable storage 208 and non-removable storage 210.

Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by computing system 200. Any such computer storage media may be part of computing system 200.

Computing system 200 may also contain communications connection(s) 212 that allow the computing system to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Computing system 200 may also have input device(s) 214 such as keyboard, mouse, pen, voice input device, touch input device, etc. Output device(s) 216 such as a display, speakers, printer, etc. may also be included. All these devices are well known in the art and need not be discussed at length here.

In some embodiments, memory 204 includes one or more of operating system 220, application programs 222, other program modules 224, and program data 226.

Examples of a possible computing system 200 includes a server computer, a server farm or cluster, a personal computer, a laptop computer, a handheld computer, a tablet computer, a personal digital assistant, a mobile phone, or other processing device configured to communicate digital data across a communication network.

In some embodiments, web server 102 includes a database of media items stored in computer storage media. The database includes a plurality of media items, such as videos, audio recordings, images, and possibly other media items. The database also stores metadata and relational data associated with the media items that allows particular media items to be quickly and easily located by a user. The metadata includes a group-specific data model.

One example of a group-specific data model is a Catholic data model. Catholic media is able to be associated with various Catholic-specific topics or identifiers that are not typically used to identify non-Catholic media. A Catholic data model allows users to quickly locate media items that are related to Catholic-specific topics.

A possible embodiment of a Catholic data model allows media items to be associated with various Catholic topics, such as liturgical dates; Bible books, chapters, and verses; Catholic catechisms, Catholic feasts, liturgical readings, masses and types of masses, sacraments, Catholic seasons, and by other topics and categories. In addition, some embodiments allow users to create user-defined tags to associate media items with additional topics that are relevant to specific groups or individuals.

In further possible embodiments, the group-specific data model also stores information to associate media items with type of user or segment of a group of users that is likely to appreciate the media item. In some embodiments, web server 102 stores statistical data regarding the users that access or purchase particular media items, and uses the data to determine characteristics of users that typically are interested in the media items. Web server 102 then uses this data to make media recommendations to a user based on one or more of the user's characteristics. In other embodiments, web server 102 stores data regarding a segment of a group of users (described in more detail herein) that are likely to appreciate or likely to purchase the media item. The data is defined by users or administrators in some embodiments, and is automatically generated by monitoring user statistics in other embodiments.

Web server 102 uses the group-specific data model to perform searches for topics or keywords identified by a user. A quick search feature receives a set of key words from a user, which the web server 102 uses to locate media items associated with the key words. An advanced search feature allows the user to define specific group-specific topics. For example, an advanced search can be conducted to find all media items associated with the book of Genesis. Another advanced search can be conducted to find all media items associated with a particular Catholic sacrament. Another advanced search can be conducted to find all media related to a specific day in the Catholic liturgical calendar. Yet other searches can be conducted to search for media associated with multiple group-specific topics.

Other group-specific data models are used in other embodiments, such as a data model for the Christian community as a whole, for other religions, or for non-religious communities, such as political groups, hobby groups, community organizations, governmental organizations, or other groups.

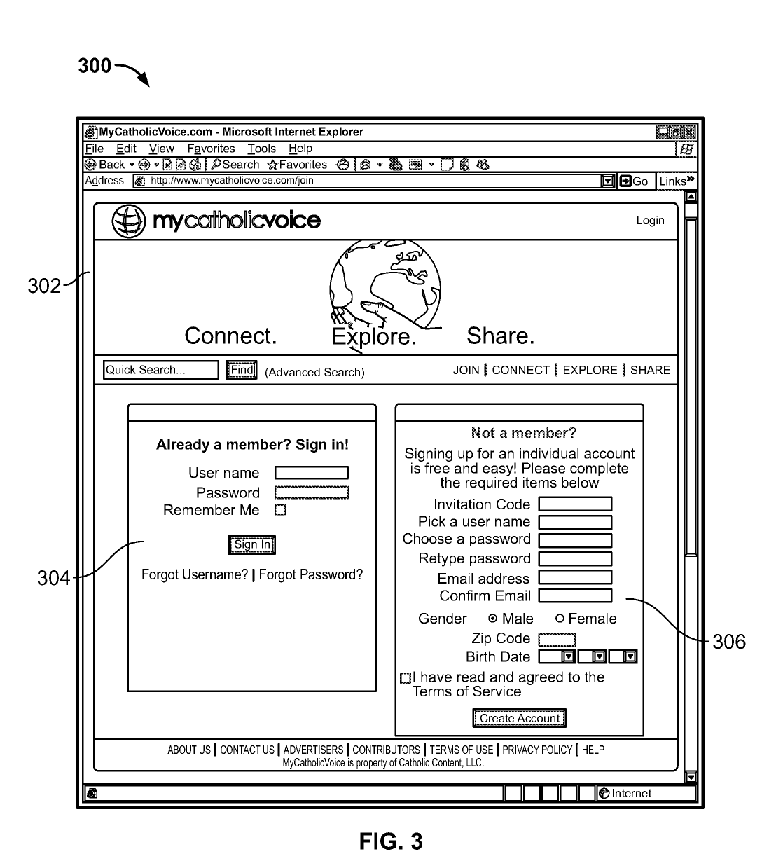

FIGS. 3-10 are screen shots of an exemplary web site 300 defined by web site data from Web server 102 (as shown in FIG. 1), transmitted across network 104, and displayed by user computing system 108 using a browser software application.

FIG. 3 is a screen shot of an exemplary login page 302 of the web site 300. Login page 302 includes member section 304 and non-member section 306. Member section 304 instructs the user to enter the unique username and password if the user is already a member. If not, non-member section 306 instructs the user to sign up for a membership, by completing registration fields.

Member section 304 includes a username field, a password field, and a sign in button. If the user has previously registered, the user enters the username and password that was previously assigned into the respective fields, and then selects the sign in button. The username and password are then sent to the Web server, which determines whether the username and password are valid. If so, the Web server allows the user to access additional features of the web site. If not, the user is again prompted to enter the username and password.

Non-member section 306 includes a variety of fields in which the user can select a user name and password, and provide personal information, such as a name, e-mail address, gender, zip code, birth date, and any other desired information. Non-member section also requires the user to review the Terms of Service, and to indicate acceptance of the terms. Once the non-member section 306 has been completed by the user, the create account button is selected. The information is then transmitted to the Web server, which sets up the account. In some embodiments, Web server requires the user to validate the email address provided, by sending an e-mail to the user and requiring them to respond or type in a code provided in the e-mail message. Other known log in or registration processes are used in other embodiments.

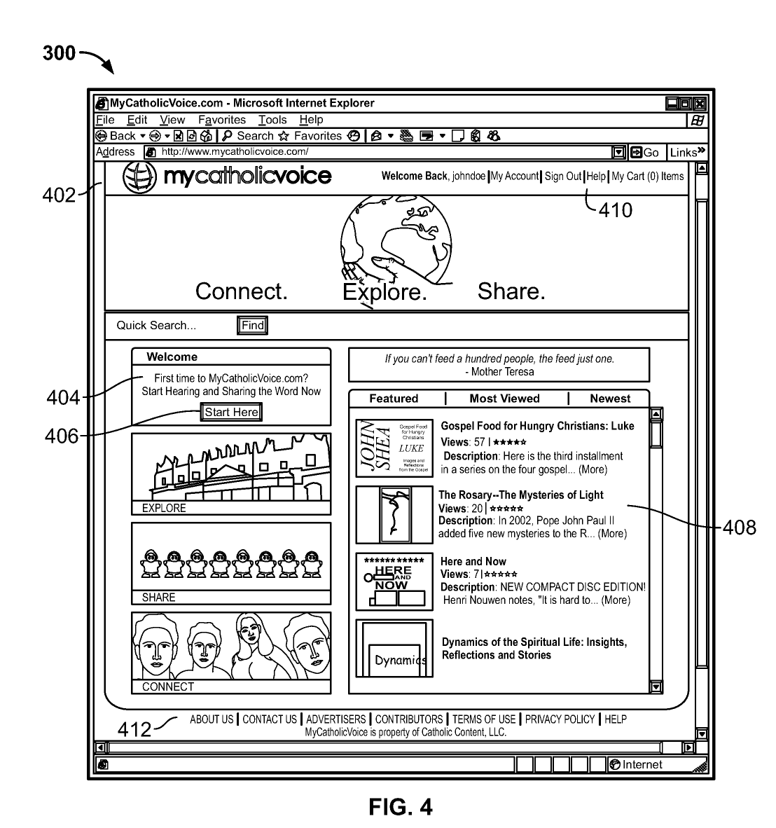

FIG. 4 is a screen shot of an exemplary welcome page 402 of web site 300. Welcome page 402 is an optional first page that is displayed to the user after a user has logged in to the web site. Welcome page 402 includes welcome section 404 and media section 408.

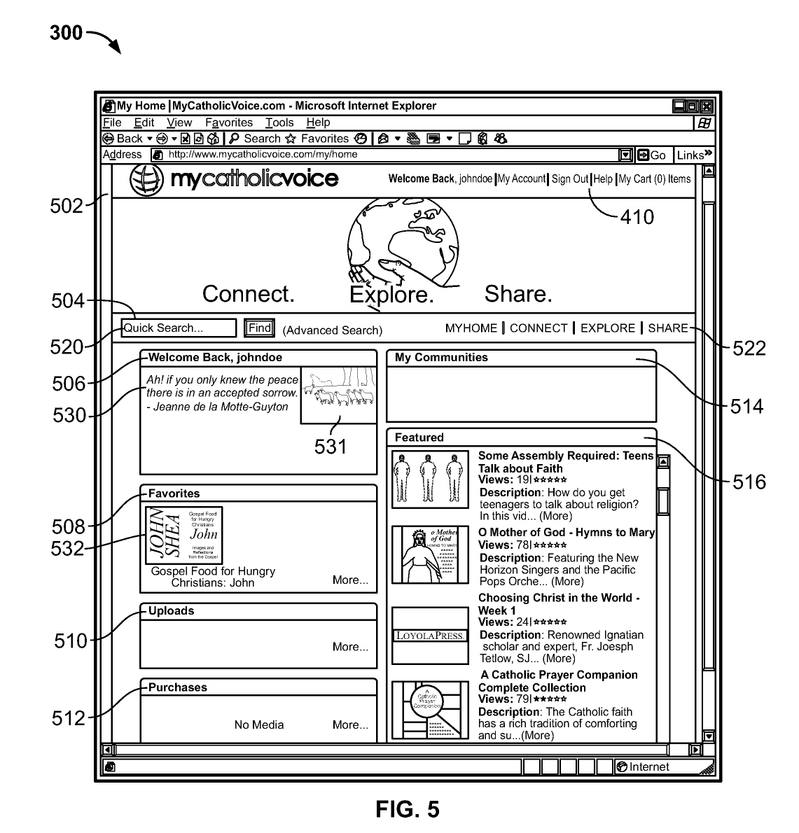

Welcome section 404 is used to display a message to the user. In this example, the welcome section 404 asks the user whether it is their first time to the web site, and if so, provides a Start Here button 406 that the user can select. In some embodiments, when the user selects Start Here button 406, a brief tutorial is displayed to introduce the user to the features and content available on the web site. In another embodiment, the Start Here button 406 brings the user to the MyHome page, as shown in FIG. 5.

Welcome page 402 also includes media section 408. Media section 408 includes a featured tab, most viewed tab, and a newest tab. If the featured tab is selected, welcome page 402 displays a set of featured content in media section 408. This is also the default tab. If the most viewed tab is selected, welcome page 402 displays a set of the most viewed content, arranged in an order from the content that has been viewed the most to the content that has been viewed the least. If the newest tab is selected, then welcome page 402 displays a set of the content that was most recently added, arranged in an order from the newest content to the oldest content.

In this example, a set of links 410 are arranged toward the top of welcome page 402. Links 410 can be selected to quickly jump to selected web pages, such as to edit user information, user preferences, account options, help pages, or a shopping cart. A sign out link is also provided. Other embodiments include other links as desired. Links 410 can be included on other pages of web site 300 after the user has logged in, if desired. Links 410 are arranged at a different location of the web pages in some embodiments.

In this example, another set of links 412 are arranged toward the bottom of welcome page 402. Links 412 can be selected to quickly jump to selected web pages, such as an about us page, a contact us page, an advertisers page, a contributors page, a terms of use page, a privacy policy page, and a help page. Links 412 are provided at a different location of welcome page 402 in other embodiments. Links 412 can be included on other pages of web site 300 if desired.

FIG. 5 is a screen shot of an exemplary MyHome page 502 of the web site 300. The MyHome page 502 includes quick links bar 504, welcome section 506, favorites section 508, uploads section 510, purchases section 512, communities section 514, and featured media section 516. The MyHome page 502 serves as a convenient central location from which the user can access many of the features of web site 300.

MyHome page 502 includes quick links bar 504. Quick links bar 504 includes quick search 520, and links 522. In some embodiments of web site 300, quick links bar 504 is present on many pages of web site 300. In this way the user has easy access to the features provided by quick links bar 504. Quick search 520 includes a search query field where a user enters keywords to search for, and a Find button that initiates the search for the entered keywords. Quick search 520 also includes an advanced search link that, when selected, opens an advanced search page. Links 522 can be selected by a user to quickly jump to a desired page of web site 300. In this example, links 522 includes a MyHome link, a Connect link, an Explore link, and a Share link. The MyHome link, when selected, returns the user to MyHome page 502, even if they are currently at a different page of web site 300. The Connect link, when selected, causes web site 300 to display a communities page. When the user selects the Explore link, web site 300 displays a media page. When the Share link is selected, web site 300 displays an upload page that allows the user to upload user-generated media.

Welcome section 506 is a region of MyHome page 502 that displays a welcome message to the user. In some embodiments, welcome section 506 includes a text-based message 530 and an image 531 or other media. Text-based message 530 can be used to provide inspirational, educational, informative, or other information to the user. As shown in FIG. 5, an example of a text-based message 530 is a quotation, such as “Ah! If you only knew the peace there is in an accepted sorrow.—Jeanne de la Motte-Guyton.” Other examples of text-based message 530 include Bible verses, poetry, inspirational thoughts. In some embodiments, text-based messages 530 are used to communicate information from web site 300 to the user. For example, text-based message 530 can be used to welcome the user, tell the user about new features of web site 300, display a personal message to the user, update the user of the status of pending orders, or for variety of other purposes. In some embodiments, text-based message 530 changes every time MyHome page 502 is displayed or refreshed. Web server stores a plurality of text-based messages that can be selected from when generating MyHome page 502.

Welcome section 506 also includes image 531. It is said that a picture is worth a thousand words. In the same way, image 531 can be used to convey information to the user. In some embodiments, image 531 is a photograph of a person, place, animal, or other object. In other embodiments, image 531 is a graphic. In other embodiments, other media is used in place of image 531, such as a video clip. Yet other embodiments include a media player, such as for playing audio to the user.

In some embodiments, MyHome page 502 (and in some embodiments, other pages of web site 300) are customized based upon one or more characteristics of the user. The user is identified by the login procedure described with reference to FIG. 3. As a result, Web server 102 is able to store information about the user which can be used to customize web site 300. For example, welcome section 506 is customizable to display text-based messages and/or images 531 based upon one or more characteristics of the user. Such characteristics include religious beliefs, identification with particular ideals, physical characteristics, personality characteristics, purchasing history, browsing history, community membership, or any other identifiable characteristic.

In some embodiments, web site 300 is customized based upon a user's Segment Self Identifier (SSID). Any group can be divided into a number of different segments of the group. For example, the group of all Catholics can be divided into five different segments. The segments include: (1) defends the rules™, (2) follows the rules™, (3) considers the rules™, (4) don't know the rules™, and (5) the rules don't apply to me™. In another embodiment, Catholics (or all people) can be divided based on spiritual type. The spiritual type, for example, divides Catholics based on whether they tend to make decisions based on reason or feelings, and whether they are more active or more contemplative. For more information, see “Roman Catholicism in America,” by Chester Gillis.

Similarly, other groups can be divided into various segments based upon any number of factors. For example, the Republican Party could be divided among various groups, such as (2) those who are fiscally conservative, (2) those who are socially conservative, (3) those who are fiscally conservative and socially conservative, and (4) those who are neither fiscally conservative or socially conservative. The SSID is used to identify the user with a particular segment of a group. Other embodiments include other groups and segments than those specifically discussed herein.

In one embodiment, the SSID is self-selected by the user, such as during the registration process (e.g., shown in FIG. 3). In another embodiment, the SSID is assigned to the user after the user answers a set of questions. In yet another embodiment, the SSID is assigned based on the user's purchasing or browsing history (e.g., what media has the user purchased or viewed?). Other embodiments assign an SSID based on other characteristics or actions of the user. In further embodiments, the SSID can change over time.

Some embodiments of web server 102 include a library of pre-configured SSIDs and associate all (or some) media items stored on web server 102 with one or more SSIDs. In some embodiments the SSID is manually assigned to each media item by an administrator, moderator, publisher, user, or other person. In other embodiments, the SSID is automatically assigned to each media item based upon characteristics of the media item, characteristics of the metadata associated with the media item, or based on an evaluation of what users interact with or purchase the media item.

Once the SSID has been assigned, some embodiments customize web site 300 based upon the SSID. For example, welcome section 506 is customized to display text-based message 530 and/or image 531 that is likely to be appreciated by a user having the SSID of the user. In other embodiments, advertisements are displayed based on the users SSID. In yet other embodiments, featured media (such as shown in featured media section 516) is selected based at least in part on the SSID. In some embodiments, the layout, formatting, display, and content of web site 300 is entirely customizable based upon the users SSID or other characteristics or identifiers to be most likely appealing to the user or most likely to fit within the values, ideas, and interests of the user.

Customization of web site 300 based upon the SSID has various benefits. One benefit is that information displayed is likely to be more relevant or meaningful to the user. For example, some users may appreciate a quote from a particular author, while others would be offended by the quote by that author. The SSID can be used to show the quote to those that are likely to appreciate it, and to withhold the quote from those that would likely be offended by it. Similarly, advertisements for certain media, products, or services may be appreciated by some but not by others. The SSID can be used by web site 300 to selectively display advertisements to those that are likely to appreciate them. Media recommendations can be similarly selected based upon the SSID or other user characteristics. In some embodiments advertisements are stored in a database of advertisements that is in data communication with the web server. In some embodiments the database of advertisements is stored locally on the web server. In other embodiments a third-party ad server service is used to provide advertisements to the web server.

The SSID is also useful as a search filter, such as to filter media by average rating given by other users sharing the same SSID or having a different SSID, or for other searching purposes. In some embodiments, use of the SSID provides a web site that meets the needs of the user more effectively and is able to present content that is more relevant to the user's needs in a shorter period of time.

Some embodiments of web site 300 and web server 102 use the SSID to provide benefits to media providers and advertisers as well. The SSID is used by web server 102 to direct media items to those users most likely to appreciate the content, and most likely to be interested in purchasing the content. Further, the SSID is used by web server 102 to present targeted advertisements to those most likely to appreciate the content, and most likely to be interested in the products or services being advertised. Similarly, the media content and advertisements are withheld by server 102 from those that are likely to be offended by or merely not interested in the media content or advertisements. For advertisers that pay for each time an advertisement is displayed, this results in reduced costs and a higher rate of return in some embodiments. The SSID can also be used to provide useful usage reports regarding the activity of users having particular SSIDs.

Favorites section 508 is a section of MyHome page 502 that displays a link 532 to media that has been previously tagged by the user as a favorite. In some embodiments, the link includes a thumbnail image of the media, and a brief description of the media. The user can select the link to cause web site 300 to display the media page associated with the favorite media.

Uploads section 510 includes links to media previously uploaded by the user. In this example, the user has not uploaded any media, and so uploads section 510 does not include any links. If the user had previously uploaded a media item, the uploads section 510 would include a link, such as link 532, to the uploaded media item. In some embodiments, a section that does not contain any relevant links is not displayed, or contains a link to a page where the user can access the associated feature, such as an upload page.

Purchases section 512 includes links to media that have been recently purchased by the user. In this example, purchases section 512 does not include any links because the user has not yet purchased any media. If the user had previously purchased a media item, the purchases section 512 would include a link, such as link 532, to the media item.

The Communities section 514 (also sometimes referred to herein as a group) includes links to the community pages of any communities that the user is a member. In this example, the Communities section 514 does not include any links because the user is not yet the member of any communities. If the user was a member of one or more communities, a link would be displayed. Selection of the link would cause web site 300 to display the associated community page. The links can include a thumbnail image associated with the community, a brief description or name of the community, or both.

The featured media section 516 includes a set of media recommendations. In some embodiments, the media recommendations are based upon a characteristic of the user, such as past purchasing or browsing history, community membership, SSID, or other characteristics. In other embodiments, the media recommendations are special offers from publishers. In yet other embodiments, the media recommendations are selected by a web site administrator or other person and are the same for all users. In further embodiments, media recommendations are random or partially randomized. Other media selection algorithms are used in other embodiments.

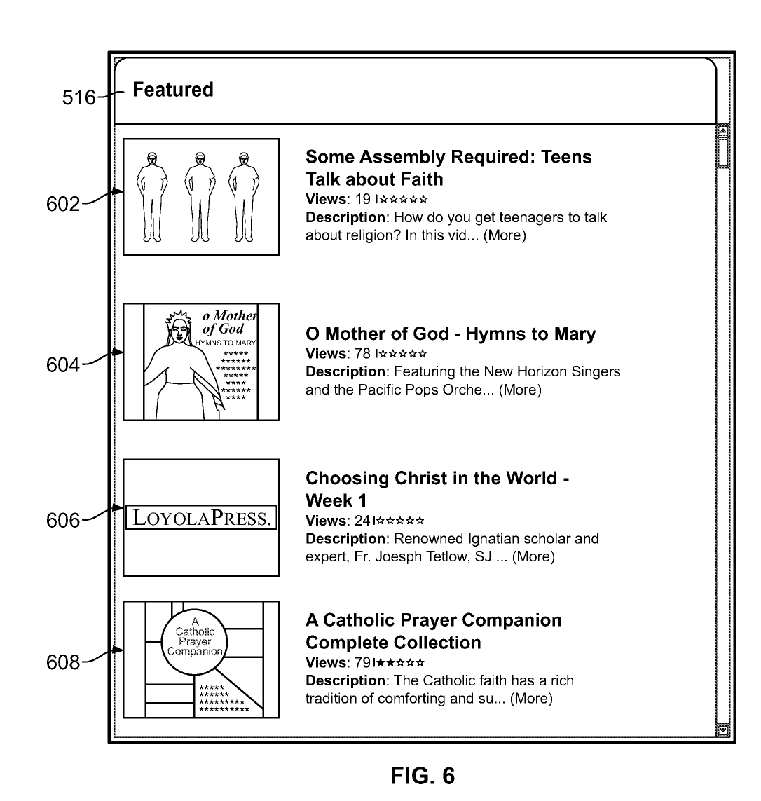

FIG. 6 is an enlarged screen shot of featured media section 516 of MyHome page 502, shown in FIG. 5. Featured media section 516 displays a snapshot of recommended media items. In this example, featured media section 516 includes snapshot 602, snapshot 604, snapshot 606, and snapshot 608. Snapshot 602 is a display of information relating to a first media selection.

In this embodiment, all snapshots share a number of common elements, including a thumbnail image, a title, popularity information, and a brief description. The thumbnail image is, for example, a single frame from a video clip, a cover image from a media case (such as a CD or DVD cover image), an image from the publisher, or any other image associated with the media. The title is displayed in a larger font and is used to identify the media item. Popularity information displays information about the popularity of the associated media item on the web site. For example, popularity information includes the number of times the associated media item has been viewed by users of the web site. Another example of popularity information is a display of an average of the ratings that have been given by users that previously viewed the associated media item. In some embodiments, web server 102 stores ratings according to the users SSID. In such embodiments, the average rating displayed is only the average of the ratings that have been entered by other users that share the same SSID as the present user. In other embodiment, the ratings display includes the average ratings for each of the various SSIDs, such that the user can also see the average ratings provided by users having a different SSID than the user's SSID.

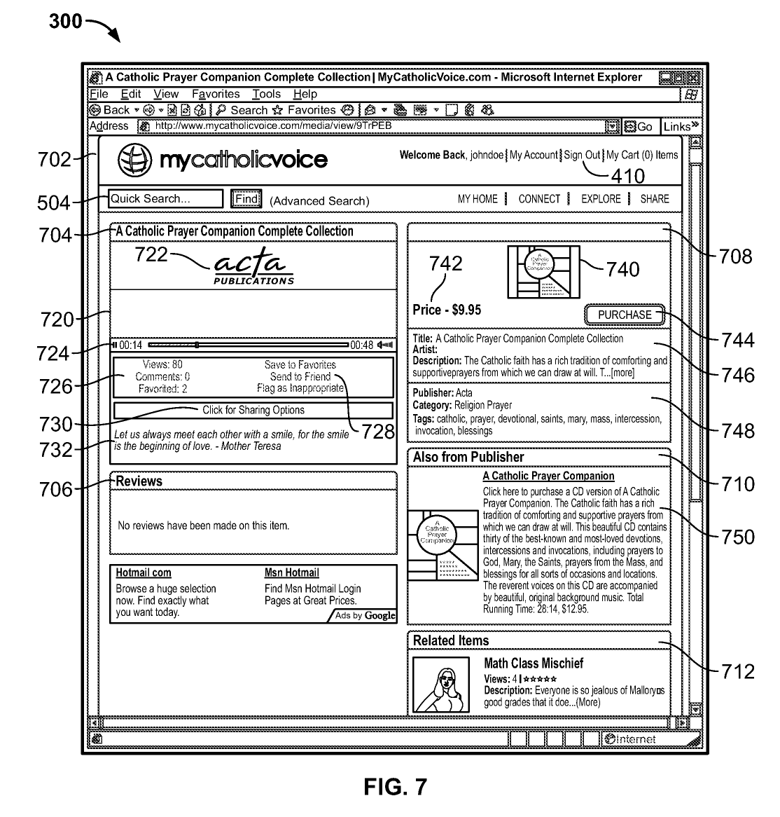

The brief description provides a brief textual description of the media item. If the user wants to get more information about the media item, the user selects the media item. Web site 300 then displays the media page associated with the selected media item. For example, if the user selects snapshot 608 associated with “A Catholic Prayer Companion Complete Collection,” then the media page associated with this media item is displayed, as shown in FIG. 7.

FIG. 7 is a screen shot of an exemplary media page 702. Media page 702 includes links 410, quick links bar 504, media player section 704, reviews section 706, full content section 708, also from publisher section 710, and related items section 712. Links 410 and quick links bar 504 are the same as on MyHome page 502.

Media page 702 is a page where additional information about a selected media item is displayed. The media item is typically either user-generated content (such as previously uploaded by a user) or content provided by a commercial publisher. In this example, the selected media item is an audio recording from a publisher. The audio recording is titled “A Catholic Prayer Companion Complete Collection” as noted at the top of media player section 704. Media player section 704 includes an audio player 720 that plays at least part of the audio recording to the user, such as through a speaker or headphones associated with the user's computing system. Audio player 720 includes an optional image display 722 that displays an image associated with the audio recording, such as a publisher logo, a CD cover image, or other image. Audio player 720 also includes a control bar 724 that includes controls to play, stop, the audio recording, and also to adjust the playback volume. More or fewer controls are included in other embodiments.

Media player section 704 also includes a media statistics display 726. Media statistics display 726 displays statistical information relating to the media item. In this example, media statistics display 726 displays the number of times this media item has been viewed by users, the number of comments that users have given for this media item, and the number of users that have tagged the media item as a favorite. Additional statistics are displayed in other embodiments.

Media player section 704 also includes media action links 728. Media action links 728 are selectable by a user to initiate an action relating to the media item. In this example, media action links 728 include Save to Favorites, Send to Friend, and Flag as Inappropriate. The Save to Favorites link is selectable to save this media item to the user's list of favorite media items. Once saved as a favorite, the user can quickly return to this media item by selecting it from the favorites section (e.g., 508) of the MyHome page 502 (shown in FIG. 5), or by navigating to a favorites page that displays the media items that the user has identified as favorites. In some embodiments, the Web server uses the list of favorites to make media recommendations to the user (such as to be displayed in the Featured media section 516 of MyHome page 502, shown in FIG. 5), or to customize the display or operation of web site 300.

Media action links 728 includes a Send to Friend link. When selected, a send to friend page is displayed that prompts the user to enter the friend's e-mail address and a personal note. Once completed, the Web server generates and sends an e-mail relating to the media item to the e-mail address provided by the user. Typically, the e-mail provides a link to web site 300 in the e-mail, so that the recipient can access web site 300 to view the media item.

Media action links 728 includes a Flag as Inappropriate link. When this link is selected, a message is sent to a web site moderator or administrator so that the media item can be reviewed for a violation of the terms of service agreement. If the web site moderator or administrator agrees that the media item is a violation of the terms of service agreement, or determines that the media item is otherwise inappropriate, the media item is removed from web site 300 and possibly from web server 102.

Media player section 704 also includes a sharing options link 730. Clicking on this link causes web site 300 to display a sharing options page. Examples of sharing options include the ability to link the media item to a third-party service (e.g., 110 shown in FIG. 1), to generate an e-mail to a friend regarding the media item, or other sharing options.

Media player section 704 also includes a message display 732. Message display 732 displays a message on media page 702. In some embodiments the message is related to the media item. In other embodiments, the message is a randomly (or partially randomly) selected message, selected from a database of available messages. Examples of messages include a quotation, an inspirational thought, a word of advice, a Bible verse or passage, a statement of encouragement, a note about the media item, or other messages. Notes about the media item can include a message relating to the popularity of the media item (e.g., “A Top Seller”, “Most Popular Media of 2008”) or a message regarding the status of the media item (e.g., “temporarily unavailable,” “sold out,” “backordered”, “on sale,” “10% off”).

Media player section 704 includes audio player 720 that plays an audio clip to the user. It has been found that web site users often have a short attention span. It is therefore desirable to provide media in short clips, sometimes referred to herein as a “snack.” The short clips are preferably from about ten seconds long to about five minutes long and more preferably from about thirty seconds long to less than about three minutes long. It has been found that many users will not regularly view clips that are longer than these ranges. On the other hand, a clip of less than ten seconds is often too short to provide the user with an adequate sample of the media item, and most full-length media items are more than ten seconds long. However, in some embodiments longer and shorter clips are used.

In some embodiments, the audio clip is a short sample of a full-length media item. The short sample allows the user to evaluate the sample to determine whether the full-length media item is something that the user would like to purchase. In other embodiments, the audio clip is a full-length media item that is associated with other media items.

Reviews section 706 is a section of media page 702 that displays reviews entered by other users that have previously viewed or purchased the media item. In this example, no reviews have been entered, and therefore the reviews section states “No reviews have been made on this item.” If reviews had been entered, the review is displayed in this section. In some embodiments, the view includes a rating of the media item (such as from one star to five stars). In some embodiments reviews section 706 displays a portion of the review, and then includes a link that can be selected by the user if the user wants to read the rest of the review. Upon selection of this link, the web site displays the full text of the associated review.

In the exemplary embodiment, media page 702 includes full content section 708. Full content section 708 provides additional information about a full length media item available from a publisher. In some embodiments, the media item is the full length version of the sample provided by media player section 704. In other embodiments, the media item is a different media item that is associated with or similar to the media item played by media player section 704. The full length media item is sometimes referred to as a “meal” herein. The full length media item typically has a play time in a range from about thirty seconds to about three hours, and preferably in a range from about five minutes to about one hour. Some embodiments include full length media items that are shorter or longer.

Full content section 708 includes thumbnail image 740, price display 742, purchase button 744, information display 746, and related links section 748. Thumbnail image 740 is an image associated with the full content media item, such as a CD cover image, a graphic, a logo, or any other image.

Full content section 708 also includes price display 742 that displays the cost to purchase the full content media item. If the user desires to purchase the media item at that price (or less, such as if the user has a coupon), the user selects purchase button 744. Web site 300 then guides the user through the purchase of the media item, or allows the user to save the media item in the shopping cart for later purchase. If the media item purchased is an electronic copy, the user is guided through a download of the media item, or alternatively is allowed to access a separate media page in which the media item is played in media player section 704.

Full content section 708 includes information display 746. Information display 746 displays additional information to the user regarding the full content media item. In this example, information display 746 displays the title, artist, and a brief description of the media item. Other information that is displayed in other embodiments includes the length of the media item, the year of publication, the name of the publisher, a list of contributing musicians or participants, a copy of the musical lyrics, or other information.

Full content section 746 includes links section 748. Links section 748 provides links to other pages within web site 300 and also displays additional information about the full length media item. In this example, links section 748 identifies the publisher and provides a link to other media items from the same publisher. Links section 748 also includes an identification of a category that the full length media item belongs to, as well as a set of tags associated with the media item. The identified categories and tags are links that, when selected, cause web site 300 to display a page including other media items that are in the same category or that are associated with the same tag selected. The user can then browse through the media items to locate additional media items of interest.

Media page 702 also includes an Also From Publisher section 710. This section displays a recommendation for one or more other media items from the same publisher that may be of interest to the user. In this example, the Also From Publisher section 710 displays information about a CD version of the media item (which is only an electronic copy). The information displayed in section 710 includes a title of the media item, a thumbnail image of the media item, and a description of the media item. If desired, the user can click on the title of the media item to be brought to a separate media page where additional information, a snack version of the media item, and purchasing information is presented. Alternatively, the Also From Publisher section 710 includes a link to the publisher's web site.

In another embodiment, the media item of media page 702 is user-generated content that is uploaded by the user. In such embodiments, the media page 702 includes an Also From User section in place of Also From Publisher section 710, which displays other user-generated media that has been uploaded by this user, if any.

In other embodiments, media page 702 includes more or less sections and features than specifically described herein.

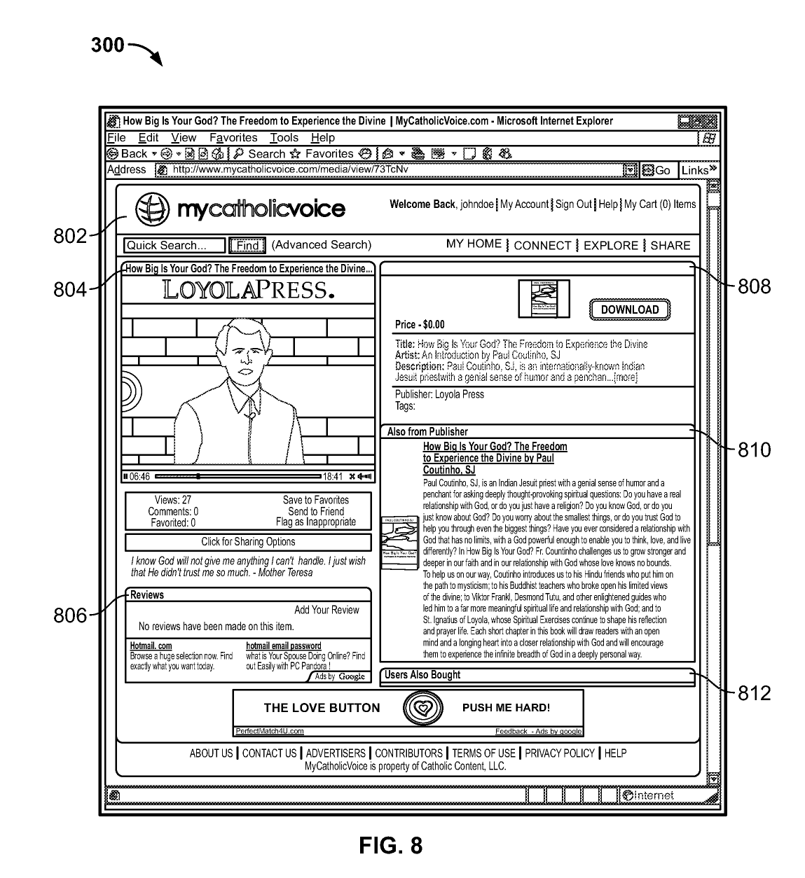

FIG. 8 is a screen shot of an exemplary media page 802. Media page 802 is similar to media page 702, except that media page 802 relates to a video media item, rather than an audio media item. Similar to media page 702, media page 802 includes media player section 804, reviews section 806, full content section 808, and also from publisher section 810. Rather than Related Items section 712, media page 802 includes Users Also Bought section 812.

In this embodiment, media player section 804 includes a section for a video player to display a video. Examples of suitable video players include the JW FLV open source media player distributed by LongTail Video, WINDOWS MEDIA® R Player by Microsoft Corporation, QUICKTIME® R application program by Apple, Inc., REALPLAYER® R software by RealNetworks. The user can download and install the media player on the user computing system 108. Other media players are used in other embodiments.

Media player section 804 includes video player 820 that plays a video clip to the user. As noted above, it has been found that web site users often have a short attention span. It is therefore desirable to provide media in short clips, sometimes referred to herein as a “snack.” The short clips are preferably from about thirty seconds long to about five minutes long and more preferably from about one minute long to less than about three minutes long. It has been found that many users will not regularly view clips that are longer than these ranges. On the other hand, a clip of less than one minute is often too short to provide the user with an adequate sample of the media item, and most full-length media items are more than one minute long. However, in some embodiments longer and shorter clips are used.

In some embodiments, the video clip is a short sample of a full-length media item. The short sample allows the user to evaluate the sample to determine whether the full-length media item is something that the user would like to purchase. In other embodiments, the video clip is a full-length media item that is associated with other media items. In some embodiments full-length media items have a play time in a range from about thirty seconds to about ten hours, and typically in a range from about fifteen minutes to about one and a half hours. User-generated content is often shorter than publisher provided content, and is typically in the range from about thirty seconds to about one hour, and more typically in a range from about thirty seconds to about ten minutes. Other embodiments include full-length media items that have shorter or longer play times.

Media page 802 also includes reviews section 806, full content section 808, and Also From Publisher section 810, which are similar to the sections described with reference to FIG. 7 above. In this example, media page 802 includes a Users Also Bought section 812 in place of the Related Items section 712 described with reference to FIG. 7. These sections are interchangeable and optional in other embodiments. The Users Also Bought section 812 displays a list of media items that other users purchased at the time that they purchased the media item associated with media page 802.

Although media pages 702 and 802 have been described with reference to audio media and video media, respectively, it is recognized that other embodiments include media pages that include other media times, such as images, animations, web camera recordings, documents, spreadsheets, databases, or any other type of digital media capable of being conveyed across a communication network.

In the event that a user was to upload a media item to web server 102 that violates a copyright of a publisher, web site 300 gives the publisher an alternative to demanding removal of the potentially infringing media. Web site 300 gives the publisher the option of tagging a potentially infringing media item, such as by selecting an appropriate button on a web site page, to identify the media item as being the property of the publisher. Once tagged, a short clip of the media item is still made available in media player sections 704 or 804, but the full content is properly identified and associated with the publisher in full content sections 708 or 808. As a result, if a user wants to purchase the full content, at least a portion of the payment will be appropriately made to the publisher by web server 102.

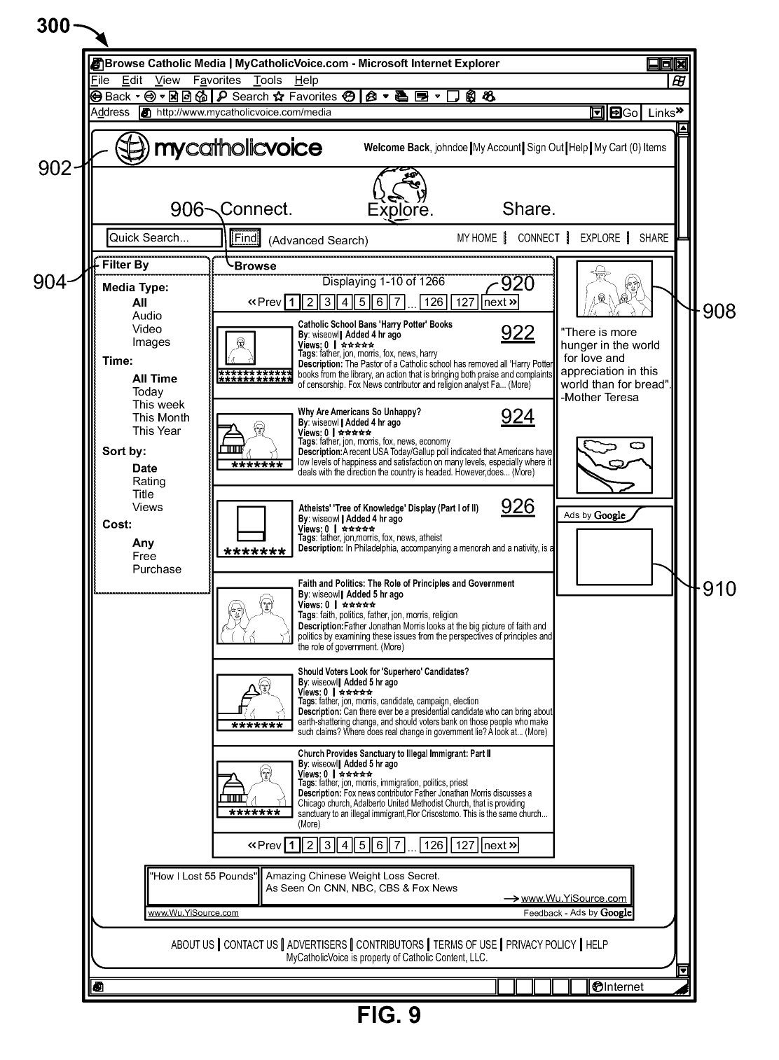

FIG. 9 is a screen shot of an exemplary media browsing page 902. Media browsing page 902 is displayed, for example, when a user selects Explore from the quick links bar (e.g., 504 described herein with reference to FIG. 5). Media browsing page 902 includes filter section 904, browsing section 906, information display section 908, and advertisement section 910.

Filter section 904 includes a set of links that allow the user to indicate one or more filters to apply to the media items displayed in browsing section 906. The default view is that all media is displayed by date. In this example, filter section 904 includes four sections, including Media Type, Time, Sort By, and Cost. One or more of the filters that can be applied to select from or organize the media items displayed in browsing section 906.

The media type filter includes a list of media types, such as All, Audio, Video, and Images. Selection of one of the media type filters removes all media that does not have the identified media type from browsing section 906.

The time filter includes a list of time filters relating to the date the media item was first included in web site 300. The time filters include All Time, Today, This Week, This Month, and This Year. Selection of a time period filters out media items that were added in other time periods from browsing section 906.

The sort by filter includes a list of available sorting alternatives for the display of media items in browsing section 906. Examples of sorting alternatives include Date, Rating, Title, and Views. Date arranges the media items by the date and time that the media items were added to web site 300. Rating arranges the media items by the average user rating that has been assigned to the media items, from highest rated to lowest rated. Title arranges the media items alphabetically by title. Views arranges the media items from those having the most number of user views to those having the least number of user views.

The cost filter includes a list of costs, such as Any, Free, and Purchase. Selection of “any” displays all media items. Selection of Free removes all media items that are not free. Selection of Purchase removes all media items that are free. Additional filters and sorting alternatives are available in other embodiments.

Browsing section 906 displays a list of media items that match the criteria specified in filter section 904. In this example, media is displayed as snapshots, including media snapshots 922, 924, and 926. Media snapshots display information about an associated media item. For example, the media snapshots include a thumbnail image, the title, the username of the person who uploaded it or the name of the publisher, an indication of how long ago the media item was added, a view count, an average rating display, a list of linked tags, and a brief description of the media item. Other embodiments include more or less information.

Browsing section 906 also includes navigation links 920. Navigation links 920 allow the user to navigate to view additional pages of media snapshots. In this example, navigation links include a previous link, a next link, and links to particular page numbers. The user selects one of the links to cause web site 300 to display a browsing page including the media items for the selected page.

In some embodiments media browsing page 902 also includes one or more information displays 908, for displaying images or text to the user. In some embodiments, information display section 908 is customized based on one or more characteristics of the user, or based upon the media item(s) that are currently displayed. In some embodiments, advertisements are included on media browsing page 902, such as an advertisement provided by GOOGLE™. Advertisements provide one of multiple potential sources of revenue for the operator of web site 300.

Some embodiments of web server 102 store, present, and distribute media items in the form of a kit. A kit is a collection of two or more media items. Kits can be defined by an administrator, a publisher, a user, or other people. In some embodiments, kits are a collection of content from a single user or publisher. In other embodiments, kits can include media items from two or more users or publishers. In some embodiments, kits include just publisher provided content, just user-generated content, or both publisher provided content and user-generated content.

In some embodiments, kits contain content that is related by a common theme or characteristic. For example, one embodiment is a kit containing media items relating to a particular event, such as World Youth Day, for example. Organizers of local World Youth Day events can download the kit that contains all of the media items necessary to put on their own World Youth Day event. Examples of media items include music, videos, brochures, handouts, banners, signs, posters, slide presentations, seminar materials, teaching outlines, a playlist, instructions for using the media, or any other desired media items. When a kit includes media items from more than one user or publisher, the proceeds of the kit are distributed between the users and publishers. This allows the users and publishers to profit from the sale of the kit, and allows the users to obtain all materials needed in a single package.

In one embodiment, the kit is displayed to the user as if it were a single media item, using a media page such as shown in FIGS. 7 and 8. The media page presents information about the media kit and allows the guides the user through the purchase and download of the media kit. In some embodiments the media is packaged as a single electronic file, such as using a compression and/or archival software application (such as WinZip distributed by WinZip, International). The kit can be decompressed or unarchived to access the multiple media items of the kit. In another embodiment, the media page (or a separate download page) includes separate links for each media item, allowing the user to selectively download each media item individually and allowing the user to choose not to download a particular media item if not needed at the present time.

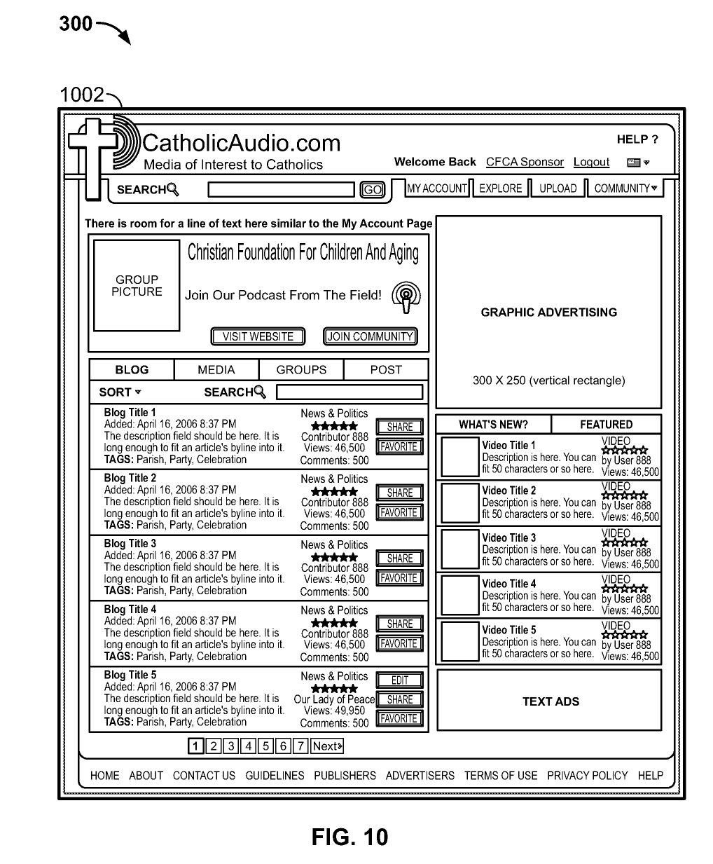

FIG. 10 is a screen shot of an exemplary Content Centered Community Page 1002 of web site 300. A further aspect of some embodiments of web site 300 provides content centered communities that users can establish and maintain. The web site includes one or more pages that act as a central storage location for information and content relating to the community. Typically, each community has at least one administrator that is allowed to customize the community for the participants. Some embodiments of a content centered community page(s) include one or more of the following: an identification of the community and basic information about the community; a designation of the community as private, invitation only, or public; customization of the community layout including the setup of media items, groups, blogs, and features; an ability to add media items and other content and designate each individual item as private to that community, viewable by other communities, or open for comment from other communities; an ability to select items from other communities that have been opened for view or comment and include them within the community; an ability to select groups of media items or individual media items to include within the community; and ability to manage blogs and discussion threads; an ability to create media, blogs, and other content created by the community; and an ability to control membership within the community.

Examples of groups that would benefit from a content centered community page include a parish, diocese, church group, youth organization, Bible study group, educational group, religious order, or other groups. Some embodiments of the content centered community pages allow users to communicate with each other and share media items with each other.

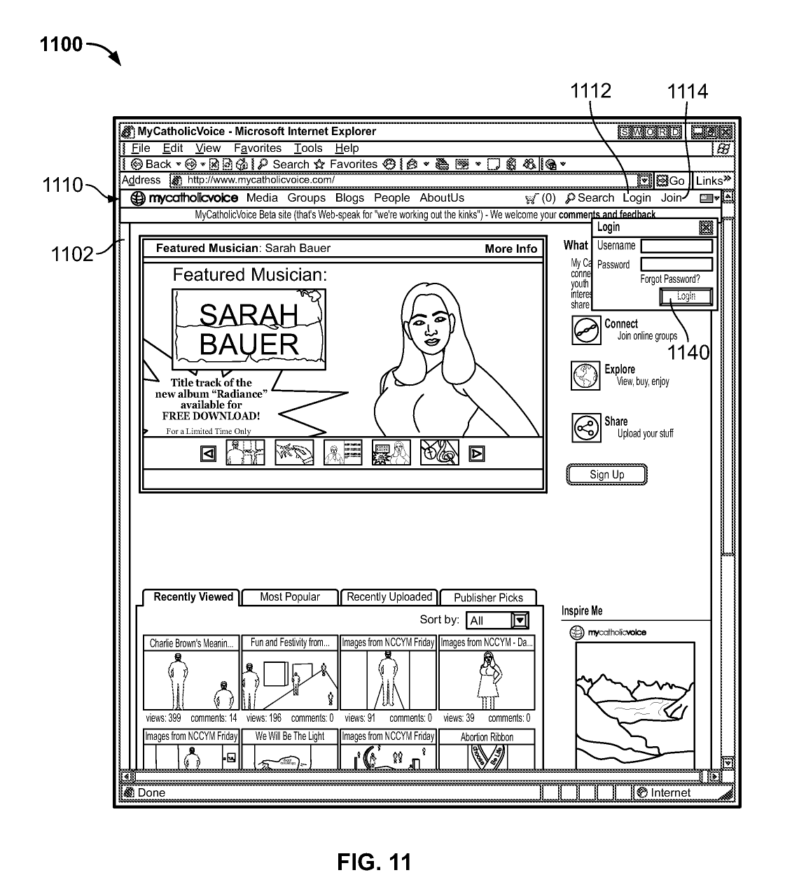

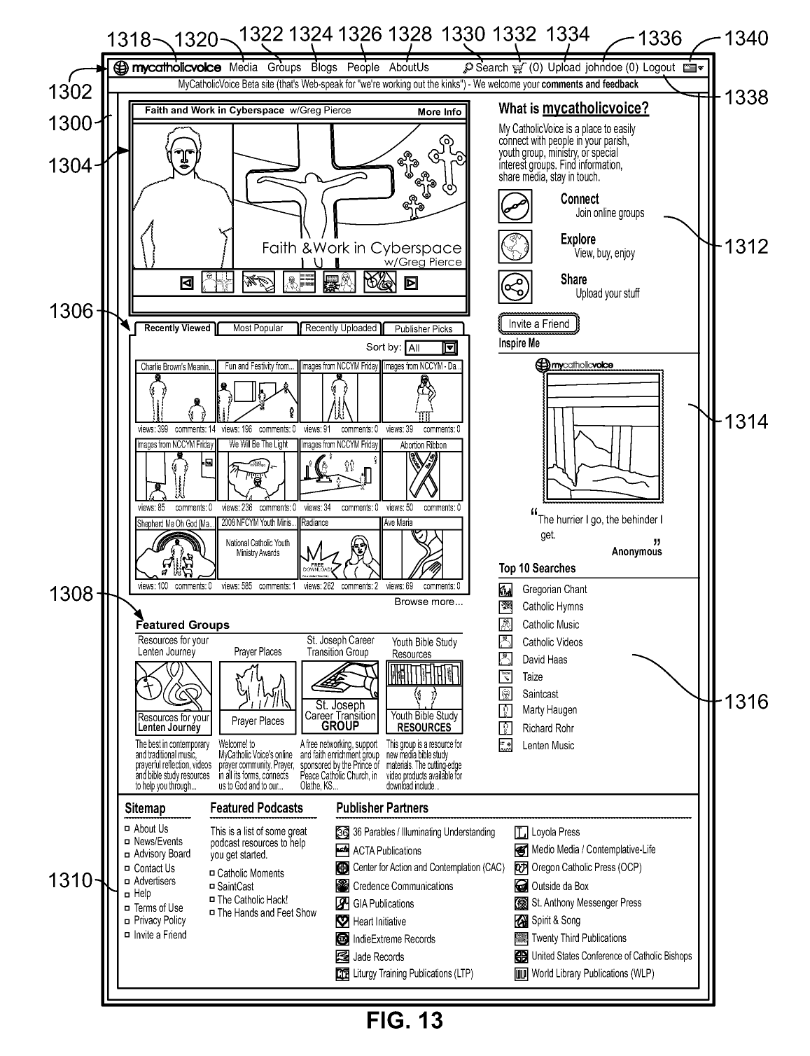

FIG. 11 is a screen shot of an example visitor home page 1102 of another web site 1100. Home page 1102 is described in more detail with reference to FIG. 13. In this example, home page 1102 includes a visitor navigation bar 1110. Visitor navigation bar 1110 includes login button 1112 and join button 1114.

Home page 1102 is typically the first page that a user encounters when visiting web site 1100. If a user has previously registered, the user can select the login button 1112 from the visitor navigation bar 1110. Upon selection of the login button, login window 1140 is displayed requesting the user name and password. The user enters the previously registered information and selects login button 1142. The web server then receives the user name and password, validates the information provided, and logs in the user.

If a user has not previously registered, web site 1100 permits the user access as a visitor user, including access to many of the web site 1100 pages and access to many of the media items contained therein. However, certain pages require the user to login in some embodiments, such as to view or edit profile data or to make purchases.

If a user has not previously registered with web site 1100, the user can do so by selecting the join button 1114. In some embodiments an additional sign up button 1116 is provided on home page 1102. In this example, sign up button 1116 operates to perform the same function as join button 1114, but is more prominently displayed on home page 1102 to more easily be noticed by a new user. In some embodiments, after a user has logged in, sign up button 1116 changes to an invite a friend button, which allows the user to send an e-mail to a friend to invite them to visit web site 1100. Upon selection of join button 1114 or sign up button 1116, a registration page is presented where the user can select a user name and password and provide additional identifying or personal information.

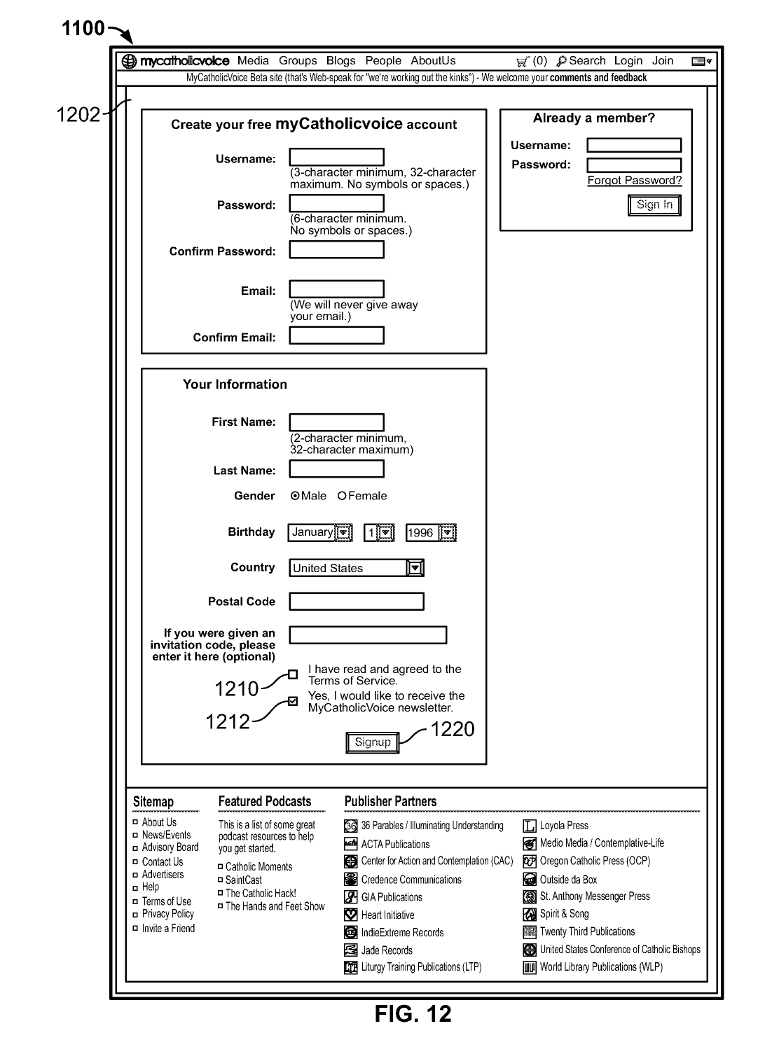

FIG. 12 is a screen shot of an example new user registration page 1200 of web site 1100. Registration page 1200 prompts the new user to provide certain identifying information, such as a user name and password. In this example, the registration page 1200 also requests the user's first and last name, gender, date and year of birth, country of residence, and postal (zip) code. In some embodiments, a user may be given an invitation code as part of a promotion. If so, the user may enter the invitation code in the registration page. For example, the invitation code may allow the user to apply credit toward future purchases (e.g., a free download of up to one dollar in value). A variety of other information may also be requested from the user in registration page 1200, such as any of the other data described herein.

Registration page 1202 also includes a terms of service agreement button 1210 and a mailing list authorization button 1212. The use can select or deselect the respective buttons. However, the user must select the Terms of Service agreement button 1210 before the user is allowed to proceed with registration.

After registration page 1202 has been completed, the user selects the Sign Up button 1220 to complete registration. The information is then transferred to the web server, which evaluates the data (such as to confirm that the user name is unique), and stores the data in its database.

FIG. 13 is a screen shot of an example home page 1300 that is displayed to a registered and logged in user. In this example, home page 1300 includes primary navigation bar 1302, a ticker zone 1304, a featured media section 1306, a featured groups section 1308, a footer links section 1310, introduction section 1312, inspirational section 1314, and atop searches section 1316.

In this example, a user having the username “johndoe” has logged into web site 1100. Once the user has logged in, the visitor navigation bar (1110, shown in FIG. 11) is replaced with a primary navigation bar 1302. More specifically, the primary navigation bar removes the login and join buttons (that are no longer needed), and replaces them with other navigation buttons.

In some embodiments, primary navigation bar 1302 is presented as a bar across the top of home page 1300 and is always present while the user is logged in to web site 1100. In this example, primary navigation bar 1302 is divided into two sections. The first section (toward the left side of primary navigation bar 1302 in this example) provides links to major sections of web site 1100. The first section includes home page button 1318, media button 1320, groups button 1322, blogs button 1324, people button 1326, and about us button 1328. The second section (toward the right side of primary navigation bar 1302 in this example) provides links to other features of web site 1100. The second section includes search button 1330, shopping cart button 1332, upload button 1334, user info button 1336, logout button 1338, and language preference button 1340.

Primary navigation bar 1302 performs multiple functions. One function is to provide a visual guide to the various features and functions available through web site 1100. The first section of primary navigation bar 1302 divides web site 1100 into a plurality of main sections: a media section, a groups section, a blogs section, a people section, and an about us section.

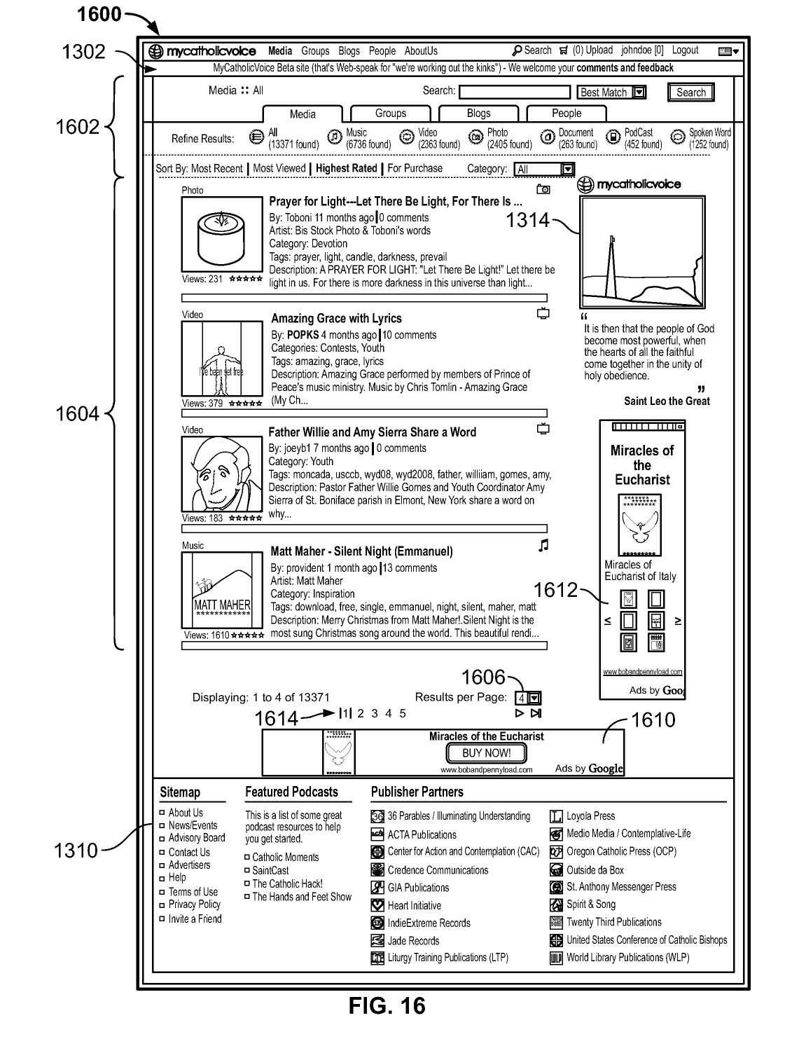

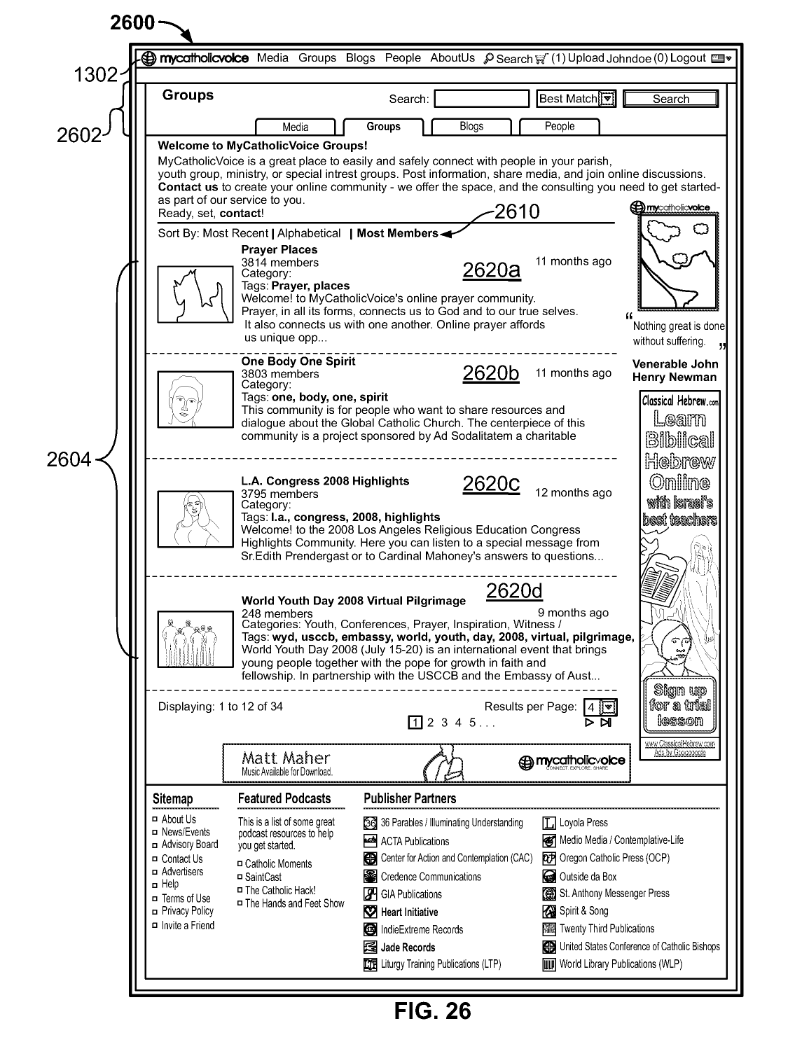

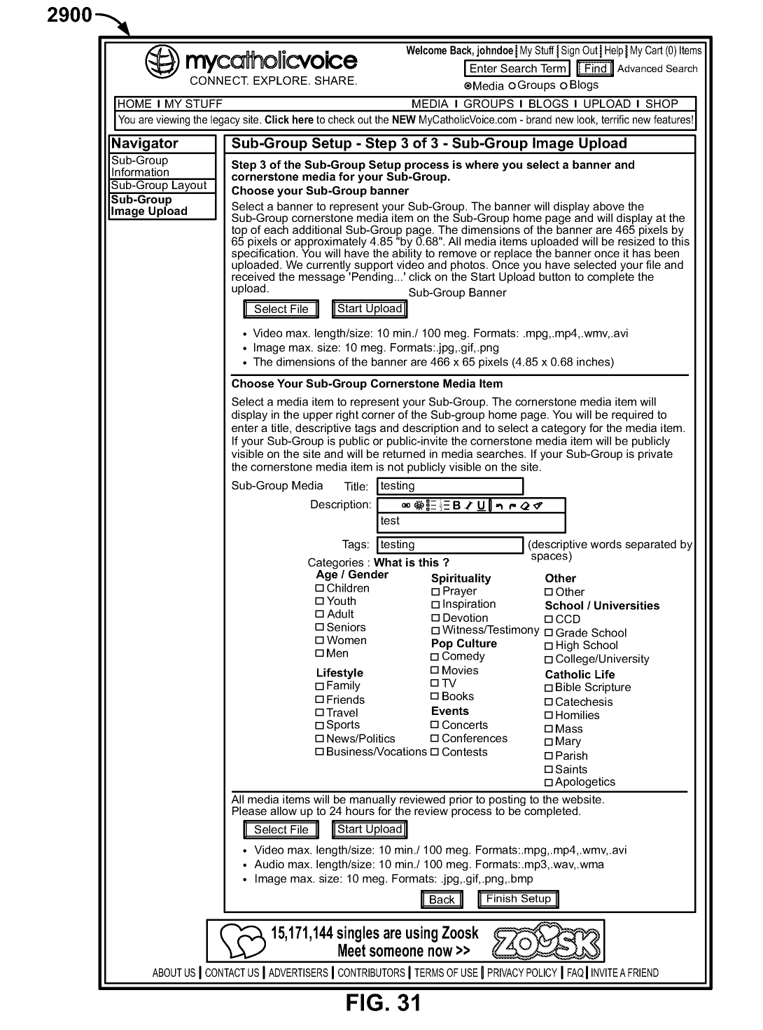

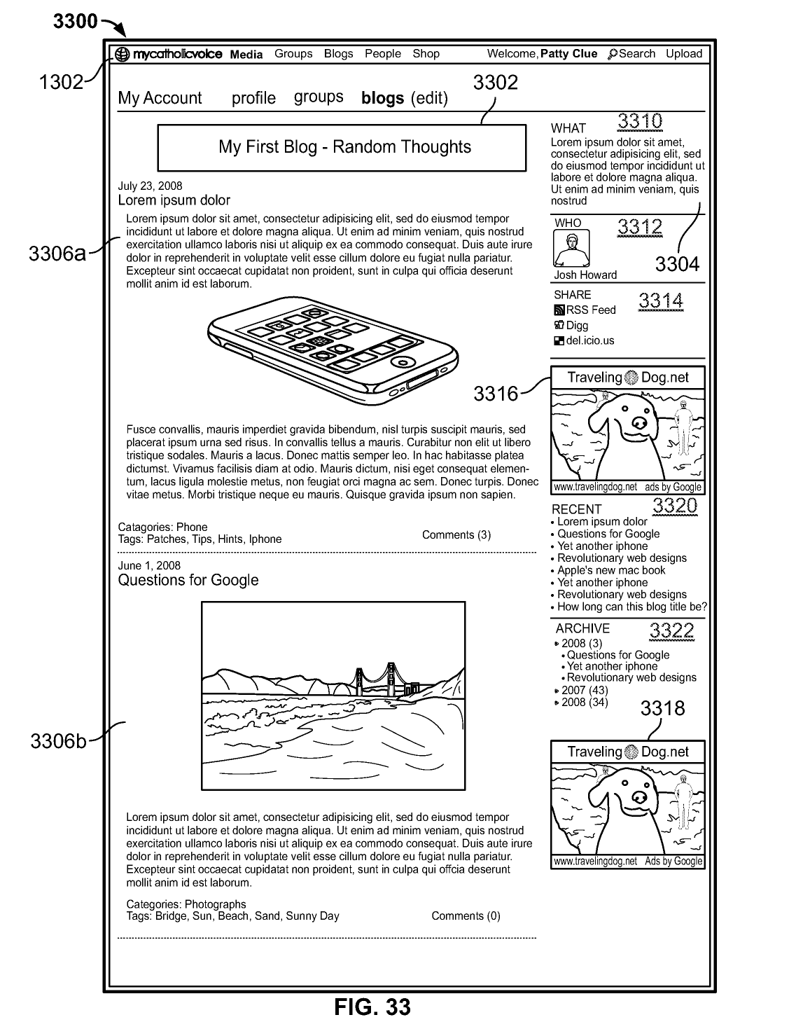

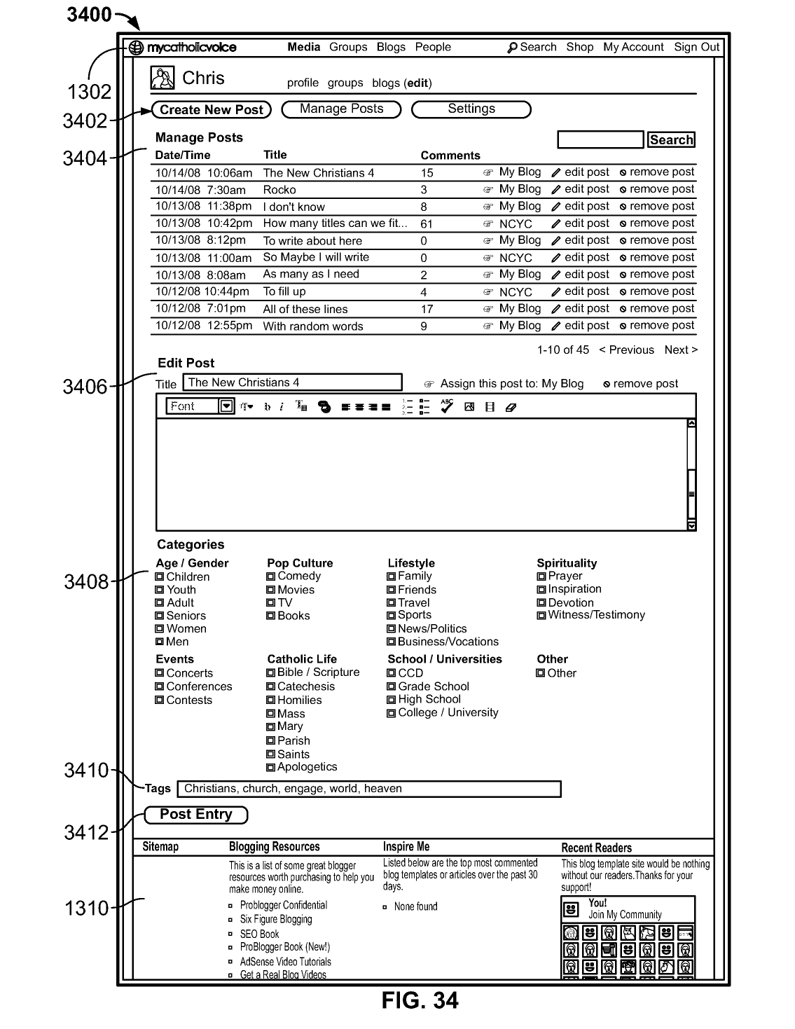

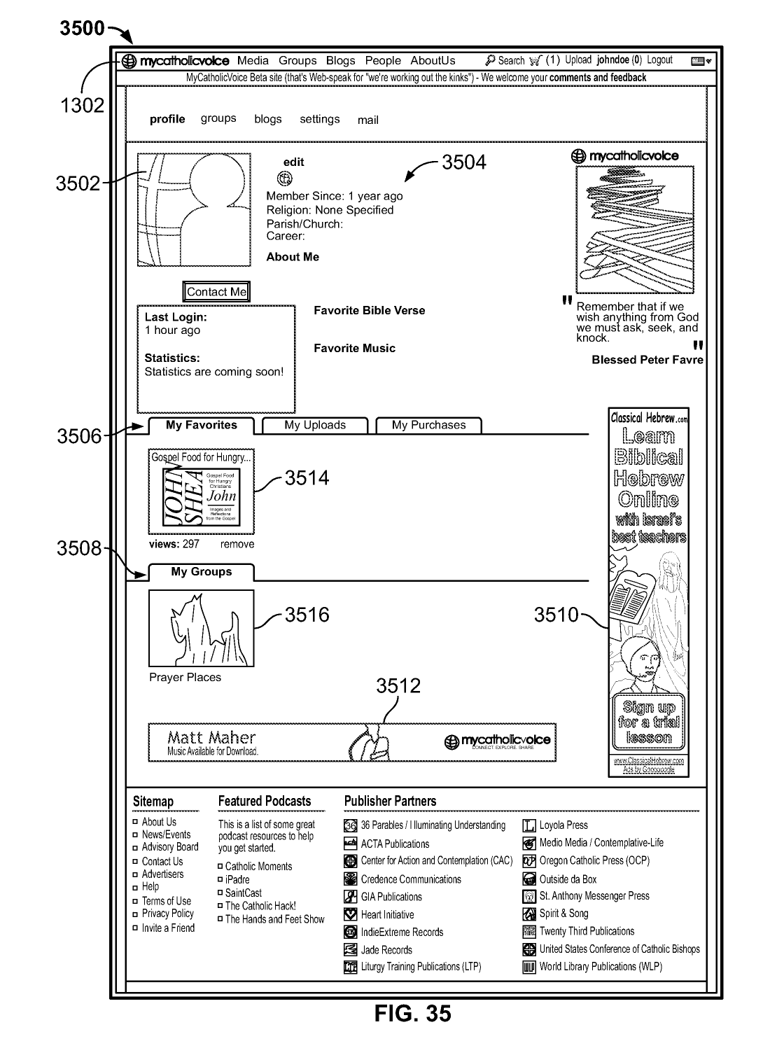

Another function of the primary navigation bar 1302 is that it allows the user to quickly jump to any of the desired sections from any other location within web site 1100. Examples of certain sections are illustrated and described below with reference to the following figures: FIGS. 13-15 illustrate an example home page, FIGS. 16-25 illustrate an example media section, FIGS. 26-32 illustrate an example groups section, FIGS. 33-34 illustrate an example blogs section, and FIG. 35 illustrates an example people section.

The second section of primary navigation bar 1302 also performs multiple functions. One function is to graphically display certain information, such as the name of the user that is currently logged in (user info button 1336 shows the username as “johndoe) and also shows that johndoe does not currently have any messages with the new mail counter “(0)” following the username. If messages are received, the counter is updated accordingly. Shopping cart button 1332 also displays the number of items that the user currently has in the shopping cart with the counter “(0)”, which is also updated as items are added to the user's shopping cart. Another function provided by the second section is to provide links to additional sections of web site 1100. Examples of some of these sections are described in more detail herein.

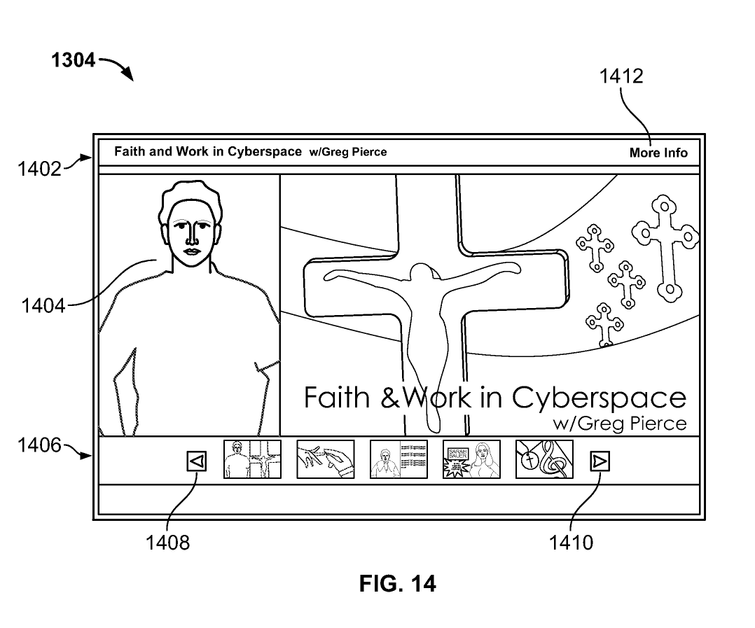

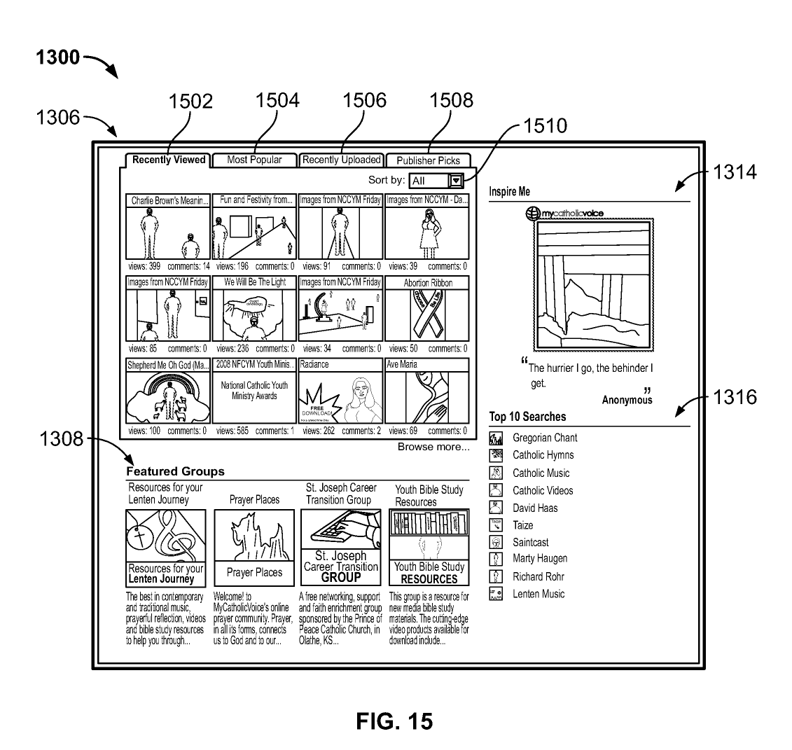

Various sections of example home page 1300 will now be described with reference to FIGS. 14-15.

FIG. 14 is a screen shot illustrating a ticker zone 1304 of the example home page 1300 shown in FIG. 13. Some embodiments of ticker zone 1304 include the following: title bar 1402, display region 1404, thumbnail display region 1406, navigation buttons 1408 and 1410, and more info button 1412. As shown in FIG. 13, ticker zone is typically prominently displayed at or near the top of home page 1300.

Ticker zone 1304 is a section of home page 1300 where certain content within web site 1100 can be featured. Any content can be featured including a particular media item, a collection of media items from a particular user or publisher, a selection of media items from multiple users or publishers, a selection of media items relating to a particular topic or event (from a single user or publisher or from a combination of multiple users and/or publishers), one or more media items that are currently very popular, one or more media items that pertain to a current event, a new or popular blog, a new or popular group, a new or popular podcast, or any other content available through or associated with web site 1100. Ticker zone 1304 is preferably updated often so that the information contained therein is always fresh, new, or different, even if a user visits frequently.

In some embodiments the ticker zone 1304 is a custom built application. In other possible embodiments, the ticker zone utilizes a slide show software, such as the SlideShowPro software product by OTS software.

Title bar 1402 includes, in this example, a brief title or summary of the information currently displayed in display region 1404. In some embodiments title bar 1402 includes a title of a media item and an identification of the artist or author. In this particular example, a group is featured that is coordinated by Greg Pierce. The group has the name “Faith and Work in Cyberspace.” In other embodiments a summary of a collection of media is provided, such as “Lenten Resources.”

Display region 1404 typically provides a graphical image and brief description of the associated media content. In other possible embodiments an audio or video clip is provided. In this example, a graphical image representing the Faith in Cyberspace group is provided, including a photograph of the coordinator as well as graphical images that are related to the content. The graphical image is typically eye-catching and designed to attract users to the content.

In some embodiments display region 1404 scrolls through a plurality of featured content. For example, the first content is first featured in display region 1404 for a period of time. After the period of time has elapsed, the second content is next displayed. The process continues until all featured content has been displayed. The process may then be repeated or the display region 1404 can stop scrolling at a particular featured content.

In some embodiments, thumbnail display region 1406 is included to show a thumbnail version of the graphical image associated with each of the featured content. In this example, a plurality of featured content is provided, such as being in a range from about 2 to about 50. In other embodiments, the plurality of featured content is in a range from about 5 to about 10. In yet other embodiments, there is only one feature at a time. In some embodiments all of the featured content is displayed as a thumbnail in thumbnail display region 1406. In other embodiments only a subset of the featured content is displayed at any one time.

Navigation buttons 1408 and 1410 are provided to allow a user to manually control display region 1404. Selection of navigation button 1408 causes the display region 1404 to go back to a previously featured content. Selection of navigation button 1410 causes display region 1404 to advance to a next featured content. Thumbnail display region 1406 aids the user in visualizing the order of the featured content.

When a user wants more information about particular featured content, the user selects the more info button 1412. Web site 1100 then displays to the user a page associated with the featured content. For example, if the featured content is a group, the associated group page is displayed. If the featured content is a media item, then the associated media item page is displayed. If the featured content is a set of media items, then the associate media browsing page is displayed. If the featured content is a blog, then the associated blog page is displayed. These pages are described in more detail herein. If the featured content is a particular user (e.g., person), the associated person page is displayed. Any other content within or associated with web site 1100 can also be linked to from ticker zone 1304.

In some embodiments, home page 1300 uses a ticker zone table to define what content is to be featured. An example Ticker Zone Table is shown in Table 1. The ticker zone table is typically a plurality of rows, each row defining the content to be featured. For each row, a data entry is provided in appropriate columns. Typically at least three data entries are provided, including a title for the featured content to be displayed in title bar 1402, an image to be displayed in display region 1404 and thumbnail display region 1406, and a link to be associated with more info button 1412. In other embodiments additional columns are included. For example, some embodiments include a start date column and a stop date column. The start date defines the date when the item should start appearing in the ticker zone. The stop date defines the date when the item should stop appearing in the ticker zone.

TABLE 1
Example Ticker Zone Table

| Title | Image | More Info Link |
|---|---|---|
| Faith and Work in | /images/fnw.jpg | /group/Faith+and+Work+in+Cyberspace/ |
| Cyberspace w/ Greg | | |
| Pierce | | |
| World Marriage Day | /images/wmd.jpg | /media/?viewing=media&keywords= |
| Feb. 08, 2009 | | marriage&filter=*&sortby=&category=none&type=intitle&sortdir=DESC |
| Pope Benedict's Prayer | /images/pbpfeb.jpg | /media/?viewing=media&keywords= |
| Intentions for February | | the%20priesthood&filter=*&sortby=&category=none&type=&sortdir=DESC |
| 2009 | | |
| Featured Musician: Sarah | /images/sbauer.jpg | /media/icfciN |
| Bauer | | |
| Lenten Resources for | /images/lent.jpg | /group/Resources+For+Your+Lenten+Journey |
| Personal Inspiration, | | |
| Prayer, and Devotion | | |

Ticker zone 1304 can be used to feature both publisher content and user generated content. Further, ticker zone 1304 can also be used to feature selections of media items from multiple publishers or users. As one example, if it was approaching the season of Lent, an administrator of web site 1100 may want to feature content associated with that season. The administrator generates a graphical image relating to the topic for the ticker zone 1304 and associates it with a media browsing page that includes the set of media items.

In some embodiments a set of search results are used as featured content. For example, as shown in Table 1, content featured for “World Marriage Day” can be the search results for media items having the keyword “marriage”.

FIG. 15 is a screen shot of a portion of home page 1300, shown in FIG. 13. Home page 1300 includes featured media section 1306, featured groups section 1308, inspirational section 1314, and a top searches section 1316.

Featured media section 1306 highlights certain media items according to a plurality of tabs. In this example, featured media section 1306 includes recently viewed tab 1502, most popular tab 1504, recently uploaded tab 1506, and publisher picks tab 1508. Featured media section 1306 also includes a sort menu 1510 that allows a user to sort or filter the results.

When recently viewed tab 1502 is selected (or by default when home page 1300 is opened), a set of recently viewed media items is displayed. In some embodiments the recently viewed media items are the media items that have been most recently viewed by any user arranged in a reverse chronological order. If a user wants to see more of the results, the browse more button can be selected.

When the most popular tab 1504 is selected, a set of media items is displayed that are currently the most popular, arranged according to the view count (e.g., how many times the media item has been viewed) with the media item with the highest view count displayed first.

When the recently uploaded tab 1506 is selected, a set of media items is displayed that have been most recently uploaded, arranged in reverse chronological order. In some embodiments, recently uploaded tab 1506 includes only user generated content. In other embodiments both user generated content and publisher content is included.

When the publisher picks tab 1508 is selected, a set of media items that have been selected by one or more publishers are displayed. The publisher picks section typically includes only content from publishers, and does not include user generated content. In some embodiments each publisher is allowed to select a number of their own media items to be featured in this section. The set that is displayed to a user can be a subset of the full set of publisher picks (such as a random set or a set of the most recent selections). In other embodiments, the items displayed as publisher picks are selected by a web site administrator, one or more users, one or more publishers, or combinations of these. In yet further embodiments, the media items that are displayed are selected based on one or more aspects of the user's profile (e.g., user viewing history, SSID) so as to select items more likely to be of interest to the particular user.

A sort or filter menu 1510 is included in some sections to allow a user to modify the set of media items displayed. In one example, sort menu 1510 is a pull down menu that allows the user to select a type of media to be displayed. In some embodiments, sort menu defines the following selectable media filters: all, music, video, photo, document, spoken word, and podcast.

Some embodiments of home page 1300 include featured groups section 1308. Rather than featuring particular media items, featured groups section 1308 includes a set of groups that may be of interest to the user. The groups may be selected due to their current popularity, how long the group has been active, how timely the topic is to current events, or variety of other factors. In some embodiments the groups displayed are selected based on one or more aspects of the user's profile (e.g., user viewing history or SSID) so as to select items more likely to be of interest to the particular user.

Some embodiments of home page 1300 include an inspirational section 1314. In some embodiments inspirational section 1314 includes an image and a quotation or text-based message. Typically the image and quotation are selected to enhance the users experience with web site 1100, as discussed in more detail herein. In some embodiments the image and quotation are selected based on one or more aspects of the user's profile (e.g., SSID) so as to select images and quotations more likely to be of interest to the particular user.

Some embodiments of home page 1300 also include a top searches section 1316. The top searches section displays a list of keywords that have been the most frequently searched on during a given period of time (e.g., hour, day, week, month, year). In some embodiments the top ten search-terms are displayed. Each displayed search is also linked to the associated media page, media browsing page, group, blog or user profile page.

Referring back to FIG. 13, example home page 1300 also includes footer links section 1310. Footer links section 1310 presents a set of commonly used links in a convenient location on home page 1300 and all other pages of web site 1100. In this example, the links include a sitemap section, a featured content section, and links to publisher partners. The sitemap, for example, includes links to the About Us page, a New/Events page, an Advisory Board page, a Contact Us page, an Advertisers Page, a Help Page, a Terms of Use page, a Privacy Policy page, and an Invite a Friend page.

Introduction section 1312 provides a brief introduction to web site 1100. The introduction section 1312 is provided to help guide a new user or infrequent user and inform those users of some of the features available through the web site.

Other embodiments include a home page having additional or fewer sections, as desired. For example, in some embodiments advertisements are displayed. The arrangement of the various sections can also be modified as desired.

FIG. 16 is a screen shot of an example media browsing page 1600 of the web site 1100 shown in FIG. 11. In this example, media browsing page 1600 includes primary navigation bar 1302, header 1602, browsing section 1604, inspirational section 1314, and footer links section 1310. In some embodiments, media browsing page 1600 is similar to the media browsing page 902 of web site 300 shown in FIG. 9.

Media browsing page 1600 is an example of a page that is displayed by web site 1100, such as upon selection of media button 1320 of primary navigation bar 1302 (shown in FIG. 13).

Primary navigation bar 1302 is typically the same as the primary navigation bar 1302 of home page 1300 (shown in FIG. 13). The primary navigation bar is displayed on all web site pages to provide a convenient way for the user to jump to a desired location of web site 1100.

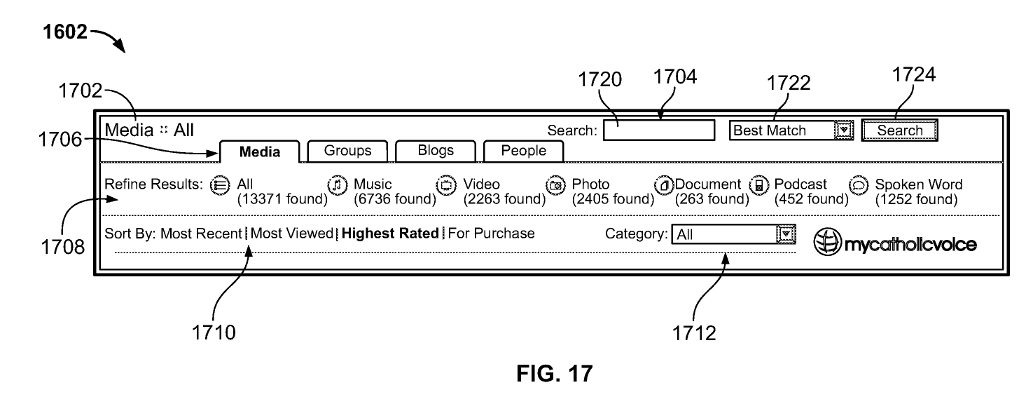

Header 1602 provides a variety of search, navigation, and sorting functions to allow a user to quickly locate desired content. Header 1602 is described in more detail with reference to FIG. 17.

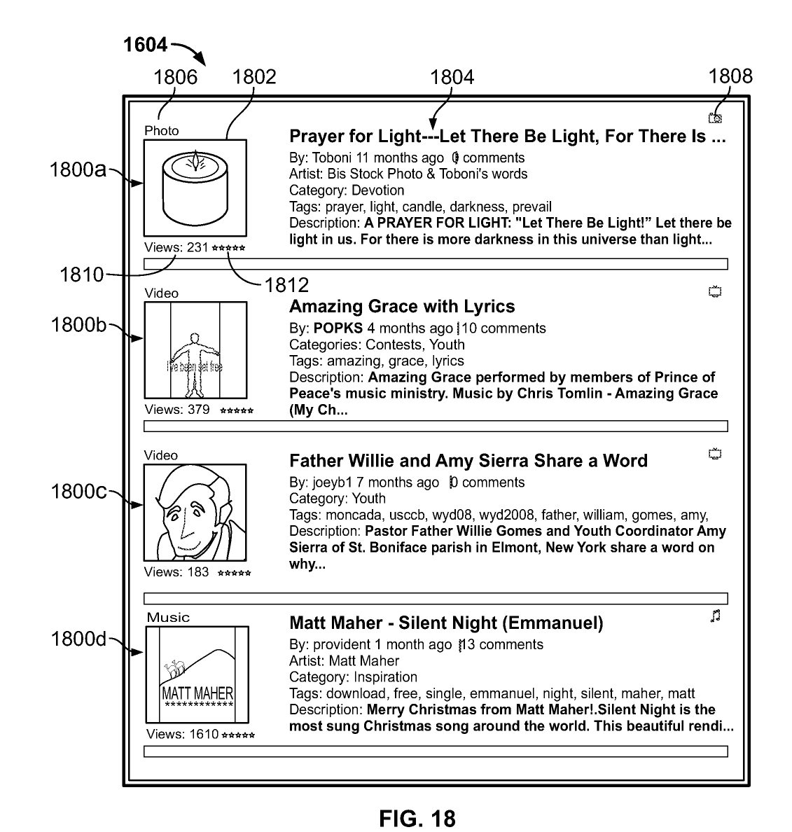

Browsing section 1604 displays a set of media items that match the current search settings. Any number of media items can be displayed, but typically a limit is set for each page so that the page does not get excessively long. For example, a results menu 1606 can be provided to allow a user to select the maximum number of results to be displayed per page. In this example, results menu 1606 is a pull down menu that allows a user to select from 1, 4, 8, and 12, but any other numbers can be used. When a number is selected, media browsing page 1600 is updated to display a maximum of that many media items (or less if fewer total search results were found for the search settings). The page is currently set to limit the results to four media items. Browsing section 1604 is illustrated and described in more detail with reference to FIG. 18.

In some embodiments media browsing page 1600 also includes an inspirational section 1314 and footer links section 1310, similar to those shown and described elsewhere herein. A navigation section 1614 is also included in some embodiments to allow navigation among multiple pages of media items. Additional sections are included in some embodiments, such as advertisement sections 1610 and 1612. Fewer sections are included in other embodiments.

FIG. 17 is a screen shot of an example header 1602 of a media browsing page 1600, shown in FIG. 16. Header 1602 includes various features that allow the user to navigate among various media types, and also includes various tools to define search settings. In this example, header 1602 includes search scope display 1702, search section 1704, navigation tabs 1706, media type filter 1708, sort section 1710, and category section 1712.

Navigation tabs 1706 allow a user to navigate away from media browsing page 1600 to one of various other pages within web site 11100. The navigation tabs 1706 also indicate the current page that is selected. Navigation tabs 1706 include, for example, a media tab, a groups tab, a blogs tab, and a people tab. Media tab of navigation tabs 1706 is highlighted to indicate that the media browsing page 1600 is currently selected.

Search scope display 1702 provides a brief textual description of the current search scope. In this example, the display shows “Media: All” to indicate that media items are currently being displayed, and that all media types are included. When a user selects another navigation tab, the display is updated to show the respective section (e.g., groups, blogs, or people), and what types are being displayed (e.g., all or only a selected type).

A keyword search can be performed using search section 1704. Search section 1704 includes keyword input field 1720, search type selection menu 1722, and search button 1724.

Keyword input field 1720 can receive one or more keywords from a user. If only a single word is entered, a search is performed for all media items that include the keyword. In some embodiments the search is limited to an exact match. In other embodiments the search includes both the keyword and variations of the keyword (e.g., plurals or other forms of the keyword, such as the name “Matthew” as well as the short form of “Matt”). If multiple words are entered, a search is performed for all media items that include all of the keywords in any order or location. In some embodiments the keyword search looks through the following fields associated with the media items to locate matching media items: title, description, author, and tags. Quotation marks can be used in some embodiments to limit search results to those having a particular arrangement of words. Other embodiments allow Boolean operators (or associated symbols) to define more advance keyword searches.

Once a keyword search has been entered, the type of search is defined using search type selection menu 1722. In one example the search type selection menu 1722 includes the following options: best match, artist name, and title search.

If “best match” is selected, the server searches all content for the items that most closely match the keywords. If “artist name” is selected, the server searches only for artist names that includes the keywords. If “title search” is selected, the server searches only for titles that include the keywords. Metadata associated with media items in the media database (e.g., 103 shown in FIG. 1) is used for such searches in some embodiments.

Once the keywords have been entered into keyword input field 1720 and the search type has been selected from search type selection menu 1722 (or the default type is used), search button 1724 is selected. Once selected the server receives the search request and performs a search of media items in the media database (e.g., 103 shown in FIG. 1) to identify the most relevant search results. Those results, if any, are then displayed in browsing section 1604.

In some embodiments searching is enhances using a Catholic Data Model. The Catholic Data Model is an organized set of data that is stored in a database and associated with media items. In some embodiment the data is metadata. The Catholic Data Model enhances searching capabilities because searches can be performed for media items that have a certain keyword or value in a certain field of the metadata. For example, a search can be performed for a media item that has the keyword “psalms” in the “book of the Bible” field of the metadata to locate media items relating to the book of the Bible named Psalms. In yet other embodiments, the results can further be refined based on the Segment Identifier or Segment Self-Identifier of the user, such as to sort the items by ratings provided by a certain segment.

Media type filter 1708 includes a plurality of buttons that allow a user to define what types of media the user is interested in viewing. In this example, media type filter 1708 includes buttons to select from the following media types: all, music, video, photo, document, podcast, and spoken word. In addition, media type filter 1708 displays the number of search results that have been found for the respective media type. For example, for the search displayed in FIG. 17, the media type filter 1708 shows that there are a total of 13,371 items of any media type, 6,736 items that are music, 2,263 items that are video, 2,405 items that are photos, 263 items that are documents, 452 items that are podcasts, and 1,252 items that are spoken word. Upon selection of one of the media type filter 1708 buttons, the media items displayed in browsing section 1604 is updated to display only those media items having the selected media type.

Sort section 1710 provides a plurality of buttons that allow a user to define the order in which search results should be listed in browsing section 1604. In this example, sort section 1710 includes the following options: most recent, most viewed, highest rated, for purchase. Other embodiments include more or fewer sort or filtering options.

If the Most Recent button is selected, the search results are sorted in reverse chronological order such that the most recent results are listed first. If the Most Viewed button is selected, the search results are sorted according to the number of times each media item has been viewed with the media item with the most views listed first. If the Highest Rated button is selected, the search results are sorted according to the average user rating given to the media item, with the highest average ratings listed first. (As discussed in more detail herein, in some embodiments the highest rating is sorted according to the average rating given to the media items by other users having the same Segment Identifier or Segment Self Identifier as the current user.) If the For Purchase button is selected, the items that are for purchase (e.g., publisher content) are listed first, followed by free user-generated content. In another possible embodiment, when the For Purchase button is selected, a filter is applied to the media items to include only those items that are for purchase. In some embodiments pseudo-publisher generated content (content generated by a user that is offered for sale through the web site) is also included. The web server performs the sorting or filtering after the button has been selected and displays the results in browsing section 1604.

Category section 1712 includes a pull-down menu that allows a user to select a category of media items to be included in the search results. In one example, category section 1712 includes the following categories: All, Family, Friends, Travel, Sports, News Politics, Business Vocations, Prayer, Inspiration, Devotion, Witness Testimony, Comedy, Movies, TV, Books, Bible Scripture, Catechesis, Homilies, Mass, Mary, Parish, Saints, Apologetics, CCD, Grade School, High School, College University, Concerts, Conferences, Contests, Children, Youth, Adult, Seniors, Women, Men, Other. Other embodiments include more or fewer categories. Upon selection of a category, the server updates the search results to limit the search results to those associated with the selected category. The updated search results are then displayed in browsing section 1604, shown in FIGS. 16 and 18.

FIG. 18 is a screen shot of a browsing section 1604 of the example media browsing page 1600, shown in FIG. 16. In this example, browsing section 1604 includes a plurality of media item snapshot displays 1800 (including displays 1800a-d) that each provide information about a single media item or collection of media items.

In this example, each media item snapshot display 1800 includes a thumbnail image 1802, text summary 1804, media type indicators 1806 and 1808, view count display 1810, and rating display 1812.

Thumbnail image 1802 is a small graphic that relates to the media item. Any image may be used as the thumbnail image 1802, but the image typically relates to the media item in some way. Examples of common thumbnail images include an image from the album cover, an image of the artist or user, a graphic including the title of the media item or album, a frame from a video, or other images. In some embodiments the thumbnail image 1802 is also a link to the media page that is associated with this media item. In some embodiments a video or audio clip is used instead of or in addition to an image.

Text summary 1804 provides text-based information about the media item. Text summary 1804 typically begins with a title or description of the media item. Other possible information included in the text summary includes: the name of the artist, the name or username of the user that provided the item, the name of the publisher, an identification of the category or categories of the media item, a list of tags associated with the media item, and a brief description of the media item (typically in a range from about 10 words to about 30 words). In some embodiments a portion of text summary 1804 (e.g., the title) is also a link to the media page that is associated with this media item. In some embodiments other text within text summary 1804 is also linked. For example, in some embodiments the artist name is a link that is associated with a media browsing page including all media items by that artist. As another example, each tag is liked to a media browsing page including all media items that also include that tag. Similarly, the category can be linked to media items sharing the same category. The username of the person that provided the content is also linked in some embodiments to the user profile of the user that uploaded the media item. Alternatively, the link is directed to the profile of that user.

Media type indicators 1806 and 1808 identify the type of this media item. For example, media item snapshot display 1800a includes the word “Photo” for text-based type indicator 1806 and a graphic of a camera for graphical media type indicator 1808. Both of the type indicators 1806 and 1808 indicate that the media item is a photograph or image. Other possible media types include, for example: music, video, document, podcast, and spoken word. Some embodiments include only one media type indicator.

View count display 1810 includes the text “views:” followed by a number. The number is the number of times that any user has viewed this media item. In other possible embodiments, the number is the number of unique users that have viewed the media item. A benefit of using only unique viewers in the view count is that it reduces the chance that the view count is tampered with by one or small number of users, such as by repeatedly viewing a media item. In another possible embodiment, the view count includes all users except the user that provided the content.

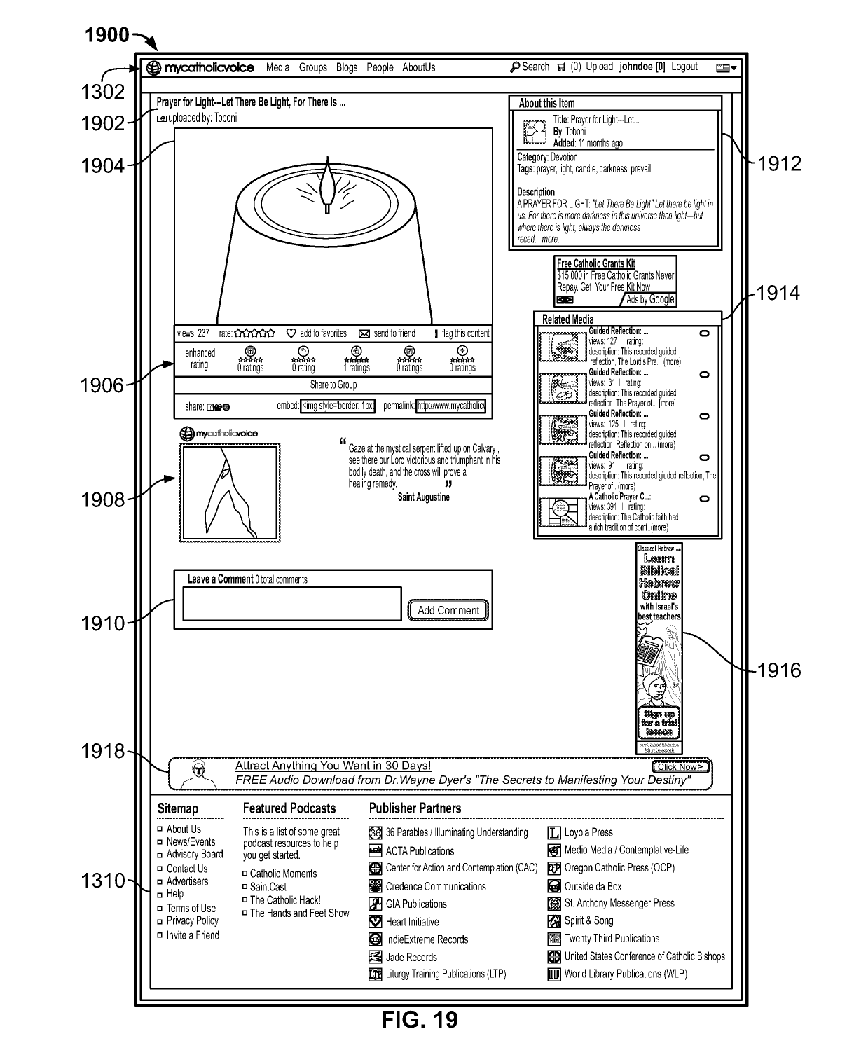

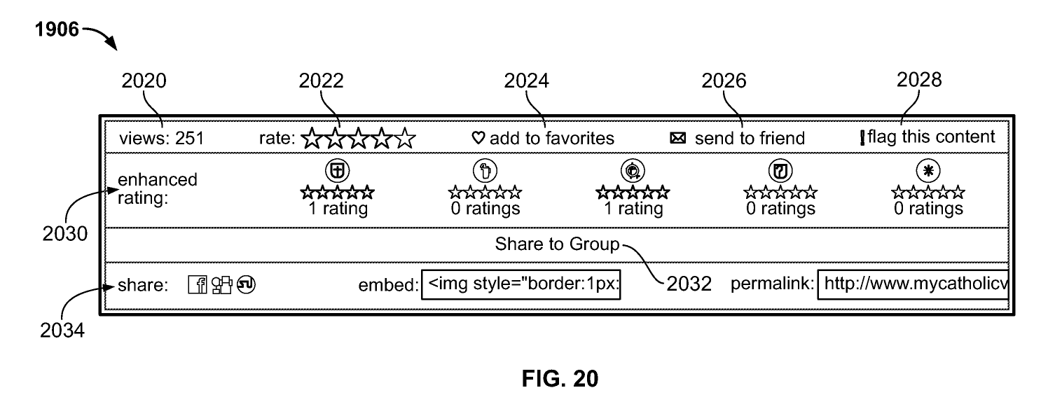

Rating display 1812 is a display that shows the average rating given to this media item by other users. Media items can be rated by users as described in more detail with reference to the example media page shown in FIGS. 19-20. The ratings given are on a scale from zero stars (worst) to five stars (best). The ratings given to a media item are averaged and the result is displayed by rating display 1812. Rating display 1812 similarly displays the average rating using a quantity of stars from zero to five. In FIG. 18 all media item snapshot displays 1800 include five stars, indicating that most users that have rated the item have thought it was very good. In some embodiments rating display 1812 is tied to user Segment Self-Identifiers (SSID) or Segment Identifier. For example, in some embodiments rating display 1812 does not show the result for all users, but rather only the average rating provided by users having the same Segment Self-Identifier as the current logged-in user. In yet another embodiment, rating display 1812 provides multiple rating displays, each display associated with one of the Segment Self-Identifiers. This allows a user to see not only what rating users having the same Segment Self-Identifier gave to the media item, but also what rating users having different Segment Self-Identifiers gave to the media item. Some embodiments include both an overall rating as well as ratings tied to each Segment Self-Identifier.

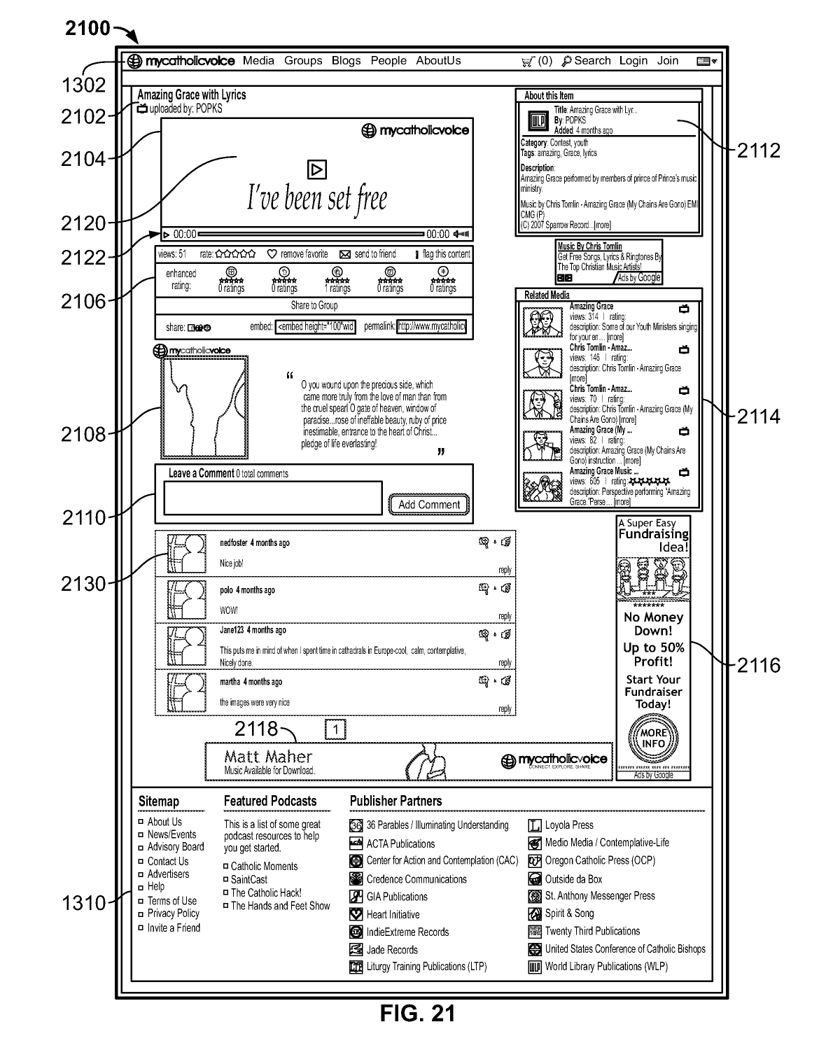

FIGS. 19-24 illustrate examples of media pages associated with various types of media. FIG. 19 is an example media page 1900 associated with an image provided by a user (user-generated content). FIG. 20 is an enlarged portion of media page 1900. FIG. 21 is a media page associated with a video provided by a user (user-generated content).

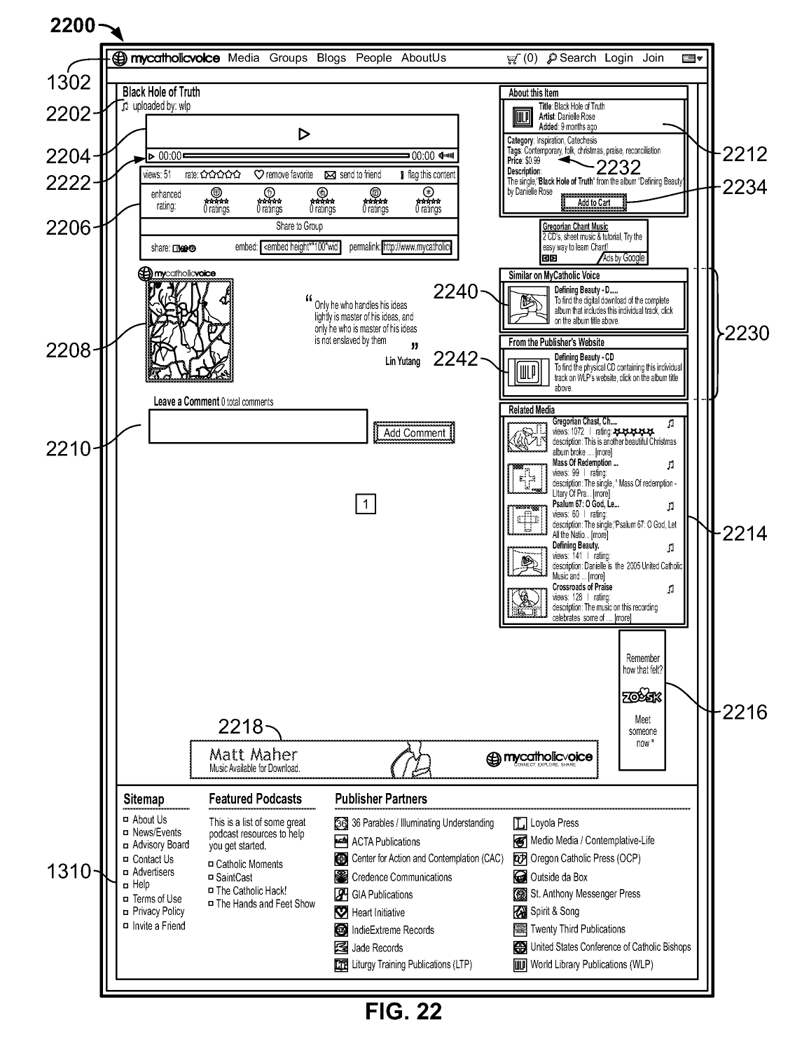

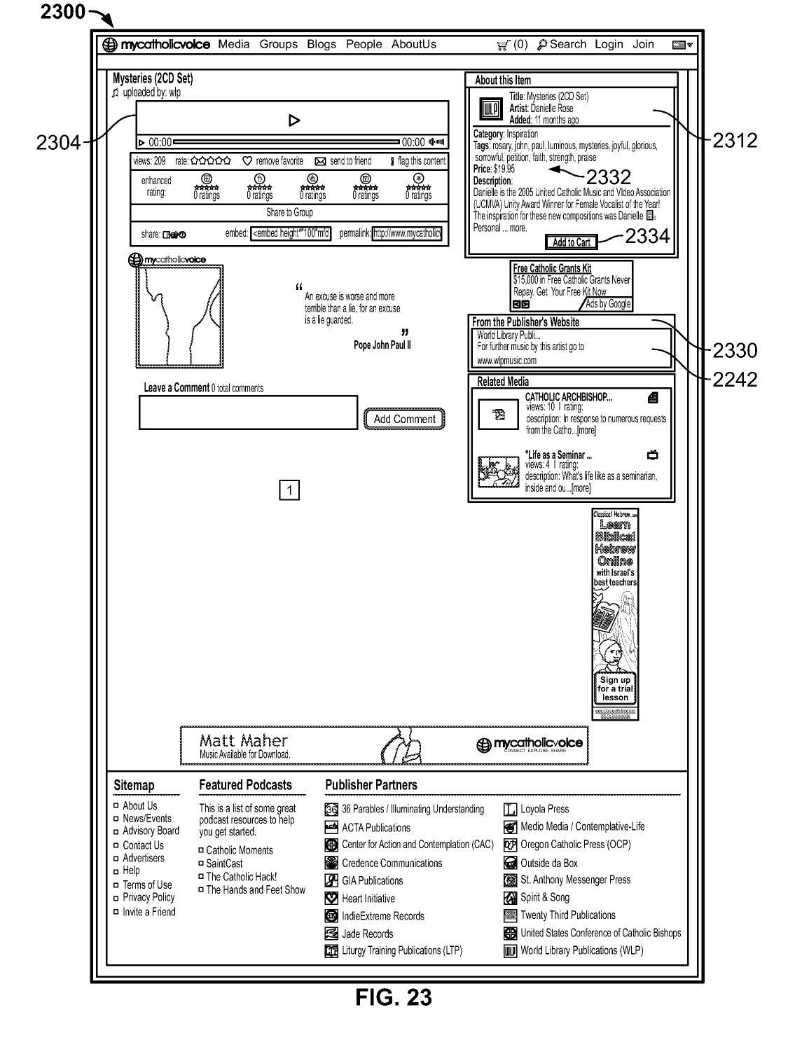

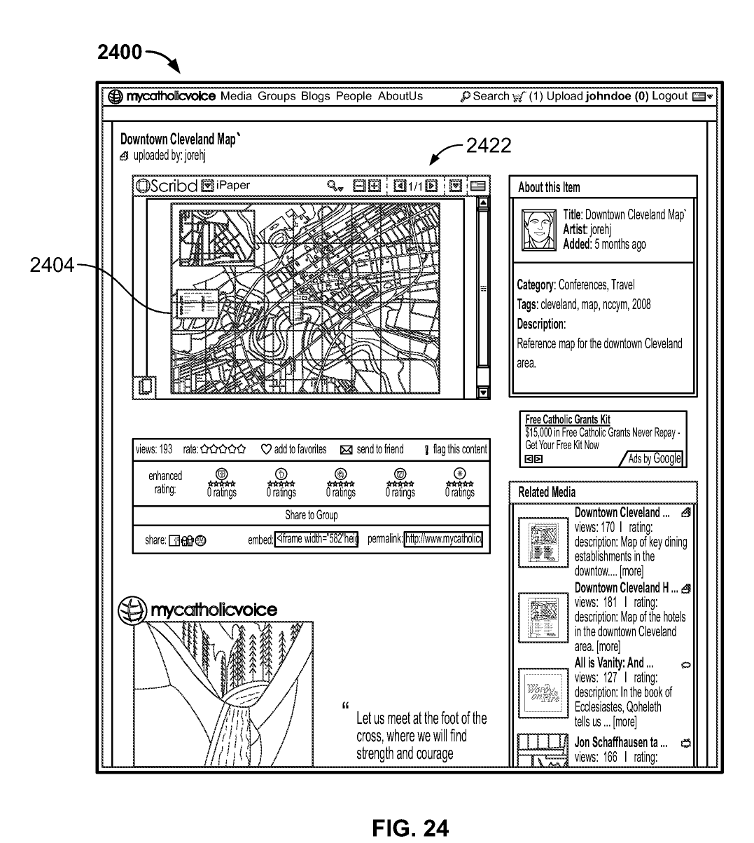

FIG. 22 is a media page associated with music provided by a publisher (publisher content). FIG. 23 is a media page associated with a collection of music provided by a publisher (publisher content). FIG. 24 is a media page associated with a document provided by a user (user-generated content).

FIG. 19 is a screen shot of an example media page 1900. In this example the media item is a photograph of a burning candle, which was uploaded by a user. Media page 1900 includes primary navigation bar 1302, title bar 1902, media player section 1904, tool bar 1906, inspiration section 1908, comments section 1910, about this item section 1912, and related media section 1914, advertisements 1916 and 1918, and footer links section 1310.

Title bar 1902 shows a text-based title for the media item. In some embodiments the author, user that uploaded the media item, or the publisher is also identified in title bar 1902. In this example, the title bar 1902 shows “Prayer for Light—Let There Be Light, For There Is . . . ” and “uploaded by Toboni.

In this example, the media item is user-generated content. User-generated content is typically freely available to users through the web site (although other embodiments allow a user to post content for a fee). As a result, media page 1900 displays the full content of the media item in media player section 1904. In this example, media player section 1904 includes a photograph of a burning candle. Because most browsers are pre-configured to display images, no special media player is necessary to display the picture in most embodiments.

Some embodiments include tool bar 1906. The example tool bar 1906 is illustrated and described in more detail with reference to FIG. 20. Comments section 1910 allows users to leave a comment regarding the media item. Comments are displayed publicly below the comment field (as shown in FIG. 21). Inspiration section 1908 is provided in media page 1900 in some embodiments to enhance the user's experience. A similar inspiration section (inspirational section 1314) is illustrated and described in more detail with reference to the home page 1300, shown in FIG. 13.

Additional information about the media item 1912 is provided in the about this item section 1912. Some possible information in this section includes the title, the author or artist, the user who uploaded, the publisher, the category or categories that the media item is associated with, the tags associated with the media item, and a description. If the description exceeds a predetermined length (e.g., in a range from about 25 to about 50 words, or in a range from about 100 to about 500 characters), the description can be truncated in the initial display of media page 1900, with a “more” link provided. If the user wants to read the rest of the description, the user selects the “more” link. Media page 1900 then expands to include the full description.

Related Media section 1914 is provided in some embodiments to display additional media items that are related to this media item. A related media item can be related for various reasons, such as by having been uploaded by the same user or publisher, by sharing a common category or tag(s), or by sharing common keywords or other metadata. In some embodiments related media is selected based on a user's Segment Identifier or Segment Self-Identifier, so as to suggest related media that is more likely to be appreciated by the user.

Advertisements 1916 and 1918 are provided on media page 1900, in some embodiments, for focused advertising. Footer links section 1310 is also provided at the bottom of media page 1900 in some embodiments.

FIG. 20 is a screen shot of an example tool bar 1906 of the media page 1900, shown in FIG. 19. In this example, tool bar 1906 includes view count display 2020, rating tool 2022, add to favorites tool 2024, send to friend tool 2026, flag this content tool 2028, enhanced ratings bar 2030, share to group tool 2032, and sharing links 2034.

View count display 2020 displays the total number of times the media item has been viewed by all viewers. Rating tool 2022 permits a user to rate the media item on a scale from one stars to five stars (other embodiments have other scales, such as a scale from one to ten). To provide a rating, the user clicks on the appropriate star to assign the rating. The left-most star is equal to a rating of one star (worst). The next is two stars. The right-most star is equal to a five star (best) rating. When the user moves a pointer over the stars, that star and all stars to the left of it (if any) are highlighted to show the user what rating is represented by that star. Once selected, the rating is recorded in the media database associated with this media item. In some embodiments, the users rating is also stored in the user database and associated with the current user. This allows the server to learn what type of media the user likes and what type of media the user dislikes. This information can be used by the server to recommend other media items through the web site to this user (or other users, such as other users having the same Segment Self-Identifier).

Add to favorites tool 2024 can be selected by the user to add this item to a list of the user's favorite media items. The list of favorites can be viewed in the user's profile page, discussed in more detail herein with reference to FIG. 35. Send to friend tool 2026 is used to send a link via email to this media item to a friend. Upon selection, media page 1900 displays an e-mail form that prompts the user to enter the friends name and e-mail address, the current user's name and e-mail address, and provide a short message to the friend. When completed, the message is sent to the user along with a link to media page 1900. Flag this content tool 2028 is a button that can be selected when a user believes that the content of a media item is inappropriate for web site 1100. Upon selection of content tool 2028, a message prompt is displayed asking the user to describe the reason that the media item is inappropriate. In some embodiments the user is required to select a reason that the content is inappropriate from a list of reasons. An example of a list of reasons includes: mature, hate speech, or other Terms of Use violations. Other embodiments include more, fewer, or different reasons. Once completed, the message is sent to an administrator of web site 1100 for consideration. If the administrator agrees, media page 1900 is removed for the associated media item and the media item is deleted from the media database.

Enhanced ratings bar 2030 includes a plurality of rating displays for the media item. Each rating is associated with a Segment Self-Identifier. The Segment Self-Identifier is discussed in more detail herein. Briefly, the vertical set of users of web site 1100 is further divided into a number of different segments. In this example, the vertical set of users includes those users who have an interest in the Catholic faith. This set of users is further divided into a plurality of segments, such as five segments. The five segments in this example are (from left to right): Defend The Rules, Follow The Rules, Consider The Rules, Do Not Know The Rules, and The Rules Do Not Apply to Me. Each user is associated with one of these Segment Self-Identifiers. The “rules” referred to in this example of Segment Identifiers refer to the Magesterium of the Catholic Church. Because of the diversity of the set of all users, the rating that one user gives to a media item may not be useful to another user having very different views from that user. Enhanced ratings allow users to see how the media item was rated by others who share the same Segment Self-Identifier, and also how it was rated by those who have different Segment Self-Identifiers. This information can be useful to a user in determining whether or not to consider the media item further, and (in the case of publisher content) whether or not to purchase the media item.

In some embodiments, media page 1900 also includes share to group tool 2032 and sharing links 2034. Upon selection of the share to group tool 2032, media page 1900 displays a Share To Group window in which the user can identify which groups to share the item with. The window includes a list of all groups media modules to which the user is currently a group administrator. After the group media module(s) have been selected, the server updates the database to associate that media item to that group module. Groups are discussed in more detail below. Sharing links 2034 allow users to interconnect the media page 1900 with external systems or third-party services (e.g., 110, shown in FIG. 1). In this example, links are provided to allow sharing with third-party services such as facebook, digg, and stumble upon. In addition, URLs are provided to allow a user to easily embed the media item in their own or other web sites (embed), or to link directly to the media page (permalink) from their own or other web sites.

FIG. 21 is a screen shot of another example media page 2100. In this example, media page 2100 is associated with a video provided by a user (user-generated content). Media page 2100 is similar to media page 1900 (described above with reference to FIG. 19), and a description of each section of media page 2100 will not be repeated below. Media page 2100 includes primary navigation bar 1302, title bar 2102, media player section 2104, tool bar 2106, inspiration section 2108, comments section 2110, about this item section 2112, and related media section 2114, advertisements 2116 and 2118, and footer links section 1310. In this example, media player section 2104 includes video display 2120 and video controls 2122.

User generated content is freely available through web site 1100. As a result, media player section 2104 of media page 2100 includes the full content of this video uploaded by a user. To play the media, the user either clicks on the video display 2120 or clicks on the play button in video controls 2122. The video then plays in media player section 2104. If the video has sound, the sound is also output through an audio generator (e.g., speakers or headphones) of the computing device (e.g., the user's computer). Video controls 2122 also include additional controls in some embodiments, such as a playback position control strip, a full-screen playback button, and a volume control tool.

One example of a media player for use in media player section 2104 is the JW FLV Media Player open source media player distributed by LongTail Video. Other examples of media players include WINDOWS MEDIA® player distributed by Microsoft Corporation, and QUICKTIME® media player distributed by Apple Inc.

Comments section 2110 is similar to comment section 1910 shown in FIG. 19. In this example, several users have provided comments. The comments are displayed in comment windows 2130. In some embodiments, comment windows 2130 allows users to rate the comments. In this example, a thumbs up button and corresponding thumbs down button can be selected by a user to indicate whether they like or dislike the comment (or to indicate the helpfulness of a comment). Comments section 2110 uses the ratings in some embodiments to sort comments from best to worst. Some embodiments also include a reply button. The reply button allows a user to post a reply to a comment, which is displayed in comments section 2110. In some embodiments an e-mail message is also sent directly to the user who wrote the original comment, to inform that user that a reply was posted.

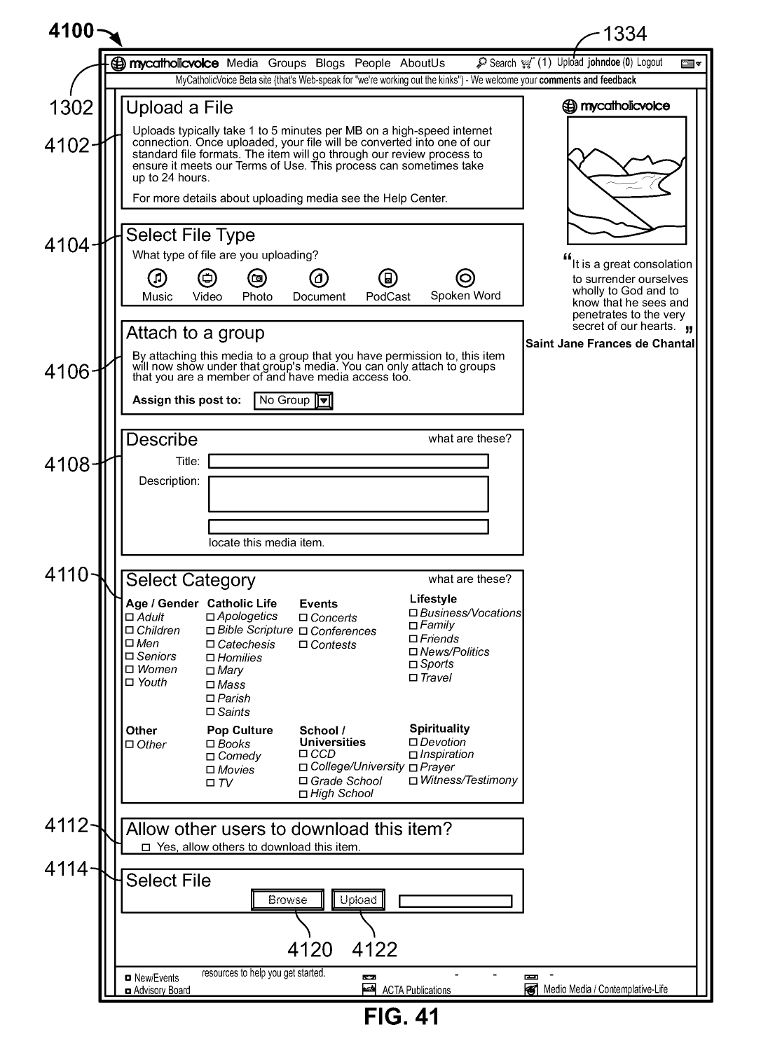

About this item section 2112 provides additional information about the media item. If the user who uploaded the content has chosen not to allow others to download the media item, there is no option available to download the content (see publication settings section 4112 shown in FIG. 41). Alternatively, if the user allows the media item to be downloaded, a download button is provided in about this item section 2112.

If the media item is enjoyed, the user may choose to review the items shown in Related Media section 2114 that are related to this item. Some of those items may be publisher content that is available for purchase.

FIG. 22 is a screen shot of another example media page 2200. In this example, the media item associated with media page 2200 is music (a song) provided by a publisher (i.e. publisher content) and available for sale through web site 1100.

Media page 2200 is similar to media page 1900 (described above with reference to FIG. 19) and media page 2100 (described above with reference to FIG. 21), and a description of each section of media page 2200 will not be repeated below. Media page 2200 includes primary navigation bar 1302, title bar 2202, media player section 2204, tool bar 2206, inspiration section 2208, comments section 2210, about this item section 2212, and related media section 2214, advertisements 2216 and 2218, and footer links section 1310. In this example, media player section 2204 includes audio controls 2222. Media page 2200 also includes price display 2232, add to cart button 2234, and additional content display region 2230 including Similar On This Site section 2240 and From the Publisher's Website section 2242.

A difference between media page 2200 and media pages 1900 (FIG. 19) and 2100 (FIG. 20) is that media page 2200 includes an option to allow a user to purchase the full content of the media item. Accordingly, media page 2200 includes a price display 2232 that displays the price of the media content and an Add to Cart button 2234 that adds the media item to the user's shopping cart when it is selected.

Publisher content is generally not freely available through web site 1100 unless the user chooses to purchase the media item. However, in order to allow the user to sample the media item, media player section 2204 provides at least some access to the media item without requiring the user to pay for it. Some limitations are placed on the media item in most embodiments. For example, in some embodiments media player section 2204 is configured to only play a portion of the media item, such as a thirty second clip. Other embodiments are configured to play a portion of the media item having a duration in a range from about ten seconds to about two minutes, and preferably in a range from about twenty seconds to about sixty seconds. Other embodiments place other restrictions on the media item. For example, in some embodiments the full duration of the media item is available in media player section 2204, but the use of the media item is restricted to streaming the media item through media player section 2204. In other words, in some embodiments a user cannot download the media item and use it separate from media player section 2204 unless the media item has been purchased. Accordingly, media player section 2204 does not typically include an option to save the media content to the user's computing device.

In some embodiments the media content provided through media player section 2204 is not the same or even a portion of the same media item. Rather, in some embodiments a separate media item is provided as the sample media content. An example is a promotional video that describes or explains the media item. Another example is a brochure (such as a PDF document), a presentation (such as a POWERPOINT® presentation graphics program) about the media item, or another type of sample media content.

As noted above, About This Item section 2212 includes additional information for the publisher content. In this example, the price display 2232 shows the price to purchase the full content of the media item. Add to Cart button 2234 allows the user to add the full content of the media item to the user's shopping cart. If Add to Cart button 2234 is selected by the user, the button is updated to display “In Cart.” In addition, the shopping cart button 1332 of primary navigation bar 1302 (described with reference to FIG. 13) is updated to show an additional item is in the shopping cart. The user can complete the checkout process by selecting shopping cart button 1332, if desired.

Additional content display region 2230 is a region that, in some embodiments, a publisher can use to display additional related content that may be of interest to the user. In this example, the publisher has included a Similar On This Site section 2240 and From the Publisher's Website section 2242. In this example, the Similar On This Site section 2240 provides a link to the media page for the full album (having a plurality of songs). Other embodiments provide links to other media pages on web site 1110, as desired by the publisher. From the Publishers Website section 2242 is a section that provides a link directly to a page on the publisher's web site. This allows the publisher to direct users to their site where the user can get further information or download or purchase additional media items or materials. In another embodiment the link may direct users to other web sites where they can get further information or download or purchase additional media items or materials. For example, in some embodiments the publisher may choose to link to physical products available on their own web site or a third-party web site, such as AMAZON®.

FIG. 23 is a screen shot of another example media page 2300. In this example, the media item associated with media page 2300 is a collection of music (a plurality of songs) provided by a publisher (i.e. publisher content) and available for sale through web site 11100.

Media page 2300 is similar to media page 2200 (described above with reference to FIG. 21), and a description of each section of media page 2300 will not be repeated below. Media page 2300 includes media player section 2304, about this item section 2312, price display 2332, add to cart button 2334, and additional content display region 2330 including Similar From the Publisher's Website section 2342.

In this example, media page 2300 is associated with a collection of music, namely a two compact disc set of songs. Media player section 2304 provides a sample of the music, such as a portion of one of the songs. In some embodiments the sample places at least some limitations on the media item, such as by limiting the sample duration to a partial duration of the media item. Other embodiments include portions of multiple songs. Yet other embodiments include the full content for one or more of the songs. Still other embodiments include the full content of all songs, but only allow the content to be streamed through media page 2300.

The full content of the two compact disc set is made available in About This Item section 2312 for a price identified in price display 2332. If the user would like to purchase the full media item, the user selects the Add to Cart button 2334.

In this example, additional content display region 2330 includes Similar From the Publisher's Website section 2342, which includes a link to a page of the publisher's web site.

FIG. 24 is a screen shot of another example media page 2400. This example is provided to show that media items are not limited to audio (music or spoken word), video, or images. In this example, media page 2400 displays a map that was uploaded by a user in a portable document format (.pdf). Media page 2400 includes media player 2404 having toolbar 2422.

In some embodiments, media pages such as media page 2400 are also configured to display documents in formats other than image files, video files, or audio files. Media player section 2404 is provided for this purpose. In this example, media player section 2404 includes the iPaper document viewer distributed by Scribd. The media player of media player section 2404 allows media page 2400 to display media items from a wide variety of file formats. Some embodiments of the media player of media player section 2404 allow the use of the following file formats: Adobe PDF (.pdf), Adobe PostScript (.ps), Microsoft Word (.doc, .docx), Microsoft PowerPoint (.ppt, .pps, .pptx), Microsoft Excel (.xls, xlsx), OpenOffice Text Document (.odt, .sxw), OpenOffice Presentation Document (.odp, .sxi), OpenOffice Spreadsheet (.ods, .sxc), OpenDocument formats, Plain text (.txt), and Rich text format (.rtf).

Toolbar 2422 provides a variety of possible functions. In some embodiments, toolbar 2422 includes one or more of the following tools: E-mail to Friend, Embed Codes, Document Info, Save Document, Print, View Mode, Upload to External Site, Help, and About. Yet further embodiments include one or more of the following: zoom tools, page navigation tools, and a full-screen viewing tools. In some embodiments the Save Document tool is not included to prevent users from saving documents, such as without purchasing the document through web site 1100.

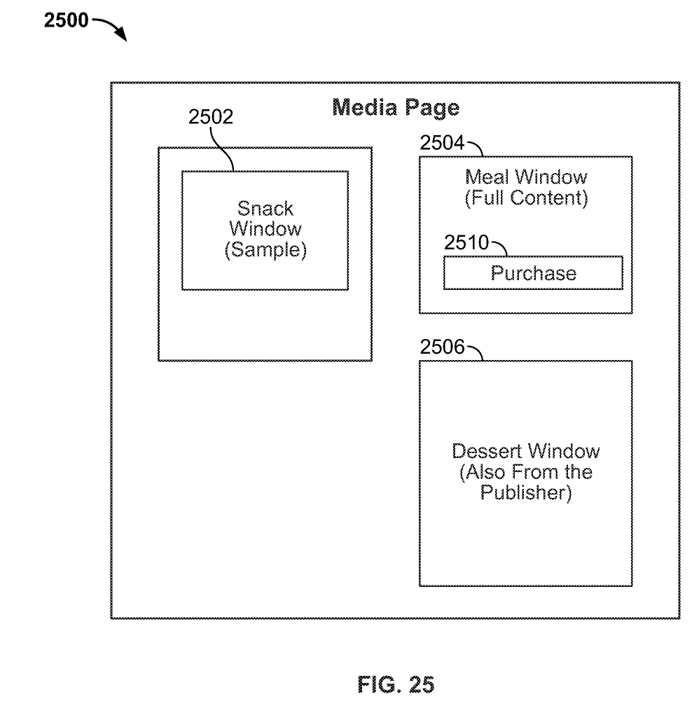

FIG. 25 is a schematic block diagram of an example media page 2500 illustrating the snack, meal, and dessert layout. In some embodiments the snack, meal, and dessert layout is used only for publisher content or content that is available for purchase through web site 11100.

In this example, media page 2500 includes snack window 2502, meal window 2504, and dessert window 2506. Snack window 2502 typically includes a media player to provide a sample of the media item or other media content related to the media item. Meal window 2504 typically includes information about the full content of the media item, and provides a link or button (such as purchase button 2510) that can be selected to initiate the purchase of the full content of the media item. Dessert window 2506 typically includes links to additional content (either within web site 1100 or external to web site 1100) related to the current media item.

Examples of snack window 2502 are media player sections 2204 and 2304 shown in FIGS. 22 and 23. Examples of meal window 2504 are About this Item sections 2212 and 2312 shown in FIGS. 22 and 23 (including Add to Cart buttons 2234 and 2334). Examples of dessert window 2506 are additional content display regions 2230 and 2330.

An example arrangement of the windows of media page 2500 are as follows. Snack window 2502 is prominently displayed near a top of media page 2500, such as toward the left top corner. Meal window 2504 is also displayed near the top of media page 2500, such as toward the right top corner (to the right of snack window 2502). Dessert window 2506 is displayed below snack window 2502 and meal window 2504, such as toward the right and directly below meal window 2504. Other embodiments include other arrangements.

As discussed in more detail herein, the content of the snack window 2502, meal window 2504, and dessert window 2506 can be defined by a publisher. An online publisher upload interface is used for this purpose in some embodiments. In other embodiments a spreadsheet and batch upload interface is used for this purpose.

The snack, meal, and dessert layout shown in FIG. 25 is typically only used with publisher content or content that is available for purchase on web site 1100. One reason for this is that user-generated content is generally not provided as a sample (although, in some embodiments the user-generated content is limited in that it is not available for download from the web site 1100). Similarly, user-generated content is generally not available for purchase, and so there is no need for a meal window where the full content can be purchased. Finally, users are typically not given the option to define the layout of media content, and therefore are not given the option to define the content of a dessert window. However, in other possible embodiments media page 2500 is used for user generated content and users are permitted to interact with web site 1100 in the same manner as publishers discussed above.

FIGS. 26-32 illustrate examples of the group functionality of example web site 1100. Groups provide users with an opportunity to be a part of an online community through web site 1100, in some embodiments. Further, in some embodiments groups provide a convenient location for the storage of information and media associated with an event.

FIG. 26 is a screen shot of an example group browsing page 2600. The group browsing page is accessible through a variety of paths in some embodiments. For example, the user can select the Group tab of navigation tabs 1706 (also shown in FIG. 17). Another path is through the groups button of the primary navigation bar 1302 (also shown in FIG. 13).

Group browsing page 2600 is similar to other browsing pages in some embodiments, such as the media browsing page 1600 described above with reference to FIG. 16. A primary difference, however, is that group browsing page 2600 provides a list of groups, rather than a list of media items. Some embodiments allow searching, sorting, and filtering of groups in a similar manner to media items to aid a user in quickly locating a desired group.

In some embodiments, group browsing page 2600 includes header 2602 and browsing section 2604, among other possible sections. Browsing section 2604 includes sorting tools and a plurality of group snapshot displays 2620 (including snapshot displays 2620a-d). The group snapshots include in some embodiments one or more of the following: a brief overview of the group, such as including an image representing the group, a name of the group, the number of members of the group, how long the group has been active on the web site, a category or categories of the group, a list of group tags, and a brief description of the group.

If a user wants more information about a group or would like to join a group, the user selects the appropriate group snapshot displays 2620a-d.

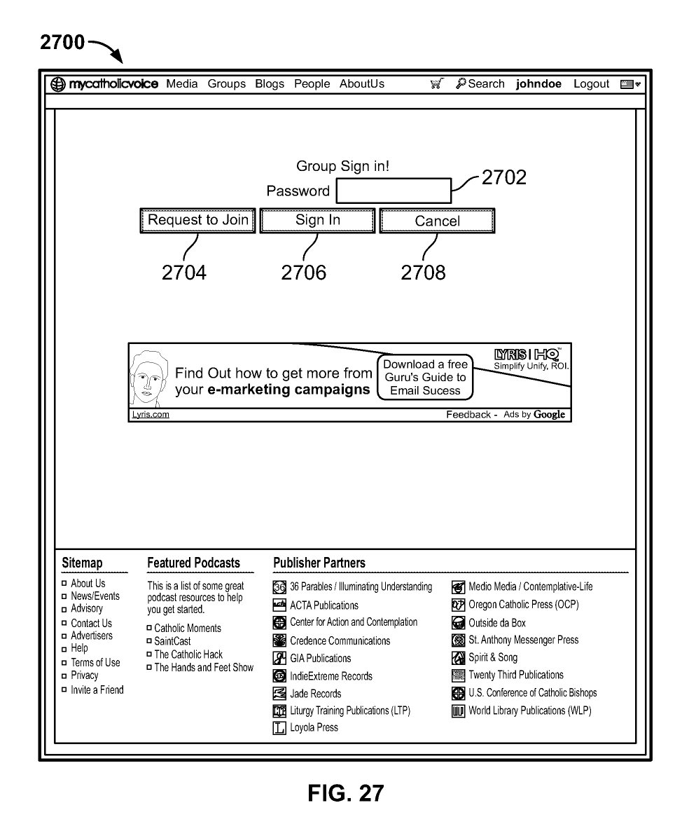

FIG. 27 is a screen shot of an example group login page 2700. Some groups are password protected to control access to information contained within the group. As a result, group login page 2700 is displayed when a user attempts to enter the associated group. Group login page 2700 includes password prompt 2702, Request to Join button 2704, Sign In button 2706, and Cancel button 2708.

If the user has previously registered with a group (or if a group member has previously provided the user with a group password), the user enters the group password into password prompt 2702. The Sign In button 2706 is then selected. If the password is validated by the server, the group page is then displayed to the user.

If the user has not previously registered, the user can select Request to Join button 2704. Upon selection of this button, a message page is displayed that allows the user to send a message to the group moderator. The message is then sent to the moderator who will either accept the request and issue the user a password to the group, or deny the request.

Alternatively, the user can select the Cancel button 2708 to return to the group browsing page (such as shown in FIG. 26).

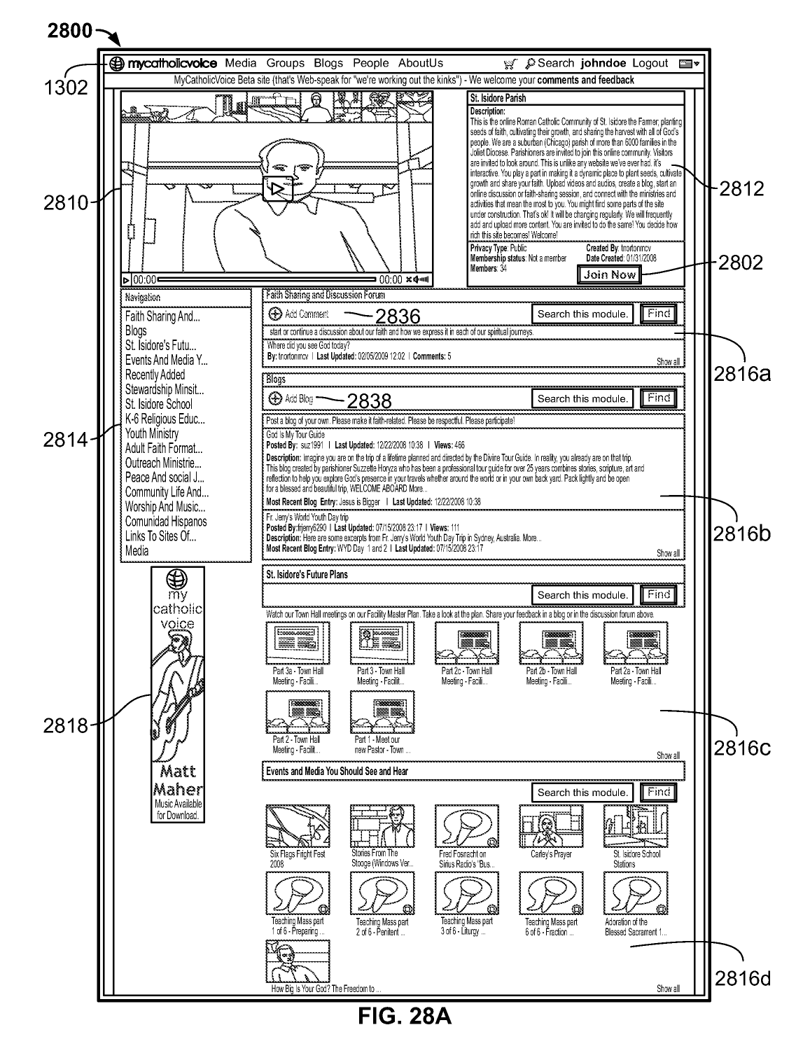

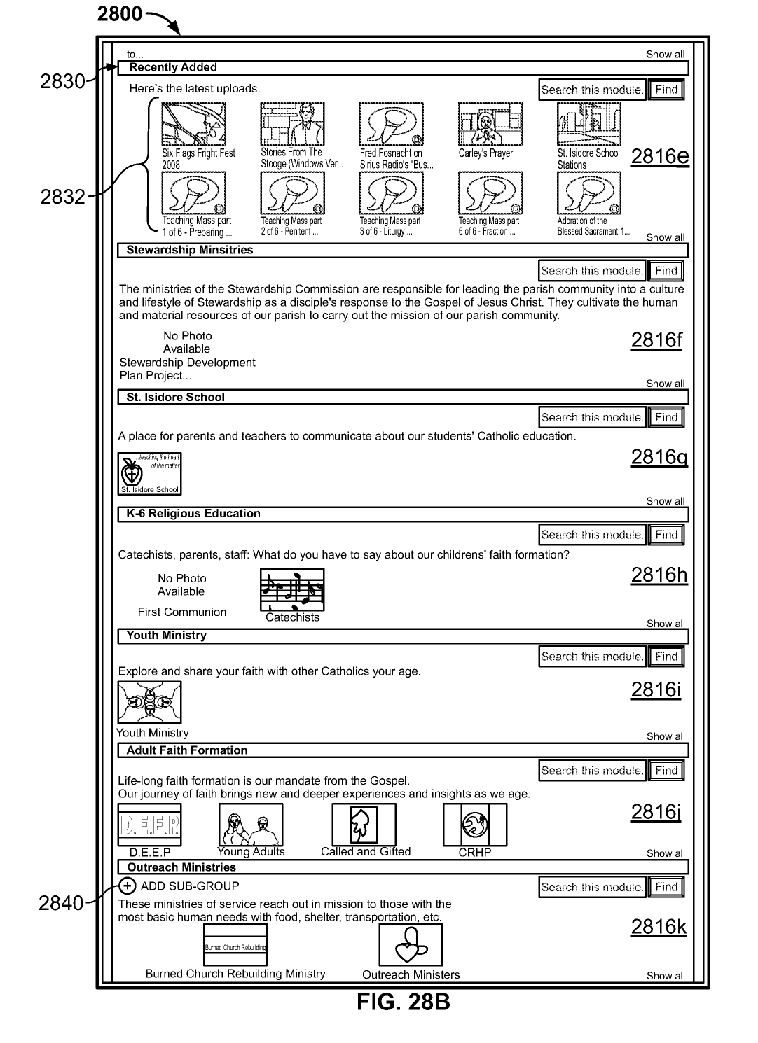

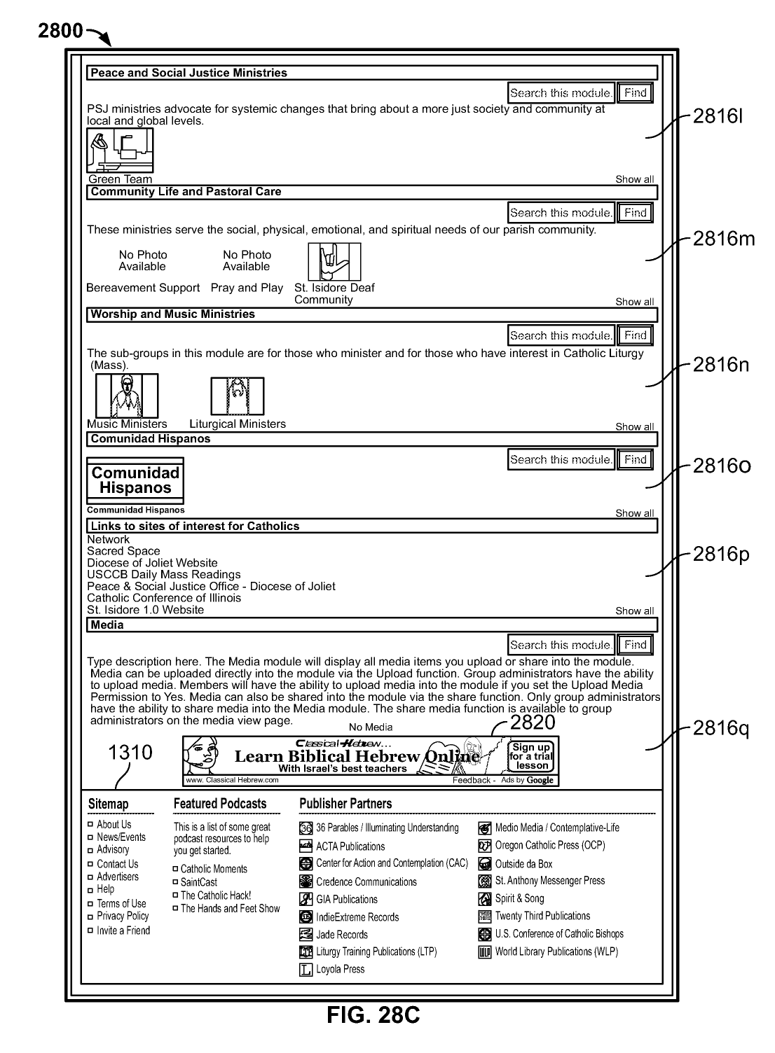

FIG. 28 (spanning FIGS. 28A, 28B, and 28C) is a screen shot of an example group page 2800. In this example, group page 2800 is a media-centric gathering place for users around a common theme. In some embodiments the theme is an existing organization (e.g., church, parish, diocese, non-profit organization, club, Bible study group, etc), a topic (e.g., prayer, Bible study, marriage, alcoholism recovery, etc.), place (a city, town, state, country, etc.), or event (musical concert, youth gathering, holiday, etc.). In this example, the group is formed for users associated with or interested in connecting with others from St. Isidore Parish, a parish located in a suburb of Chicago having more than 6,000 families in the Joliet Diocese.

Because group page 2800 is a part of web site 1100, group page 2800 has access to all of the media content available in the media database (e.g., media database 103, shown in FIG. 1). As a result, some embodiments are media-centric, such that the group is formed around the media content. Media content includes all forms of media content described herein, such as music, spoken word (or other audio), video, images, documents, and kits. In some embodiments groups are defined both by a group page 2800 as well as a set of users that are members of the group. Group membership requires a user to join a group, such as by selecting a join button 2802 provided on the group page.

Group pages such as group page 2800 are highly configurable by the group moderator (the user that forms the group on web site 1100). In this example, group page 2800 includes welcome window 2810, description window 2812, navigation menu 2814, one or more configurable modules 2816 (including modules 2816a-q), advertisement spaces 2818 and 2820, and footer links section 1310.

Welcome window 2810 typically includes one or more media items, such as an image or video. In this example, welcome window 2810 includes a media player that plays a video. The video welcomes the user to the group and provides a brief explanation of the purpose and features of the group.

Description window 2812 provides a text-based description of the group. If the user has not yet joined the group, a join button 2802 is also provided. In some embodiments the description window 2812 also displays additional information about the group, such as a privacy type (private or public), user membership status (member or not member), number of members, username of the user that formed the group (e.g., the moderator), and the date that the group was created. More or less information is provided in other embodiments.

Modules 2816 are sections of group page 2800 that can be configured by the moderator to customize the group page to the unique needs of the group. In this example a plurality of modules 2816 (2816a-q) are included. The example modules include Faith Sharing and Discussion Forum module 2816a, Blogs module 2816b, St. Isidore's Future Plans module 2816c, Events and Media You Should See and Hear module 2816d, Recently Added module 2816e, Stewardship Ministries module 2816f, St. Isidore School module 2816g, K-6 Religious Education module 2816h, Youth Ministry module 2816i, Adult Faith Formation module 2816j, Outreach Ministries module 2816k, Peace and Social Justice module 28161, Community and Pastoral Care module 2816m, Worship and Music Ministries module 2816n, Comunidad Hispanos module 2816o, Links to sites of Interest for Catholics module 2816p, and Media module 2816q.

Each module 2816 typically includes a title bar 2830 and a content window 2832. The title bar 2830 includes a text-based description of the module. The content window 2832 includes the content for that module, including text or media content. In some embodiments the modules are configurable to allow a moderator to define whether the content within each module can be updated by group members or whether the content can only be updated by the moderator. If content is modifiable by users, buttons (e.g., 2836 and 2838) are provided to allow users to add content. When the button is selected, an interface is displayed to allow the user to enter or define the content. For example, when the user clicks on the Add Comment button 2836, the user is taken to the comment page and when the user clicks on the Add Blog button 2838, the user is taken to the Create Blog page. The ability to add content allows users to interact with one another as a community. For example a message board module can be used to post messages viewable by others in the group. A blog module can also be used to author blogs. Photo or video gallery modules are used to share photos or videos. A music module is used to share music, such as by linking to music stored in media database 103 (shown in FIG. 1). Some modules are configured to include multiple types of media in a single module.

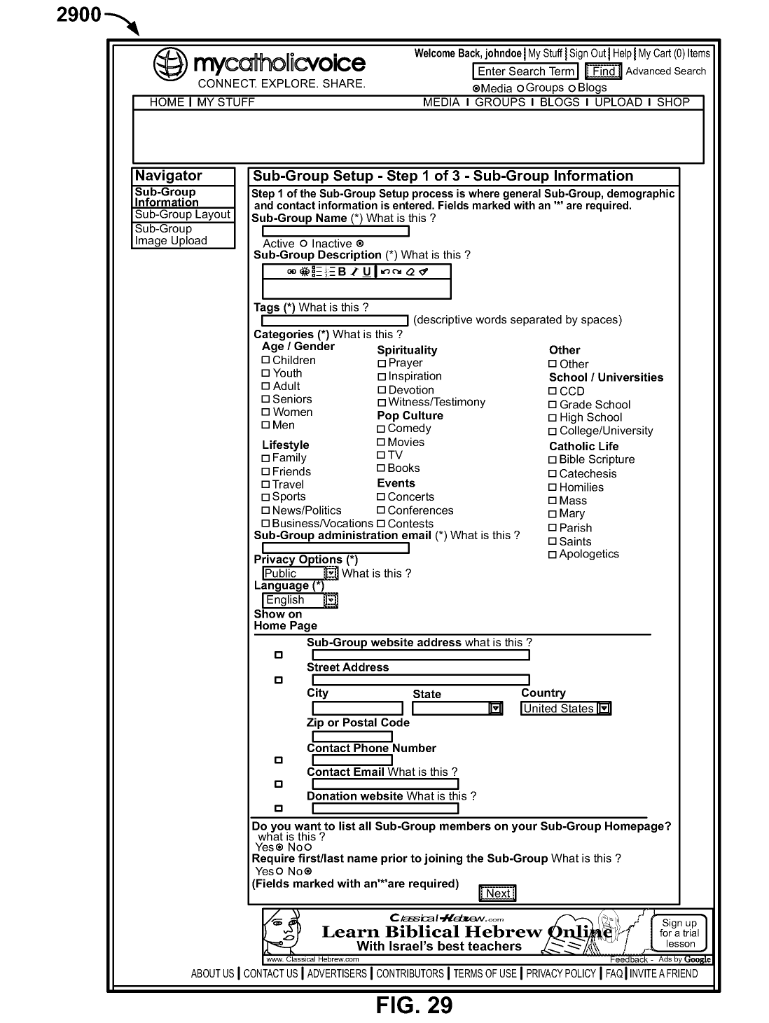

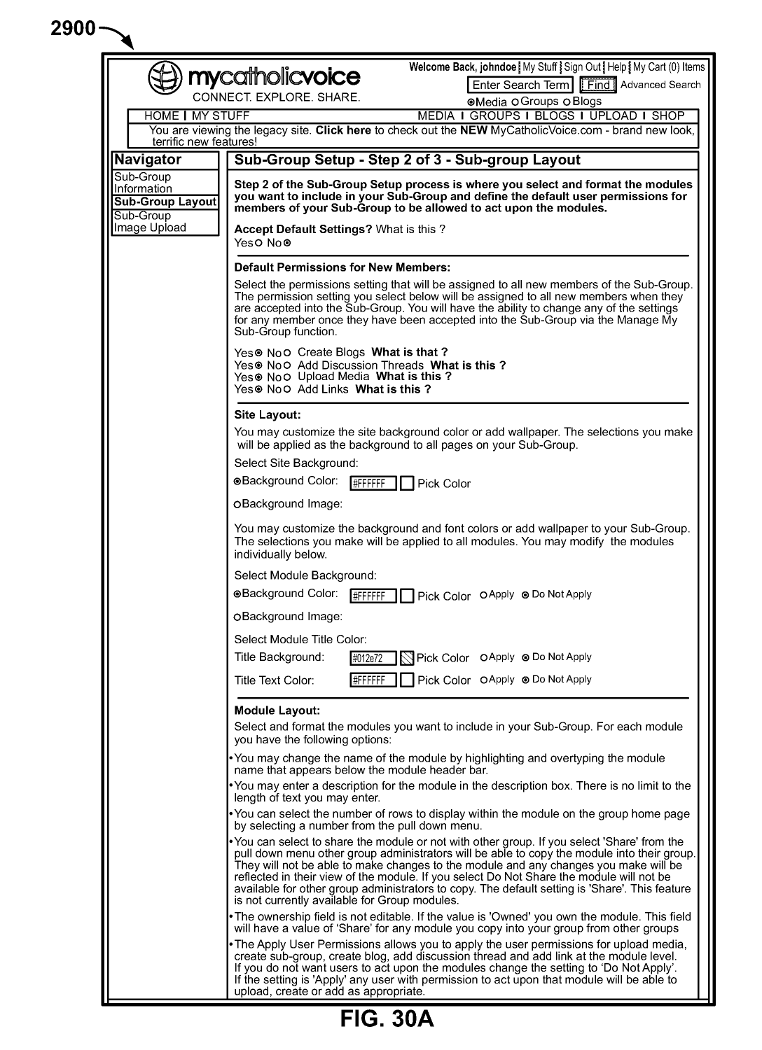

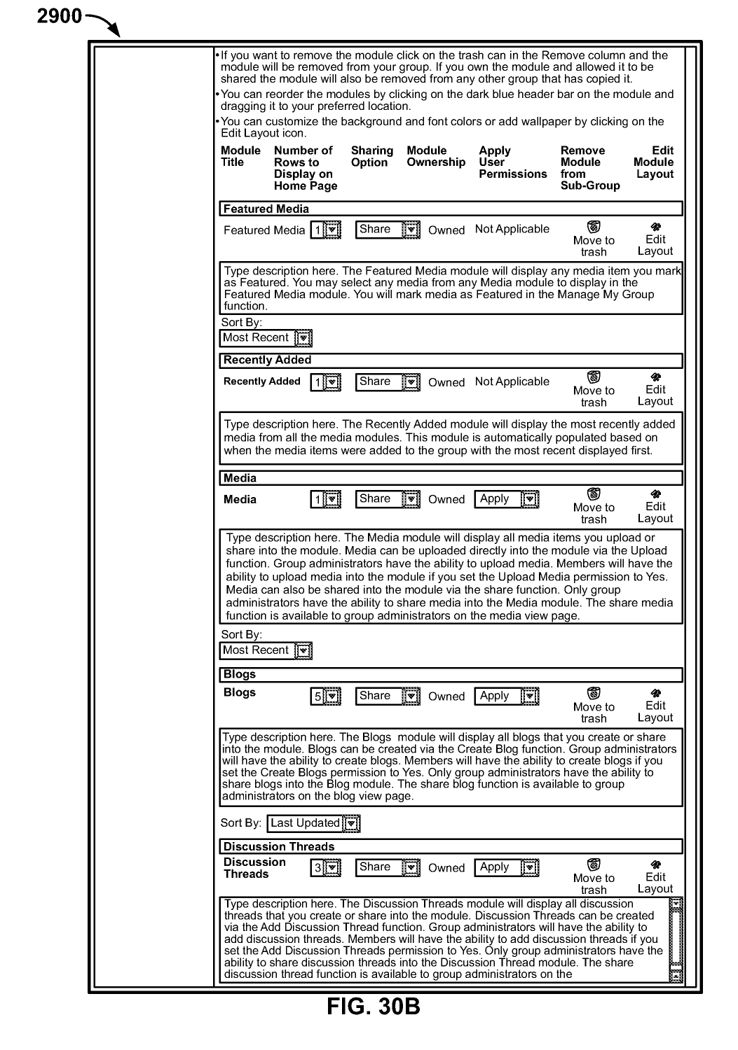

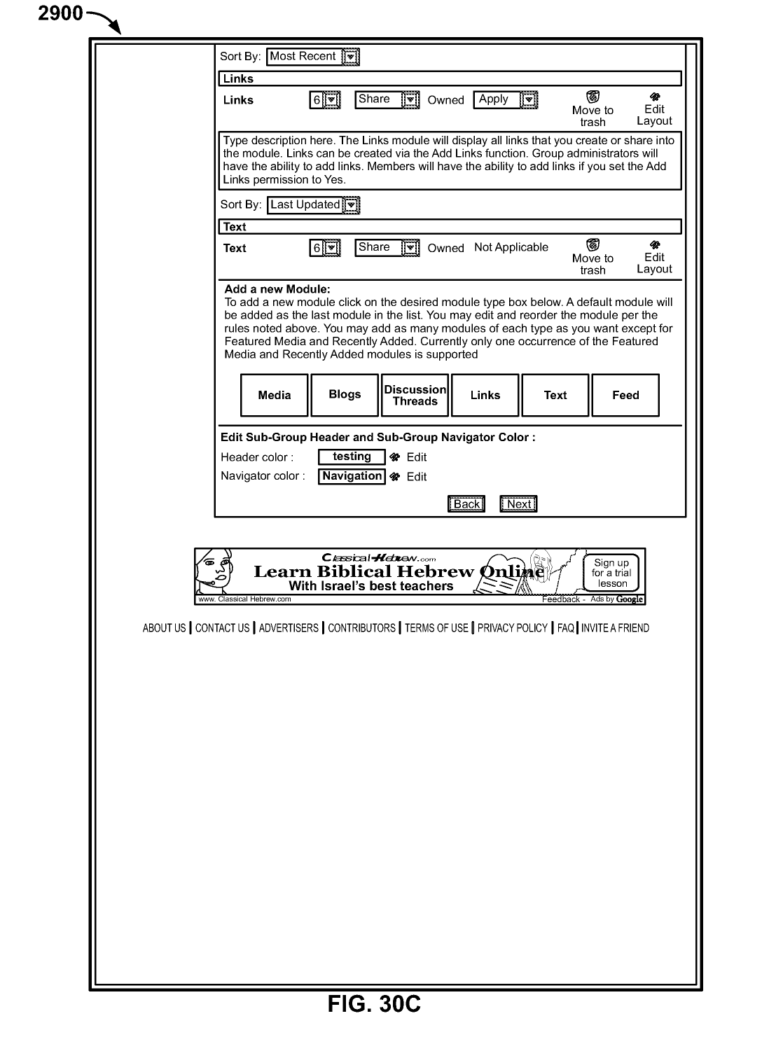

In some embodiments, groups can also include sub-groups. For example, for the St. Isidore group, a set of sub-groups are available through the Outreach Ministries module 2816k. Further, users can define additional sub-groups for other outreach ministries by selecting Add Sub-Group button 2840. Upon selection, web site 1100 guides the user through the formation of a sub-group using the Sub-Group formation module shown in FIGS. 29-31 (including FIGS. 29, 30A-B, and 31). A similar Group formation module is presented to a user when a user wants to create a new group, which guides the user through the formation of the new group.

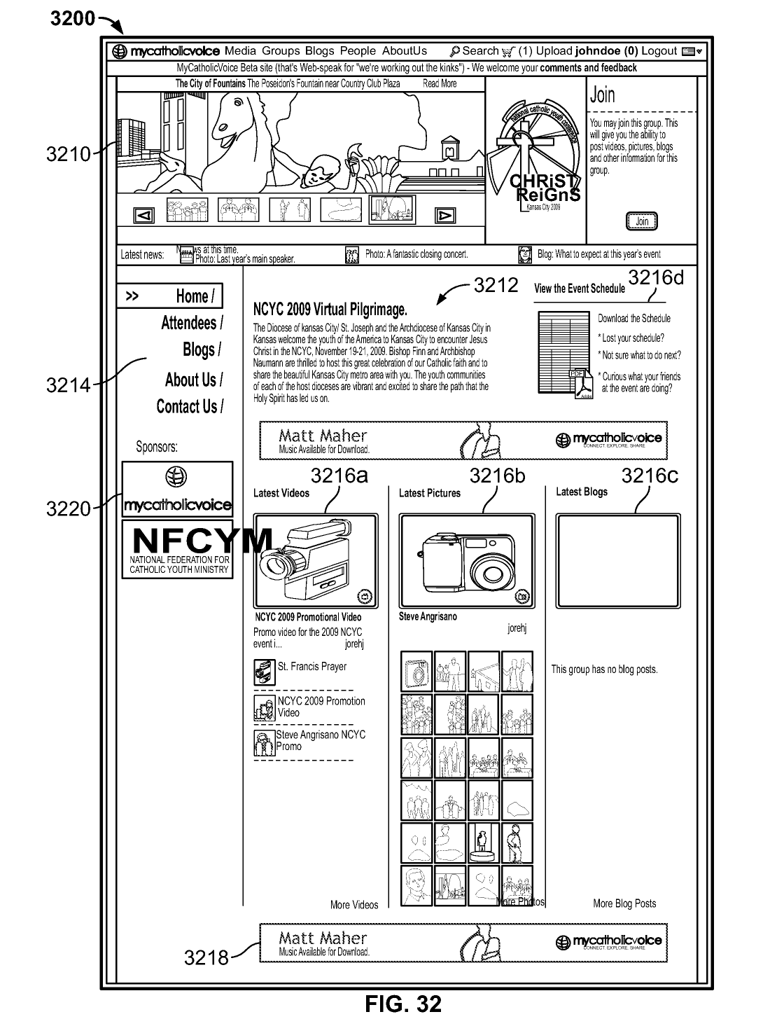

FIGS. 29-31 illustrate an example of a sub-group formation module 2900. The sub-group formation module 2900 is presented to a user to guide the user through a sub-group. A similar group formation module is used in some embodiments to guide a moderator through the formation of a new group. The group formation module includes similar fields that guide the user in the formation of a group, resulting in a group page, such as the example group pages shown in FIGS. 28 and 32.

Detailed instructions for the sub-group formation process are provided in FIGS. 29-31 and therefore will not be repeated here.

FIG. 32 is a screen shot of another example group page 3200. In this example, group page 3200 is formed around an event. The event in this example is the NCYC 2009 to be held in Kansas City later this year. The event organizers, for example, have put together group page 3200 on web site 1100 in order to promote the event. In some embodiments, the group page 3200 also or alternatively allows users to see who else is going, begin to develop relationships with those users that will be at the event, get more information about the event (such as an event brochure, view promotional media items, download or view the event calendar, and view maps of where events will take place.) During the event, group page 3200 can be used to upload and view media items related to the events such as videos or audio files taken at the event. After the event is over, group page 3200 can also be used to re-live the event (such as by viewing pictures or videos of the event) and reconnect with friends or contacts made at the event.

In this example, group page 3200 includes welcome window 3210, description window 3212, navigation menu 3214, one or more configurable modules 3216 (including modules 3216a-d), advertisement spaces 3218, and sponsor banners 3220.

In this embodiment welcome window 3210 includes multiple media items, displayed using a ticker zone, similar to ticker zone 1304 shown in FIG. 14. Description window 3212 provides a text-based description of an event that the group relates to. Navigation menu 3214 is a menu that allows a user to jump to additional pages of the group associated with the selected topic (e.g., home, attendees, blogs, about us, contact us).

Configurable modules 3216 include the following in this example: Latest Videos module 3216a includes links to the latest videos, Latest Pictures module 3216b provides thumbnail versions of the latest photos and links to images; Latest Blogs module 3216c provides links to the latest blog postings; and View the Event Schedule module 3216d provides information about the event schedule, or other event information.

Some embodiments of group pages (not shown in FIG. 32) include a user profile module where a user can see a list of the members of the group. Clicking on a member causes web site 1100 to display the user profile associated with that member, so that the user can learn more about other members. If communication is desired, the user can send an e-mail through web site 1100 to the user or post a message on the member's profile page.

These examples illustrate that group page 3200 is highly configurable to meet the needs of the particular group, and various arrangements of the content and various types of content are provided in different embodiments according to the needs or preferences of the users and group moderators.

Another possible embodiment includes a Diocese Resource Center. The Diocese Resource Center is a group page that is pre-configured for a Diocese. In some embodiments a Diocese pays a periodic subscription fee to establish and/or maintain a group page for the Diocese. In turn the setup and/or maintenance of the group page is handled by administrators or others (e.g., web developers) associated with web site 1100.

FIGS. 33-34 illustrate an example blog feature of web site 1100. Blogs are accessible through a variety of paths in some embodiments. For example, the user can select the Blog tab of navigation tabs 1706 (also shown in FIG. 17). Another path is through the blog button of the primary navigation bar 1302 (also shown in FIG. 13).

In some embodiments a blog browsing page (not separately illustrated) is provided by web site 1100, similar to the media browsing page and the group browsing page previously described. The main difference between the blog browsing page and the media browsing page and the group browsing page is that each browsing section is associated with a blog, rather than a media item or a group.

FIG. 33 is an example blog page 3300. Blog page 3300 is a page where blog posts made entered by a user are displayed through web site 1100. Like other pages in web site 1100, blog page 3300 is highly configurable in some embodiments.

In this example, blog page 3300 includes primary navigation bar 1302, blog title bar 3302, side bar 3304, and post display regions 3306 (including regions 3306a and 3306b).

Title bar 3302 typically includes a text-based title of the blog, although other embodiments include graphics. In this example, the title is “My First Blog—Random Thoughts.”

Sidebar 3304 is a section of blog page 3300 that includes a variety of possible information. In some embodiments, sidebar 3304 includes a description section 3310, about the author section 3312, links section 3314, advertisement sections 3316 and 3318, recent posts section 3320, and archive section 3322. In this example sidebar 3304 is arranged along a right side of blog page 3300, but is arranged in other locations (e.g., a left side) in other embodiments.

Post display regions 3306 typically include a date of the post, post title, and a body section. In the body section text of the post can be included, along with one or more media items, if desired. Some embodiments also include additional information in the body, such as a list of categories to which the post applies, a list of tags, and a comments link that shows whether any comments have been entered by users, and if so, provides a link to view those comments. Post display region 3306 can include, for example, media items from media database 103 (shown in FIG. 1) in some embodiments.

FIG. 34 is an example blog administration page 3400 of a blog module of web site 1100. Blog module of web site 1100 provides a set of pages to guide the user in the creation and updating of their blog. Blog administration page 3400 is an example of such a page.

In this example, blog administration page 3400 includes menu 3402, manage posts section 3404, edit posts section 3406, category selection region 3408, tag definition region 3410, Post Entry button 3412, and footer links section 1310.

Menu 3402 presents a list of options to the user, such as Create New Post, Manage Posts, and Settings. Create New Post option is selected by a user when they want to make a new post entry. When the Create New Post option is selected, a page similar to page 3400 is displayed by web site 1100, except that it typically does not include manage posts section 3404. Manage Posts option is selected when they want to edit or view an existing post, in which case page 3400 is displayed. Setting option is selected when the user wants to change the blog settings.

Manage Posts section 3404 displays a list of previously entered posts, including the date of the post, the title, number of comments, and other options. If a user desires to edit a post, the user selects the post from the manage posts section 3404. The post is then displayed in the Edit Post section 3406 where edits can be made.

If a user wants to create a new post, a Create Post section is provided similar to Edit Post section 3406. Category selection region 3408, tag definition region 3410, and Post Entry button 3412 are also included in some embodiments.

Category selection region 3408 is used to associate the post with one or more categories, if desired. Tag definition region 3410 is used to associate the post with one or more tags, if desired.

After the post has been entered or edited, Post Entry button 3412 is selected to save the post and publish it on the blog page (such as blog page 3300, shown in FIG. 33).

Other embodiments of the web site interface with a third-party blog service, such as the BLOGGER™ web publishing service by GOOGLE® to allow users to provide blog content.

FIG. 35 illustrates an example people feature of web site 1100. The People Section of web site 1100 is accessible through a variety of paths in some embodiments. For example, the user can select the People tab of navigation tabs 1706 (shown in FIG. 17). Another path is through the People button of the primary navigation bar 1302 (shown in FIG. 13). In some embodiments these paths lead to the people browsing page that lists a plurality of people. The people page 3500 is then displayed after a user selects on a particular person from the people browsing page.

In some embodiments a People browsing page (not separately illustrated) is provided by web site 1100, which is similar to the media browsing page, group browsing page, and blog browsing pages previously described. The main difference between the People browsing page is that each browsing section is associated with a user, rather than a media item or a group. Accordingly, a user can use the People browsing page to search for or browse through the profiles of users of web site 1100. In some embodiments People browsing page only displays those users that have indicated that they know the current user, such as by accepting an invitation message previously sent by the current user (or vice versa).

In this example, user profile page 3500 includes personal photo 3502, personal info section 3504, media content tabs 3506, groups tab 3508, and advertisement sections 3510 and 3512.

Personal photo 3502 is an image provided by the user as a personal profile photo. The image may be a picture of the user, or may be any other image that the user wants to represent him on web site 1100. In other embodiments, other media items are able to be displayed as a personal identifier, such as a video, an audio clip, a document, etc.

Personal info section 3504 displays information about the user. In this example, personal info section 3504 identifies how long the user has been a member, the user's religion, parish/church membership, and the user's occupation. In addition, some embodiments also include an About Me section where the user can write a brief bio about themselves, a Favorite Bible verse section where the user can write a favorite Bible verse, and a Favorite Music section where the user can insert media items, such as from media database 103 (shown in FIG. 1). Other information is included in other embodiments.

Media content tabs 3506 display media content associated with the user. Examples include those media items tagged by the user as being a favorite, media items uploaded by the user, and media items purchased by the user. In this example, the user has tagged one media item as a favorite. The media item is displayed as a thumbnail image 3514, which is linked to the associated media page.

My groups tap 3508 displays groups that the user is a member of. In this example, the user is a member of one group, which is displayed as a thumbnail image 3516 which is linked to the group page for that group.

FIGS. 36-38 illustrate the concept of Segment Identifiers according to the present disclosure. FIG. 36 is a simplified Venn diagram illustrating an example set of all users U. (The diagram is simplified to have no overlap between any of the groups.) As just one example, consider the set of all users U to be all users of a network, such as the Internet. This set of users U has tremendous diversity, in language, beliefs, cultures, and interests.

However, within the set of users U are a plurality of vertical groups of users V. The vertical groups of users V share something in common, other than that they are all users. For example, a vertical group of users V may share a commonality, such as a common interest, religion, race, language, political ideology, or other commonality. A vertical group of users does not include all users, and preferably excludes a large percentage of the full group of users U. In some embodiments, the vertical group of users V includes less than 50% of the full group of users. Other embodiments include less than 25%, while others include less than 10%.

Even within a vertical group of users V, there may still be great diversity. The diversity may be in beliefs or opinions relating to the common aspect of the vertical group. In the context of a media distribution site, such diversity can be advantageous in some situations, but disadvantageous in other situations. For example, a media item that is enjoyed by one subset of users within the vertical group V, may not be enjoyed by another subset of users within the vertical group V due to their differences, such as in beliefs or opinions.

Accordingly, a vertical group of users V can further be divided into segments S of the vertical group of users V. An example is the vertical group of users V′. In this example, the vertical group of users V′ can be subdivided into a plurality of segments S, including segment A, segment B, segment C, segment D, and segment E. Each segment shares a commonality, such as a certain interest, belief on a particular subject or set of subjects, or other commonality. Preferably the commonality is not shared by the members of the other segments, or at least not to the same degree. In some embodiments the number of segments of a vertical group is in a range from about 3 to about 10, and preferably in a range from about 4 to about 6. This example includes five segments.

A particular example will be provided to illustrate the concepts. In this example, the set of all users U is the set of all users of the Internet. An example of a vertical group is the set of users interested in exploring the rich tradition of the Catholic faith. This group is not limited to Catholics, but also includes those who are skeptical or intrigued to learn more. The users within this vertical group can be the target users for a media distribution site, such as described herein.

Within this vertical group V, however, there is still great diversity. As noted above, the diversity is an asset in some situations, but a detriment in other situations. As a result, it is useful to have a tool to further identify this diversity. The tool is the division of the vertical group V into a plurality of segments S. In this example, the vertical group V can be divided into five segments S, each segment being identified by a Segment Identifier as follows: (1) defends the rules, (2) follows the rules, (3) considers the rules, (4) don't know the rules, and (5) the rules don't apply to me. Such a division of users into segments allows the media site to perform various unique functions.

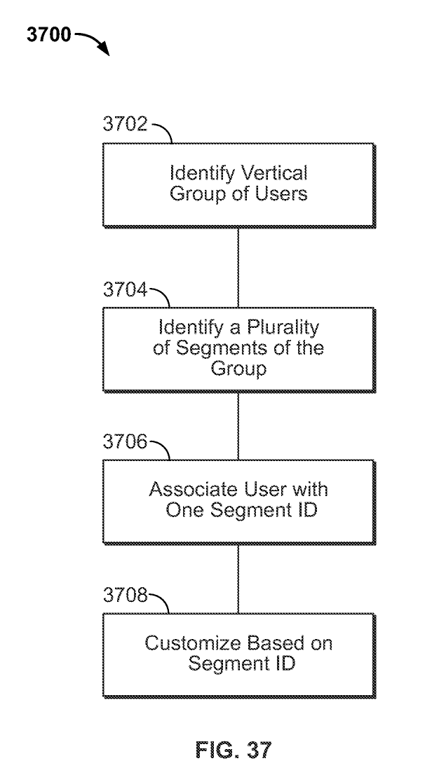

FIG. 37 is a flow chart further illustrating the concept of Segment Identifiers. FIG. 37 illustrates a method of customizing a web site. The method includes operations 3702, 3704, 3706, and 3708.

The method begins with operation 3702 in which a vertical group of users is identified from a complete set of users. In the example discussed above, the vertical group of users was the set of all users interested in exploring the rich tradition of the Catholic faith. In some embodiments, the vertical group identified is set as the target set of users for a web site. Other embodiments include other vertical groups.

Operation 3704 is next performed to identify a plurality of segments of the vertical group. In the example discussed above, the plurality of segments were identified as: (1) defends the rules, (2) follows the rules, (3) considers the rules, (4) don't know the rules, and (5) the rules don't apply to me. Other embodiments include other segments.

Operation 3706 is then performed to associate a user with one of the segments. In some embodiments operation 3706 involves prompting a user to select a segment identifier that the user believes most closely identifies himself or herself. When a segment identifier is selected by the user himself or herself, the segment identifier is sometimes referred to as a Segment Self Identifier herein (or an “SSID”). Some embodiments allow a user to opt out of selecting a Segment Self Identifier.

In other embodiments, the segment identifier is assigned to a user automatically, such as by comparing aspects of the user's interaction with the web site to predefined criteria for each segment (e.g., the type of media items that the user has selected as favorites, and determining what segment is most likely to enjoy that media item). In yet another embodiment, the user is associated with a segment identifier by others, such as through a process where users are able to suggest what segment identifier best describes the user.

After the user has been associated with a segment identifier, operation 3708 is performed to customize web site 1100 according to the user's segment identifier in some embodiments. For example, various pages discussed herein include a customizable section. One example of a customizable section is the inspirational section 1314 illustrated in FIG. 13. The inspirational section 1314 displays a media item, such as an image, and/or a text-based message, such as a quotation or “thought of the day.” In some embodiments the web server includes an inspiration database, which is a collection of images and/or messages that can be displayed in inspirational section 1314. In some embodiments the content of inspiration database is associated with one or more segment identifiers. When a page is displayed, the web server determines the segment identifier of the current user and compares that with the segment identifier(s) associated with the content of the inspiration database. The web server then selects from the content that is associated with the same segment identifier as the current user and displays that on the current page. This method of customizing a web site enhances the user experience by providing to the user information or media that the user is most likely to appreciate, while not displaying information or media that the user is not likely to appreciate.

The same concept can be applied to advertisements. There may be particular advertisements that are likely to be appreciated by users of one segment but not by users of another segment. Similarly, there may be certain segments where an advertisement has a greater likelihood of leading to commercial transaction than with other segments. These factors can be used by a server to selectively display advertisements to users. For example, an advertisement for a book may appeal to a large percentage of users associated with the “defends the rules” segment, while only to a small percentage of users in the “doesn't know the rules” segment. Accordingly, the server can selectively display the advertisement only to users that are in the “defends the rules” segment, while displaying other advertisements to users in the “doesn't know the rules” segment. In some embodiments a third-party ad server service is used to provide such advertisements.

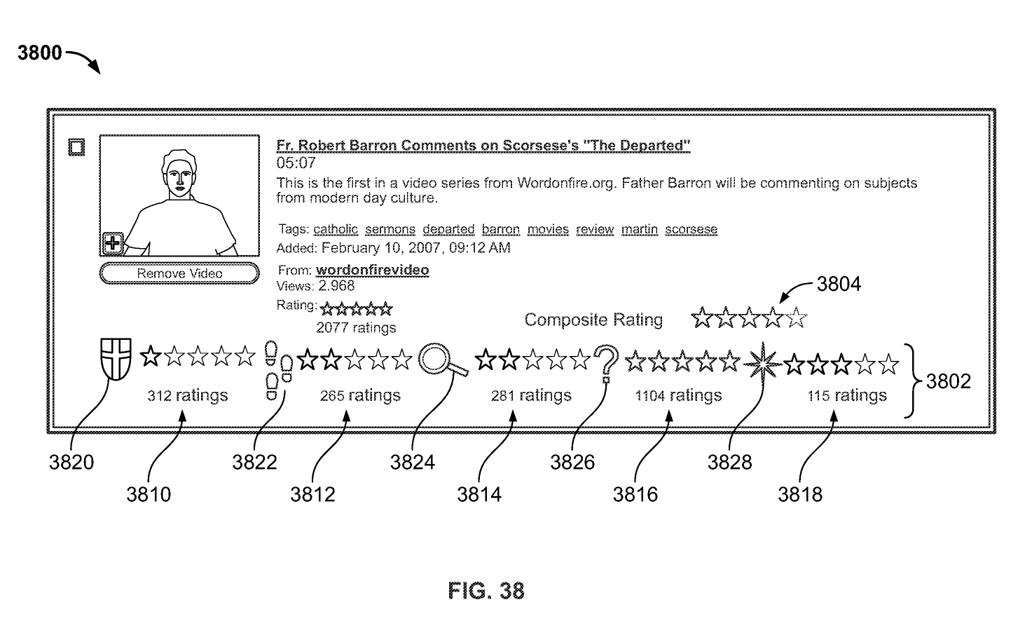

In other embodiments, however, the segment identifier is used to display additional information to the user, such as enhanced user ratings as discussed with reference to FIG. 38.

FIG. 38 is a screen shot of another example snapshot display 3800, provided to illustrate another method of using Segment Identifiers. Snapshot display 3800 is another embodiment of the example snapshot display 1800a shown in FIG. 18 such as can be included in a media browsing page.

Snapshot display includes a rating display region 3802. The rating display region 3802 displays the ratings that have been given to the associated media item by users of the web site. In this example, snapshot display includes a composite rating 3804, which is the average rating given to the media item by all users who have provided a rating. Additional ratings are provided through segment rating display 3810, 3812, 3814, 3816, and 3818. Each segment rating display includes an image 3820, 3822, 3824, 3826, and 3828 associated with a segment identifier (e.g., defends the rules, follows the rules, considers the rules, don't know the rules, and the rules don't apply to me, respectively). Each segment rating display provides the average rating given to the media item by those users that are associated with the respective segment identifier. For example, segment rating display 3810 shows that 312 users that have identified themselves to be associated with the “defends the rules” segment identifier have rated this media item. The average rating given by that segment is one star. On the other hand, the 1104 users who are associated with the “don't know the rules” segment (as shown in segment rating display 3816) have rated the media item and on average have provided a five star rating to the media item.

Segment rating displays are useful to a user of the web site because they aid the user in determining whether or not the user is likely to enjoy a media item before the user has viewed it.

Segment ratings can also be useful to a server to provide more relevant information to a user. For example, some embodiments utilize the segment ratings to provide customized search rank results, such as to sort search results according to a segment rating associated with a selected segment identifier or according to the segment identifier associated with the current user.

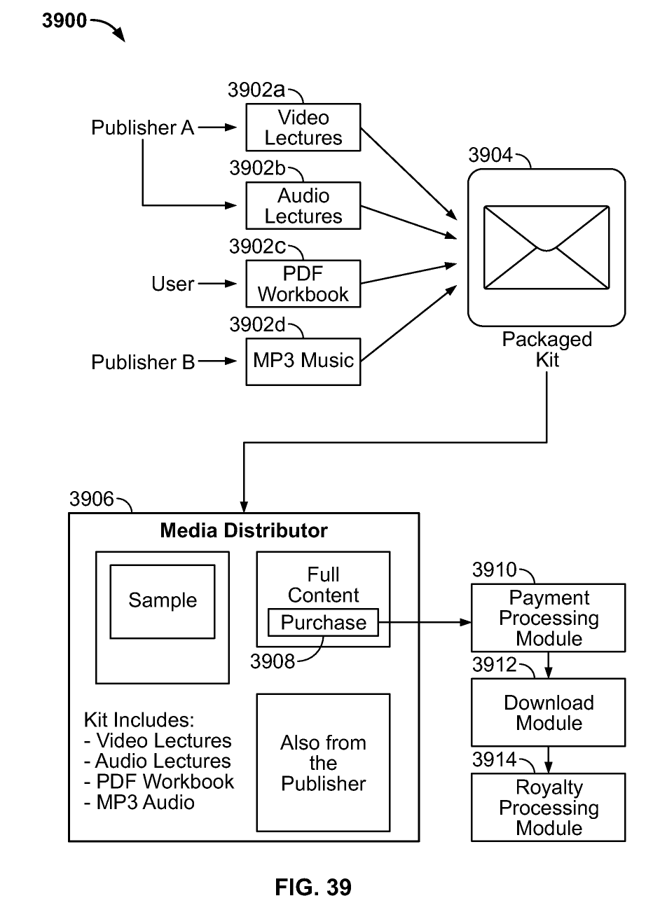

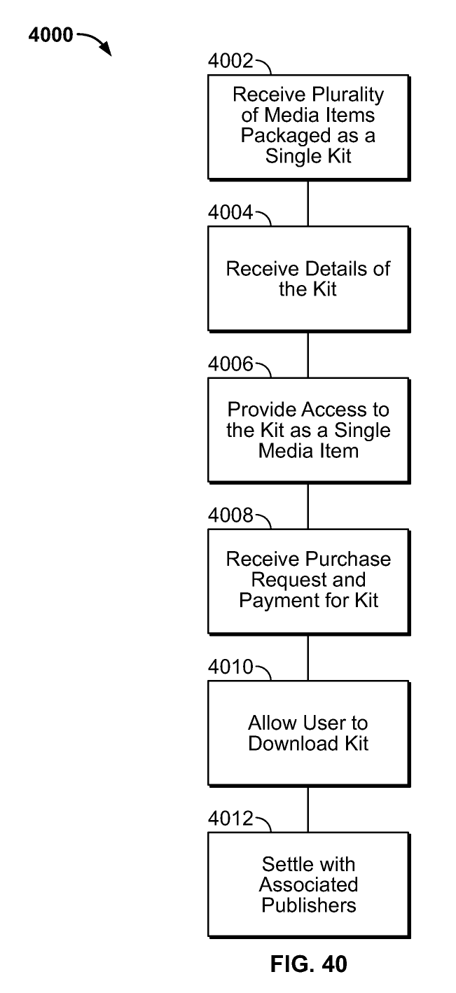

FIGS. 39-40 illustrate the concept of a kit according to the present disclosure. FIGS. 39 and 40 are flow charts illustrating example methods 3900 and 4000 of distributing a plurality of media items as a kit. One advantage of the kit is that the user only has to purchase and/or download a single media item (i.e. the kit) to obtain all items within the kit.

FIG. 39 illustrates a plurality of media items 3902(a-d) of a variety of different formats and from a variety of different sources. For example, media item 3902a is a video lecture published by publisher A. Media item 3902b is an audio lecture also published by publisher A. 3902c is a pdf workbook provided by a user. 3902d is a song in MP3 format published by publisher B.

The plurality of media items 3902(a-d) are packaged together to form packaged kit 3904. In most embodiments packaging means at least combining multiple files into a single packaged file. In some embodiments packaging also includes compressing the data to result in a packaged file that requires less storage space than the sum of the individual files. An example of a packaged file is the ZIP file format. An example of a lossless data compression algorithm is Deflate which is a part of the RFC 1951 specification. In some embodiments the kit is packaged as a self-extracting executable.

The packaged kit 3904 is then stored in a media database (e.g., media database 103, shown in FIG. 1) and made available through a media distributor 3906, such as the media distribution system discussed herein.

The packaged kit 3904 is made available through media distributor 3906 as if it were a single media item. In some embodiments the packaged kit is associated with a media page, as discussed herein. The user can request a download of the kit, for example, by selecting a purchase button 3908. The media distributor 3906 then receives a payment from the user for the kit using a payment processing module 3910.

After the payment has been processed, the user is allowed to download the kit 3904, such as by clicking on a download button. The download is then initiated to the user's computing device, where the user saves the kit and is then able to extract the plurality of media items.

A royalty processing module 3914 is then used to process and distribute royalty payments as necessary. Since multiple publishers provided media items to the kit, royalties should be paid to both publishers in this example. Royalty processing module 3914 determines the payments that should be made to each distributor and processes such payments.

In some embodiments the royalty processing module 3914 is a software module that interacts with a banking system to transfer funds electronically. In other embodiments, royalty processing module includes a software module that performs some of the record keeping, but also includes a manual process for making such payments (such as by a person reviewing a monthly report generated by the software and then initiating the appropriate payments).

The example provided above describes both publisher content and user-generated content. Other embodiments include only publisher content or only user-generated content. Further, some embodiments include media items from only one publisher, or from only a plurality of publishers (and no users).

FIG. 40 is a flow chart illustrating another example method of distributing a plurality of media items 4000. Method 4000 includes operations 4002, 4004, 4006, 4008, 4010, and 4012.

Method 4000 begins with operation 4002 in which a plurality media items packaged as a single kit. For example, a user uploads the packaged kit to the web server through a web site.

Operation 4004 is then performed to receive details of the kit. For example, a user enters a title, a description, and a price for the kit. In some embodiments the user also identifies each media item contained in the kit, and identifies who owns the copyright or distribution rights for each media item. In yet further embodiments, the user identifies the royalty payment that should be made for each sale of the kit.

Operation 4006 is next performed to provide access to the kit as a single media item. For example, the web site stores the media item in a media database and displays the kit as a media item on a media page.

Operation 4008 is then performed to receive a purchase request and a payment for the kit.

Once payment has been received, operation 4010 is performed to allow the user to download the kit.

Operation 4012 is then performed to settle with the associated publishers. For example, royalty payments are made to each publisher owning a right to at least one media item contained within the kit.

FIGS. 41-45 illustrate how media items are provided to the server through a web site, such as web site 1100 shown in FIG. 11. FIG. 41 illustrates a user upload page.

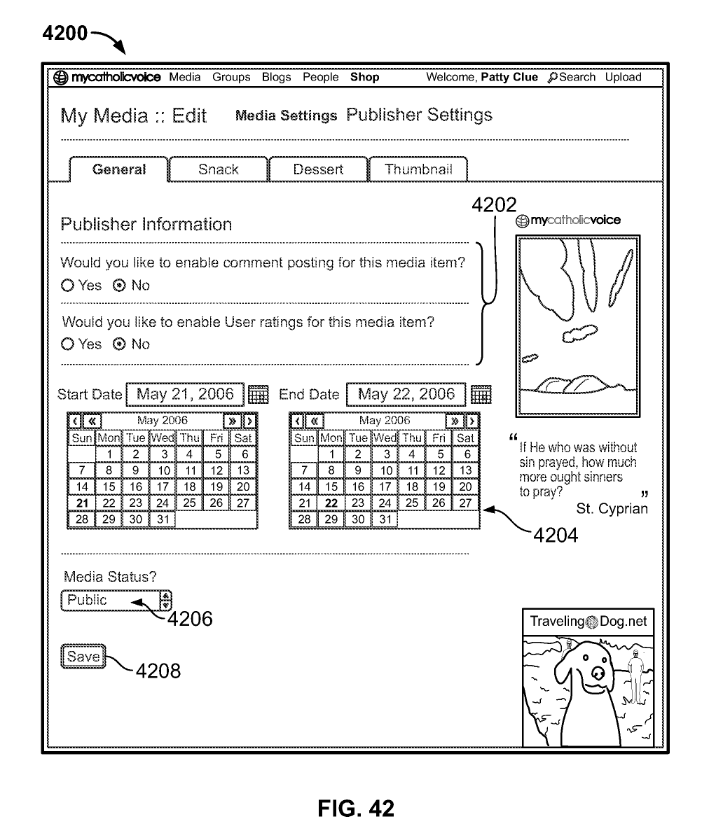

FIG. 42 illustrates additional publisher pages that allow a publisher to edit uploaded content.

FIG. 41 is an example upload page 4100 that acts to receive a media item and additional information about a media item from a user. Upload page 4100 is displayed, for example, when a user selects the upload button 1334 of primary navigation bar 1302. Upload page 4100 includes primary navigation bar 1302, general instruction section 4102, file type selection section 4104, group attachment section 4106, description section 4108, category selection section 4110, publication settings section 4112, and file section 4114.

Instructions for uploading a file are provided in general instruction section 4102. After reviewing the instructions, the user selects a file type from file type selection section 4104. Examples include music, video, photo, document, podcast, and spoken word.

If the user wants to attach the media item to a group, the group is selected from a menu in group attachment section 4106.

Description section 4108 prompts the user to enter a title, brief description, and tags for the media item. The user enters such information into the appropriate fields.

The media item can then be associated with one or more categories by selecting the categories from category selection section 4110.

A user then has the option to define whether the media item should only be available for viewing through the web site (such as through a media player), or whether other users should be allowed to download the media item. If the user wants to allow others to download the media item, the user selects the box in publication settings section 4112.

The file is then uploaded by selecting the browse button 4120 and selecting the media item in a pop-up window. The upload button 4122 is then selected to upload the selected file to the server and to save the media item and associated information in the media database (e.g., 103 shown in FIG. 1). In some embodiments an additional step is included between the upload and save process. The additional step is the transcode step in which media items are converted into one or more predetermined formats. For example, a video file that is uploaded is transcoded into an MP3 format with a desired bitrate (e.g., 64 kbs).

FIGS. 42-45 illustrate additional example pages that are presented to a publisher after the publisher has uploaded a media item to the server. Before these pages are presented, the publisher uploads a media item through user upload page 4100 (shown in FIG. 41) or a similar page in some embodiments.

FIG. 42 is a media editing page 4200 associated with a previously uploaded media item. The media editing page 4200 allows the publisher to define certain aspects of how the media item will be used by the web site.

In this example, media editing page 4200 includes prompts 4202, publication date selection section 4204, media status selection section 4206, and save button 4208.

Prompts section 4202 prompts the publisher to identify whether comments should be allowed to be posted on a media page for this media item, and whether users should be allowed to rate the media item.

In some situations the publisher may desire to limit the publication dates of a media item. For example, a publisher may want to upload the media item before it has been released the public. Publication date selection section 4204 allows the publisher to identify a starting date and an ending date for the media item to be available through the web site.

Media status selection section 4206 prompts the user to identify the status of the media, such as public or private. A private media item, for example, may only be available to a particular group.

Save button 4208 saves the data entered into the media database (e.g., 103 shown in FIG. 1).

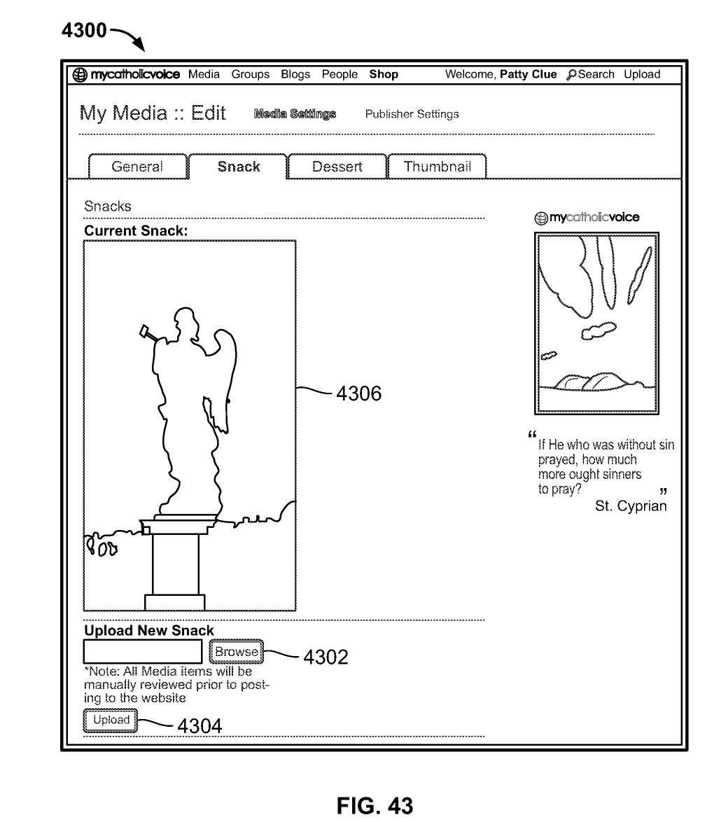

FIG. 43 is an example of a snack definition page 4300 associated with a previously uploaded media item. Referring back to FIG. 25, the snack, meal, and dessert format is used for a media page in some embodiments. The snack definition page 4300 allows the publisher to define the media item to be presented in snack window 2502. To do so, the publisher selects browse button 4302 and, selects the desired file. The upload button 4304 is then selected to upload the selected file to the server and to save the changes. A preview of the currently selected snack is provided in preview window 4306, if any.

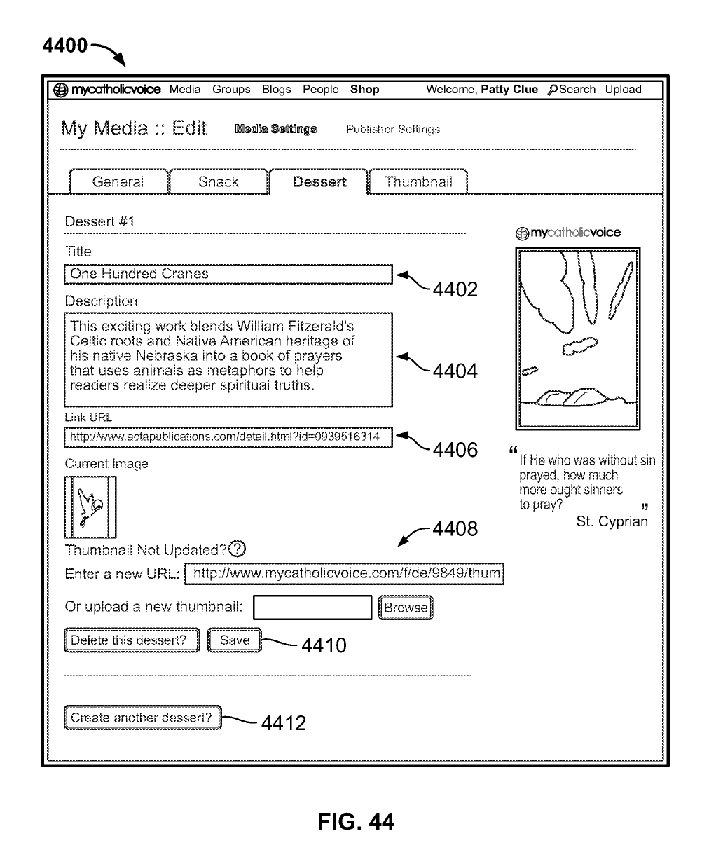

FIG. 44 is an example of a dessert definition page 4400 associated with a previously uploaded media item. Referring again back to FIG. 25, an example snack, meal, and dessert format is used for a media page in some embodiments. The dessert definition page 4400 allows the publisher to define the content of the dessert window.

In this example, dessert definition page 4400 allows the publisher to define one or more dessert displays. For a first dessert display, dessert definition page 4400 includes a title field 4402, description field 4404, link URL field 4406, image selection section 4408, and save button 4410.

The publisher enters a title into the title field 4402 and a brief description into the description field 4404. To link the dessert display to another page or web site, the URL for the page or web site is entered in link URL field 4406. The URL can be for the any page on the media distribution site (such as a media page), or to an external web site, such as the publishers own web site.

If desired, a thumbnail image is entered using image selection section 4408. After all information has been entered, the save button 4410 is selected to upload and to save the information to the server.

If additional dessert displays are desired, the publisher selects the create another dessert button 4412 and repeats the process discussed above for the next dessert display.

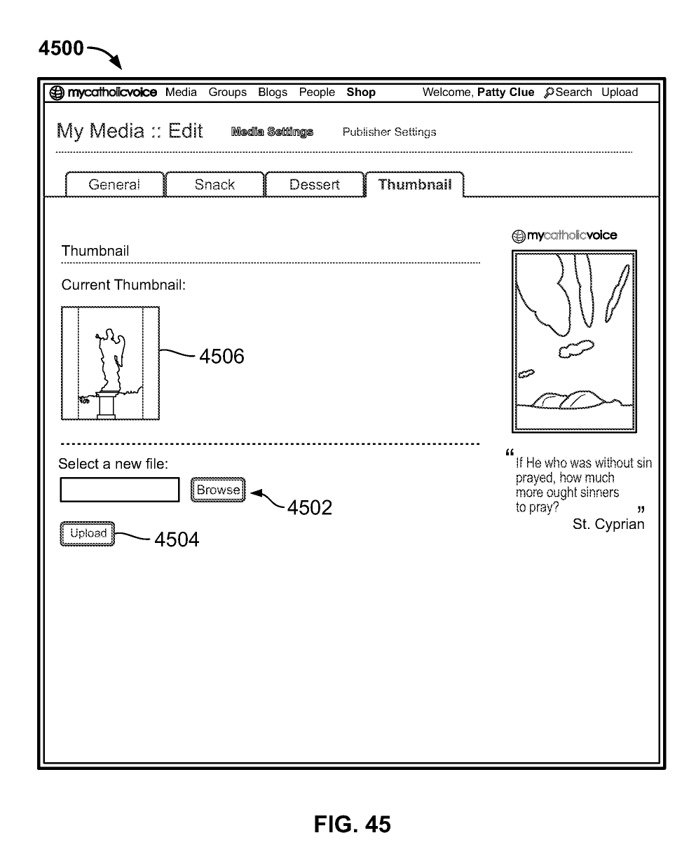

FIG. 45 is an example of a thumbnail definition page 4500 associated with a previously uploaded media item. On some pages of the media distribution web site a thumbnail image of the media item is displayed. For example, in some embodiments when a media item is displayed in a list of results in a media browsing page, the thumbnail image is displayed. Thumbnail definition page 4500 is used by a publisher to define the image that should be used for the thumbnail display. To do so, the browse button is selected from thumbnail definition page and the desired file selected. The upload button 4504 is then selected to upload the selected file and to save the changes to the server. A preview of the currently selected thumbnail, if any, is shown in preview window 4506.

The process illustrated and described above with reference to FIGS. 42-45 works particularly well when limited numbers of media items are being provided at a time to the media distribution system. There are times, however, when a publisher desires to provide large quantities of media items to the media distribution system at a time, such as when the publisher first begins providing content to the media distribution system. In such situations, some embodiments also utilize a method of providing media items to the media distribution system involving the use of a content ingestion spreadsheet. The spreadsheet includes a plurality of columns and a plurality of rows. Each row is used to define a separate media item. Each column of the spreadsheet is used to provide information about the media item or about how the media item should be used or presented in the web site. The content ingestion spreadsheet allows a publisher to more quickly define the information for a large number of media items.

In one example, the spreadsheet has a plurality of columns assigned to the following fields of basic information: Publisher Name, Publisher Media Item ID, Media Item Title, Artist, Description, Category, Tags, Media Type, Language, Thumbnail, Meal, Streaming Snack, Price, Start Date, Inactive Date, Allow Ratings, Allow Comments, Has Profanity. In some embodiments, the spreadsheet further includes fields to define one or more dessert displays, such as the following: image, title, description, and URL. Multiple sets of columns can be provided to allow multiple dessert displays. Other embodiments include more or fewer columns. Other embodiments include other different fields.

In some embodiments the content ingestion spreadsheet is provided by a page of a web site, but in other embodiments spreadsheet software is used, such as Microsoft EXCEL® spreadsheet software. The spreadsheet can be provided from the publisher to the media distribution system in any desired manner, such as via e-mail or by uploading through a spreadsheet upload page of the web site. The data is then fed into the server by a software program that reads the spreadsheet, automatically copies the data into the appropriate locations in the database and uploads the identified media item into the database.

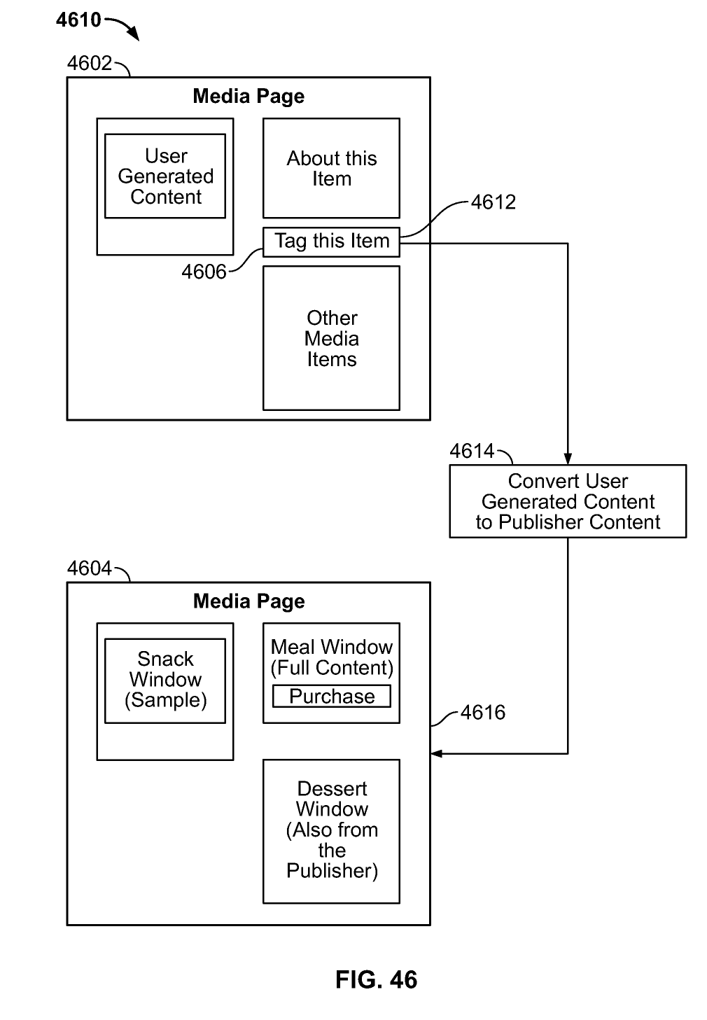

FIG. 46 is a combined block diagram and flow chart illustrating a method of tagging an item to convert the item from user generated content to publisher content according to the present disclosure. FIG. 46 includes a screen shot 4602 of an example media page as viewed by a publisher who has logged in to a web site (such as web site 1100). FIG. 46 also includes a screen shot 4604 of an example media page after the media item has been tagged by a publisher as including content owned by the publisher. The method 4610 includes operations 4612, 4614, and 4616.

When users are allowed to upload media items to a web site (such as web site 1100), there is a risk that a user will upload a media items that includes content owned by another. For example, a video made by a user may have a copyrighted song playing in the background. Because most publishers do not want content that they own freely distributed across the Internet, one solution is to allow publishers to report to the Web site administrator potential violations. The web site administrator reviews the media item and if a violation is detected, removes the media item from the web site.

An alternative is the method of tagging media items illustrated in FIG. 46. The method allows a publisher to tag a media item including content owned by the publisher to convert the media item to publisher content. Once converted, the publisher controls the distribution of the media item. In this way the publisher is able to benefit from the free publicity of the media item, but can also select whether a payment should be required by the user before distribution of the media item.

In some embodiments, a web server includes a tag this item button 4606 on a media page when the media page is being access by a publisher. If a publisher identifies content within the media item that is owned (e.g., copyrighted) by the publisher, the publisher clicks on tag this item button 4606 (operation 4612).

Once the tag this item button 4606 is selected, operation 4614 is performed to convert the user generated content to publisher content. Operation 4614 is performed by the web server in some embodiments, but can also be performed by an administrator in other embodiments.

Once the conversion has been completed, the publisher is then given the right to control the distribution of the media item (operation 4616). Although the media item could include additional content that is not copyrighted by the publisher, such as content copyrighted by the user, the terms of use agreement can specify that users relinquish any copyrights when content is uploaded to the web server, at least with respect to distribution through the media distribution system.

In some embodiments, the converted media item is now listed among the publisher's uploaded content, and the publisher can use the publisher upload interface (such as shown in FIG. 42-45) to define how the media item will be distributed. For example, in some embodiments the publisher defines the content of a snack window, a meal window, and a dessert window, and sets a price for distribution of the full content through the meal window. The publisher can set only a portion of the full content as freely available in the snack window in some embodiments, for example.

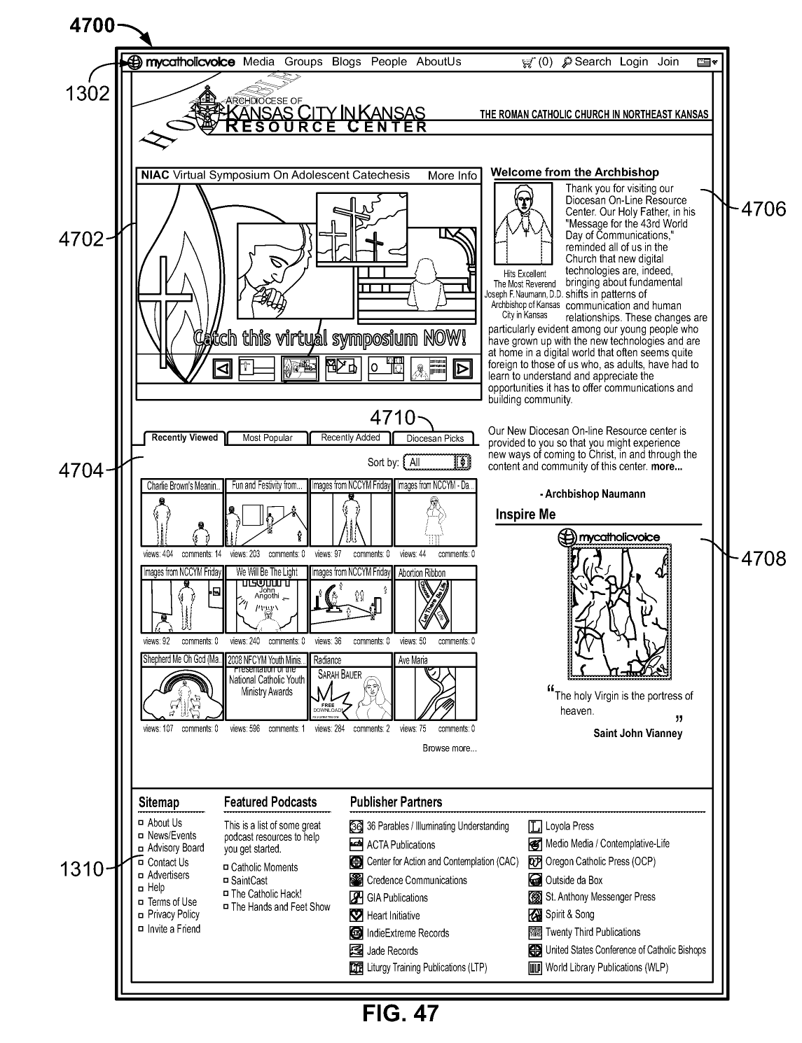

FIG. 47 is a screen shot of an example Resource Center 4700 according to the present disclosure. In this example, the Resource Center is a Diocese Resource Center. In some embodiments Resource Center 4700 includes primary navigation bar 1302, ticker zone 4702, featured media section 4704, introduction section 4706, inspiration section 4708, and footer links section 1310.

In this example, the Diocese Resource Center is configured for a particular diocese, such as the Archdiocese of Kansas City in Kansas as noted at the top of the page. The resource center is an example of a group, discussed herein. In some embodiments the Resource Center acts as a stand alone web site. The Resource center can, in some embodiments have its own URL that is associated with the name of the group, rather than the name of the media distribution system (or a sub-domain of the media distribution system).

Ticker zone 4702 is similar to ticker zone 1304 discussed herein with reference to FIGS. 13 and 14, but is directed toward the interests of the particular Diocese. The Ticker zone 4702 is used by the Diocese to highlight particular information or media items that are related to or recommended by the Diocese.

Featured media section 4704 is similar to featured media section 1306 described herein with reference to FIGS. 13 and 15. The Resource Center has access to all of the media items available through the media database of the web site (e.g., web site 1100). In some embodiments, media included in the Resource Center includes only those media items that have been approved by the Diocese. In some embodiments the Diocese can tag media items from the media database as being approved by the Diocese. Only those items are available through the Diocese Resource Center in some embodiments.

Featured media section 4704 includes a Diocesan Picks tab 4710 in some embodiments that suggests media items that are recommended by the Diocese.

Introduction section 4706 is a section where an introduction message is provided, similar to introduction section 1312 described with reference to FIG. 13. This section can also be used to inform users of important news relating to the Diocese in some embodiments.

Inspiration section 4708 is a section where an image or text-based message, or both are displayed. Inspiration section 4708 is similar to inspirational section 1314 described with reference to FIG. 13. In some embodiments the images or text-based messages are selected, approved, or provided by the Diocese.

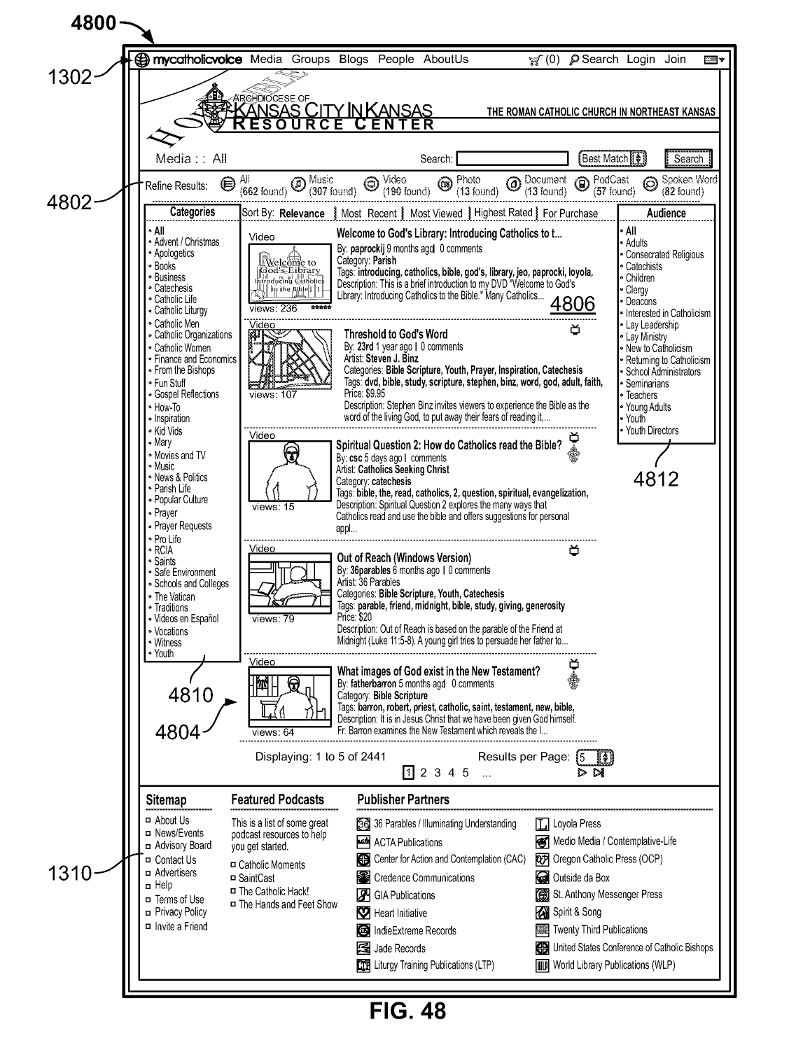

FIG. 48 is a screen shot of an example media browsing page 4800 of a Resource Center, such as the example Diocese Resource Center. Media browsing page 4800 includes primary navigation bar 1302, media type filter 4802, browsing section 4804 including media item snapshot display 4806, category filter 4810, audience filter 4812, and footer links 1310.

Media browsing page 4800 is similar to other browsing pages discussed herein, such as media browsing page 1600 shown in FIG. 16. As noted above, however, the Resource Center can limit media content to those items specifically authorized, approved, or sanctioned by the group, such as the diocese.

Category filter 4810 allows a user to filter media items by a selected category by selecting a category from the list. In this example, the available categories are: all, advent/Christmas, Apologetics, Books, Business, Catechesis, Catholic Life, Catholic Liturgy, Catholic Men, Catholic Organizations, Catholic Women, Finance and Economics, From the Bishops, Fun Stuff, Gospel Reflections, How-To, Inspiration, Kid Vids, Mary, Movies and TV, Music, News & Politics, Parish Life, Popular Culture, Prayer, Prayer Requests, Pro Life, RCIA, Saints, Safe Environment, Schools and Colleges, The Vatican, Traditions, Videos en Espanol, Vocations, Witness, and Youth. Other embodiments include more, less, or different categories. In some embodiments multiple categories can be selected in a single search to further refine the search results.

Audience filter 4812 allows a user to filter media items by a particular audience. In this example, the available audiences are: All, Adults, Consecrated Religious, Catechists, Children, Clergy, Deacons, Interested in Catholicism, Lay Leadership, Lay Ministry, New to Catholicism, Returning to Catholicism, School Administrators, Seminarians, Teachers, Young Adults, Youth, Youth Directors.

The category filter 4810 and audience filter 4812 can be used together to filter search results in some embodiments. For example, if a youth director is preparing for a Christmas youth event, the director can use the Diocese Resource Center to locate media items that have been approved by the Diocese for such an event. To do so, the youth director selects “youth director” from the audience filter 4812 and then selects “Advent/Christmas” from the category field. The results are then displayed in browsing window 4804 for review by the youth director.

In some embodiments the Resource Center acts as a separate web site, except that it includes the primary navigation bar 1302 and footer links section 1310 of the media distribution web site (e.g., 1100 introduced with reference to FIG. 11). In some embodiments if a user clicks on a link that would navigate away from the Resource Center (such as back to web site 1100), a message is displayed to the user informing them that they are about to leave the Resource Center, and asking them to confirm that they want to do so.

An example Catholic data model is provided below. In some embodiments the Catholic data model is used to store metadata in a database. It is recognized that various modifications can be made to the data model and the following is provided as only one possible example of such a data model.

In this example, the Catholic data model includes the following schemas: api, adserve, assoc, blog, catholic, commerce, community, discussion, faq, general, inspiration, language, media, module, object, queue, reader, reference, searchindex, and usr. A brief description of each schema follows.

The api schema is used for logging each API request that is processed by the web site servers. The adserve schema is used for storing and logging any advertisement widgets sent out to third party websites. The assoc schema contains cross-schema association tables to relate information between tables, such as media items to catholic metadata tables. The blog schema contains blogs, blog posts, and the associations between them. The catholic schema contains tables for storing Catholic identifiers and relationships between the Catholic identifiers. The commerce schema includes e-commerce data which includes virtual shopping cart, coupons, transaction logging, invoices and invoice items. The community schema includes information for groups and modules and media items associated with each.

The discussion schema includes message forums for group discussions. The faq schema includes frequently asked questions or help sections so web site users can find answers to any frequently asked questions. The general schema contains miscellaneous tables such as addresses, email templates, and error logs. The inspiration schema includes a collection of image metadata and inspirational quotes used to generate inspirational widgets. The language schema includes localization data used in translating text within the web site. The media schema includes media metadata, including; statistical information, ratings, comments, activity logging, and media purchases.

The module schema includes module metadata in relation to group modules and objects (such as media, blogs, etc). The object schema contains metadata for “objects”, which include things like media, users, groups, blogs, etc. The queue schema contains an email and messaging queue to process emails. The reader schema includes RSS feed metadata and logging. The reference schema contains reference metadata for use within the site, such as States, Countries, and Religious references. The searchindex schema contains the search index for generating data sets requested by the web site search engine. The usr schema contains user metadata, preferences and activity logging

An example Catholic Data Model is as follows:

Table “adserve.campaigns”

| Column | Type | Modifiers |
|---|---|---|
| campaign_id | integer | not null default |
| | | nextval(‘adserve.campaigns_campaign_id_seq’::regclass) |
| client_id | integer | not null |
| date_created | timestamp | not null default now( ) |
| | without time | |
| | zone | |

Indexes:
“campaigns_pkey” PRIMARY KEY, btree (campaign_id)

Table “adserve.clients”

| Column | Type | Modifiers |
|---|---|---|
| client_id | integer | not null default nextval(‘adserve.clients_client_id_seq’::regclass) |
| name | character | not null |
| | varying(50) | |
| date_created | timestamp | not null default now( ) |
| | without time | |
| | zone | |

Indexes:
“clients_pkey” PRIMARY KEY, btree (client_id)

Table “adserve.impressions”

| Column | Type | Modifiers |
|---|---|---|
| impression_id | integer | not null default |
| | | nextval(‘adserve.impressions_impression_id_seq’::regclass) |
| campaign_id | integer | |
| url | character | |
| | varying(150) | |
| ip | inet | |
| date_created | timestamp | not null default now( ) |
| | without time | |
| | zone | |

Indexes:
“impressions_pkey” PRIMARY KEY, btree (impression_id)

Table “adserve.search_log”

| Column | Type | Modifiers |
|---|---|---|
| search_log_id | integer | not null default |
| | | nextval(‘adserve.search_log_search_log_id_seq’::regclass) |
| query | text | not null |
| impression_id | integer | |
| date_created | timestamp | not null default now( ) |
| | without | |
| | time zone | |

Indexes:
“search_log_pkey” PRIMARY KEY, btree (search_log_id)

Table “assoc.adserve_client_to_publisher”

| Column | Type | Modifiers |
|---|---|---|
| adserve_client_publisher_id | integer | not null default |
| | | nextval(‘assoc.adserve_client_to_publisher_adserve_client_publisher_id_seq’::regclass) |
| publisher_id | integer | |
| client_id | integer | |
| date_created | timestamp | not null default now( ) |
| | without time | |
| | zone | |

Indexes: None

Table “assoc.community_to_address”

| Column | Type | Modifiers |
|---|---|---|
| community_to_address_id | integer | not null default |
| | | nextval(‘assoc.community_to_address_community_to_address_id_seq’::regclass) |
| community_id | integer | not null |
| address_id | bigint | not null |
| date_created | timestamp | not null default now( ) |
| | without | |
| | time zone | |

Indexes:
“community_to_address_pkey” PRIMARY KEY, btree (community_to_address_id)
Foreign-key constraints:
“community_to_address_community_id_fkey” FOREIGN KEY (community_id) REFERENCES community.communities(community_id) ON DELETE CASCADE

Table “assoc.media_to_bible”

| Column | Type | Modifiers |
|---|---|---|
| media_to_bible_id | integer | not null default |
| | | nextval(‘assoc.media_to_bible_media_to_bible_id_seq’::regclass) |
| media_id | bigint | not null |
| bible_book_id | integer | not null |
| bible_chapter_id | integer | |
| verse_start | smallint | |
| verse_end | smallint | |
| date_created | timestamp | not null default now( ) |
| | without | |
| | time zone | |

Indexes:
“media_to_bible_pkey” PRIMARY KEY, btree (media_to_bible_id)
Foreign-key constraints:
“media_to_bible_media_to_bible_id_fkey” FOREIGN KEY (media_id) REFERENCES media.media(media_id) ON DELETE CASCADE

Table “assoc.media_to_blog_entry”

| Column | Type | Modifiers |
|---|---|---|
| media_to_blog_entry_id | integer | not null |
| blog_entry_id | integer | not null |
| media_id | integer | not null |
| date_create | timestamp | |
| | without | |
| | time zone | |

Indexes:
“media_to_blog_entry_pkey” PRIMARY KEY, btree (blog_entry_id, media_id)
“media_to_blog_entry_media_to_blog_entry_id_key” UNIQUE, btree (media_to_blog_entry_id)
Foreign-key constraints:
“media_to_blog_entry_media_id_fkey” FOREIGN KEY (media_id) REFERENCES media.media(media_id) ON DELETE CASCADE

Table “assoc.media_to_catechism”

| Column | Type | Modifiers |
|---|---|---|
| media_to_catechism_id | integer | not null default |
| | | nextval(‘assoc.media_to_catechism_media_to_catechism_id_seq’::regclass) |
| media_id | bigint | not null |
| catechism_part_id | integer | not null |
| date_created | timestamp | not null default now( ) |
| | without time | |
| | zone | |
| catechism_section_id | integer | |
| catechism_chapter_id | integer | |
| catechism_article_id | integer | |

Indexes:
“media_to_catechism_pkey” PRIMARY KEY, btree (media_to_catechism_id)
Foreign-key constraints:
“media_to_catechism_media_id_fkey” FOREIGN KEY (media_id) REFERENCES media.media(media_id) ON DELETE CASCADE

Table “assoc.media_to_dessert”

| Column | Type | Modifiers |
|---|---|---|
| media_to_dessert_id | integer | not null default |
| | | nextval(‘assoc.media_to_dessert_media_to_dessert_id_seq’::regclass) |
| media_id | bigint | not null |
| dessert_id | integer | not null |
| date_created | timestamp | not null default now( ) |
| | without time | |
| | zone | |

Indexes:
“media_to_dessert_pkey” PRIMARY KEY, btree (media_to_dessert_id)
Foreign-key constraints:
“media_to_dessert_media_id_fkey” FOREIGN KEY (media_id) REFERENCES media.media(media_id) ON DELETE CASCADE

Table “assoc.media_to_feast”

| Column | Type | Modifiers |
|---|---|---|
| media_to_feast_id | integer | not null default |
| | | nextval(‘assoc.media_to_feast_media_to_feast_id_seq’::regclass) |
| media_id | bigint | not null |
| feast_id | integer | not null |
| date_created | timestamp | not null default now( ) |
| | without time | |
| | zone | |

Indexes:
“media_to_feast_pkey” PRIMARY KEY, btree (media_to_feast_id)
Foreign-key constraints:
“media_to_feast_media_id_fkey” FOREIGN KEY (media_id) REFERENCES media.media(media_id) ON DELETE CASCADE

Table “assoc.media_to_liturgical”

| Column | Type | Modifiers |
|---|---|---|
| media_to_liturgical_id | integer | not null default |
| | | nextval(‘assoc.media_to_liturgical_media_to_liturgical_id_seq’::regclass) |
| media_id | bigint | not null |
| liturgical_day_id | integer | not null |
| date_created | timestamp | not null default now( ) |
| | without | |
| | time zone | |

Indexes:
“media_to_liturgical_pkey” PRIMARY KEY, btree (media_to_liturgical_id)
Foreign-key constraints:
“media_to_liturgical_media_id_fkey” FOREIGN KEY (media_id) REFERENCES media.media(media_id) ON DELETE CASCADE

Table “assoc.media_to_mass”

| Column | Type | Modifiers |
|---|---|---|
| media_to_mass_id | integer | not null default |
| | | nextval(‘assoc.media_to_mass_media_to_mass_id_seq’::regclass) |
| media_id | bigint | not null |
| mass_id | smallint | not null |
| date_created | timestamp | not null default now( ) |
| | without | |
| | time zone | |

Indexes:
“media_to_mass_pkey” PRIMARY KEY, btree (media_to_mass_id)
Foreign-key constraints:
“media_to_mass_media_id_fkey” FOREIGN KEY (media_id) REFERENCES media.media(media_id) ON DELETE CASCADE

Table “assoc.media_to_refer”

| Column | Type | Modifiers |
|---|---|---|
| refer_id | integer | not null |
| media_id | integer | not null |
| reviewer_id | bigint | not null |
| system_type | smallint | not null |
| immediacy | boolean | not null default false |
| reason | text | not null |
| comment | text | |

Indexes:
“media_to_refer_pkey” PRIMARY KEY, btree (refer_id)
Foreign-key constraints:
“media_to_refer_media_id_fkey” FOREIGN KEY (media_id) REFERENCES media.media(media_id) ON DELETE CASCADE

Table “assoc.media_to_sacrament”

| Column | Type | Modifiers |
|---|---|---|
| media_to_sacrament_id | integer | not null default |
| | | nextval(‘assoc.media_to_sacrament_media_to_sacrament_id_seq’::regclass) |
| media_id | bigint | not null |
| sacrament_id | integer | not null |
| date_created | timestamp | not null default now( ) |
| | without time | |
| | zone | |

Indexes:
media_to_sacrament_pkey” PRIMARY KEY, btree (media_to_sacrament_id)
Foreign-key constraints:
“media_to_sacrament_media_id_fkey” FOREIGN KEY (media_id) REFERENCES media.media(media_id) ON DELETE CASCADE

Table “assoc.media_to_season”

| Column | Type | Modifiers |
|---|---|---|
| media_to_season_id | integer | not null default |
| | | nextval(‘assoc.media_to_season_media_to_season_id_seq’::regclass) |
| media_id | bigint | not null |
| season_id | integer | not null |
| date_created | timestamp | not null default now( ) |
| | without time | |
| | zone | |

Indexes:
“media_to_season_pkey” PRIMARY KEY, btree (media_to_season_id)
Foreign-key constraints:
“media_to_season_media_id_fkey” FOREIGN KEY (media_id) REFERENCES media.media(media_id) ON DELETE CASCADE

Table “assoc.media_to_season_day”

| Column | Type | Modifiers |
|---|---|---|
| media_to_season_day_id | integer | not null default |
| | | nextval(‘assoc.media_to_season_day_media_to_season_day_id_seq’::regclass) |
| media_id | bigint | not null |
| season_day_id | integer | not null |
| date_created | timestamp | not null default now( ) |
| | without | |
| | time zone | |

Foreign-key constraints:
“media_to_season_day_media_id_fkey” FOREIGN KEY (media_id) REFERENCES media.media(media_id) ON DELETE CASCADE

Table “assoc.media_to_set”

| Column | Type | Modifiers |
|---|---|---|
| media_to_set_id | integer | not null default |
| | | nextval(‘assoc.media_to_set_media_to_set_id_seq’::regclass) |
| media_id | bigint | not null |
| set_id | integer | not null |
| date_created | timestamp | not null default now( ) |
| | without time | |
| | zone | |

Indexes:
“media_to_set_pkey” PRIMARY KEY, btree (media_to_set_id)
Foreign-key constraints:
“media_to_set_media_id_fkey” FOREIGN KEY (media_id) REFERENCES media.media(media_id) ON DELETE CASCADE

Table “assoc.media_to_ssi”

| Column | Type | Modifiers |
|---|---|---|
| media_to_ssi_id | integer | not null default |
| | | nextval(‘assoc.media_to_ssi_media_to_ssi_id_seq’::regclass) |
| media_id | bigint | not null |
| ssi_id | smallint | not null |
| date_created | timestamp | not null default now( ) |
| | without | |
| | time zone | |

Indexes:
“media_to_ssi_pkey” PRIMARY KEY, btree (media_to_ssi_id)
Foreign-key constraints:
“media_to_ssi_media_id_fkey” FOREIGN KEY (media_id) REFERENCES media.media(media_id) ON DELETE CASCADE

Table “assoc.user_to_address”

| Column | Type | Modifiers |
|---|---|---|
| user_to_address_id | integer | not null default |
| | | nextval(‘assoc.user_to_address_user_to_address_id_seq’::regclass) |
| user_id | bigint | not null |
| address_id | bigint | not null |
| date_created | timestamp | not null default now( ) |
| | without | |
| | time zone | |

Indexes:
“user_to_address_pkey” PRIMARY KEY, btree (user_to_address_id)
Foreign-key constraints:
“user_to_address_user_id_fkey” FOREIGN KEY (user_id) REFERENCES usr.users(user_id) ON DELETE CASCADE

Table “assoc.user_to_admin_permissions”

| Column | Type | Modifiers |
|---|---|---|
| user_to_admin_permissions_id | integer | not null default |
| | | nextval(‘assoc.user_to_admin_permissions_user_to_admin_permissions_id_seq’::regclass) |
| user_id | integer | not null |
| admin_permission_id | integer | not null |
| date_created | timestamp | not null default now( ) |
| | without time zone | |

Indexes:
“user_to_admin_permissions_pkey” PRIMARY KEY, btree (user_to_admin_permissions_id)
Foreign-key constraints:
“user_to_admin_permissions_user_id_fkey” FOREIGN KEY (user_id) REFERENCES usr.users(user_id) ON DELETE CASCADE

Table “assoc.user_to_set”

| Column | Type | Modifiers |
|---|---|---|
| user_to_set_id | integer | not null default |
| | | nextval(‘assoc.user_to_set_user_to_set_id_seq’::regclass) |
| user_id | bigint | not null |
| set_id | integer | not null |
| date_created | timestamp | not null default now( ) |
| | without | |
| | time zone | |

Indexes:
“user_to_set_pkey” PRIMARY KEY, btree (user_to_set_id)
Foreign-key constraints:
“user_to_set_user_id_fkey” FOREIGN KEY (user_id) REFERENCES usr.users(user_id) ON DELETE CASCADE

Table “billing.coupon_use”

| Column | Type | Modifiers |
|---|---|---|
| coupon_use_id | integer | not null default |
| | | nextval(‘billing.coupon_use_coupon_use_id_seq’::regclass) |
| coupon_id | integer | |
| cart_id | integer | |
| invoice_id | integer | |
| user_id | integer | |
| date_created | timestamp | default now( ) |
| | without | |
| | time zone | |
| amount_used | double | |
| | precision | |

Indexes:
“coupon_use_pkey” PRIMARY KEY, btree (coupon_use_id)
Foreign-key constraints:
“coupon_use_user_id_fkey” FOREIGN KEY (user_id) REFERENCES usr.users(user_id) ON DELETE CASCADE

Table “billing.discounts_log”

| Column | Type | Modifiers |
|---|---|---|
| discount_id | integer | not null default |
| | | nextval(‘billing.discounts_log_discount_id_seq’::regclass) |
| invoice_id | integer | |
| publisher_id | integer | |
| coupon_id | integer | |
| date_created | timestamp | default now( ) |
| | without | |
| | time zone | |
| discount_amount | double | |
| | precision | |

Indexes:
“discounts_log_pkey” PRIMARY KEY, btree (discount_id)

Table “billing.invoice_items”

| Column | Type | Modifiers |
|---|---|---|
| invoice_item_id | bigint | not null default |
| | | nextval(‘billing.invoice_items_invoice_item_id_seq’::regclass) |
| invoice_id | integer | not null |
| charge_type_id | smallint | not null |
| item_id_varchar | character | |
| | varying(30) | |
| price | double precision | not null |
| contract_id | integer | |
| date_created | timestamp | default now( ) |
| | without time zone | |
| item_id | integer | |

Indexes:
“invoice_items_pkey” PRIMARY KEY, btree (invoice_item_id)

Table “billing.invoices”

| Column | Type | Modifiers |
|---|---|---|
| invoice_id | bigint | not null default |
| | | nextval(‘billing.invoices_invoice_id_seq’::regclass) |
| user_id | bigint | not null |
| invoice_status_id | smallint | not null |
| first_name | character | |
| | varying(50) | |
| last_name | character | |
| | varying(50) | |
| address_1 | character | |
| | varying(25) | |
| address_2 | character | |
| | varying(25) | |
| city | character | |
| | varying(25) | |
| state | character | |
| | varying(10) | |
| zip | character | |
| | varying(10) | |
| phone | character | |
| | varying(25) | |
| date_created | timestamp | not null default now( ) |
| | without time | |
| | zone | |
| c_number | character | |
| | varying(20) | |
| c_expires | character | |
| | varying(7) | |
| c_type | text | |
| total_price | double | |
| | precision | |
| transaction_code | character | |
| | varying(50) | |
| num_trans | integer | |
| appr_code | character | |
| | varying(6) | |
| user_ip | inet | |
| cart_id | integer | |
| c_type_id | smallint | |

Indexes:
“invoices_pkey” PRIMARY KEY, btree (invoice_id)
Foreign-key constraints:
“invoices_user_id_fkey” FOREIGN KEY (user_id) REFERENCES usr.users(user_id) ON DELETE CASCADE

Table “billing.transaction_log”

| Column | Type | Modifiers |
|---|---|---|
| transaction_id | integer | not null default |
| | | nextval(‘billing.transaction_log_transaction_id_seq’::regclass) |
| transaction_code | integer | |
| cart_id | integer | |
| status_code | integer | |
| date_created | timestamp | default now( ) |
| | without time zone | |
| data_recieved | text | |
| data_sent | text | |

Indexes: None

Table “blog.blog_entry”

| Column | Type | Modifiers |
|---|---|---|
| blog_entry_id | integer | not null |
| user_id | bigint | not null |
| title | character varying(255) | not null |
| content | text | not null |
| blog_id | integer | not null |
| date_created | timestamp without time | not null default now( ) |
| | zone | |
| active | boolean | default true |
| url_title | character varying | |

Indexes:
“blog_entry_pkey” PRIMARY KEY, btree (blog_entry_id)
Foreign-key constraints:
“blog_entry_user_id_fkey” FOREIGN KEY (user_id) REFERENCES usr.users(user_id) ON DELETE CASCADE

Table “blog.blog_entry_categories”

| Column | Type | Modifiers |
|---|---|---|
| blog_entry_category_id | integer | not null default |
| | | nextval(‘blog.blog_entry_categories_blog_entry_category_id_seq’::regclass) |
| blog_entry_id | bigint | not null |
| category_id | integer | not null |
| date_created | timestamp | not null default now( ) |
| | without time | |
| | zone | |

Indexes:
“blog_entry_categories_pkey” PRIMARY KEY, btree (blog_entry_category_id)

Table “blog.blog_entry_comment”

| Column | Type | Modifiers |
|---|---|---|
| blog_entry_comment_id | bigint | not null |
| user_id | bigint | not null |
| comment | text | not null |
| parent_blog_entry_comment_id | integer | not null default |
| | | nextval(‘blog.blog_entry_comment_parent_blog_entry_comment_id_seq’::regclass) |
| blog_entry_id | integer | not null |
| date_created | timestamp | not null default now( ) |
| | without | |
| | time zone | |
| active | boolean | default true |

Indexes:
“blog_entry_comment_blog_entry_comment_id_key” UNIQUE, btree (blog_entry_comment_id)
Foreign-key constraints:
“blog_entry_comment_user_id_fkey” FOREIGN KEY (user_id) REFERENCES usr.users(user_id) ON DELETE CASCADE

Table “blog.blog_entry_comment_ratings”

| Column | Type | Modifiers |
|---|---|---|
| blog_entry_comment_rating_id | integer | not null default |
| | | nextval(‘blog.blog_entry_comment_ratings_id_seq’::regclass) |
| blog_entry_id | integer | |
| user_id | integer | |
| date_created | timestamp | not null default now( ) |
| | without time | |
| | zone | |
| blog_entry_comment_id | bigint | |
| rating | text | |

Indexes:
“blog_entry_comment_ratings_pkey” PRIMARY KEY, btree (blog_entry_comment_rating_id)
Foreign-key constraints:
“blog_entry_comment_ratings_user_id_fkey” FOREIGN KEY (user_id) REFERENCES usr.users(user_id) ON DELETE CASCADE

Table “blog.blog_entry_tags”

| Column | Type | Modifiers |
|---|---|---|
| blog_entry_tag_id | integer | not null default |
| | | nextval(‘blog.blog_entry_tags_blog_entry_tag_id_seq’::regclass) |
| blog_entry_id | bigint | not null |
| tag | character | not null |
| | varying(50) | |
| date_created | timestamp | not null default now( ) |
| | without time | |
| | zone | |
| category | boolean | not null default false |
| tag_type_id | integer | not null default 1 |

Indexes:
“blog_entry_tags_pkey” PRIMARY KEY, btree (blog_entry_tag_id)

Table “blog.blogs”

| Column | Type | Modifiers |
|---|---|---|
| blog_id | integer | not null default |
| | | nextval(‘blog.blogs_blog_id_seq’::regclass) |
| owner_type_id | integer | not null |
| owner_id | integer | not null |
| title | character varying(50) | not null |
| url_title | character varying(50) | not null |
| description | text | not null |
| date_created | timestamp without time | not null default now( ) |
| | zone | |
| index_level | integer | default 2 |
| status_id | integer | default 2 |

Indexes:
“blogs_pkey” PRIMARY KEY, btree (blog_id)

Table “blog.blogs1”

| Column | Type | Modifiers |
|---|---|---|
| blog_id | integer | not null |
| user_id | bigint | not null |
| title | character varying(50) | not null |
| community_id | integer | |
| date_created | timestamp without time | not null default now( ) |
| | zone | |
| active | boolean | default true |
| sharing_option_id | integer | not null default 1 |
| last_updated | timestamp without time | default now( ) |
| | zone | |
| description | text | default 0 |
| number_views | bigint | |
| url_title | character varying | |

Indexes:
“blogs1_pkey” PRIMARY KEY, btree (blog_id)
Foreign-key constraints:
“blogs1_community_id_fkey” FOREIGN KEY (community_id) REFERENCES community.communities(community_id) ON DELETE CASCADE
“blogs1_user_id_fkey” FOREIGN KEY (user_id) REFERENCES usr.users(user_id) ON DELETE CASCADE

Table “blog.blogs_reported”

| Column | Type | Modifiers |
|---|---|---|
| reported_id | integer | not null default |
| | | nextval(‘blog.blogs_reported_blogs_reported_id_seq’::regclass) |
| blog_id | integer | not null |
| user_id | integer | not null |
| reported_reason_id | smallint | not null |
| reviewer | character | |
| | varying(50) | |
| reviewer_comments | text | |
| date_created | timestamp | not null default now( ) |
| | without | |
| | time zone | |
| date_modified | timestamp | |
| | without | |
| | time zone | |
| flag_comment | text | |

Indexes:
“blogs_reported_pkey” PRIMARY KEY, btree (reported_id)

Table “blog.categories”

| Column | Type | Modifiers |
|---|---|---|
| blog_category_id | integer | not null default |
| | | nextval(‘blog.categories_blog_category_id_seq’::regclass) |
| blog_id | bigint | not null |
| category_id | integer | not null |
| date_created | timestamp | not null default now( ) |
| | without | |
| | time zone | |

Indexes:
“categories_pkey” PRIMARY KEY, btree (blog_category_id)

Table “blog.post_to_blog”

| Column | Type | Modifiers |
|---|---|---|
| post_to_blog_id | integer | not null default |
| | | nextval(‘blog.post_to_blog_post_to_blog_id_seq’::regclass) |
| blog_id | integer | not null |
| post_id | integer | not null |
| date_created | timestamp | not null default now( ) |
| | without | |
| | time zone | |

Indexes:
“post_to_blog_pkey” PRIMARY KEY, btree (post_to_blog_id)

Table “blog.posts”

| Column | Type | Modifiers |
|---|---|---|
| post_id | integer | not null default |
| | | nextval(‘blog.posts_post_id_seq’::regclass) |
| user_id | integer | |
| title | character varying(50) | not null |
| url_title | character varying(50) | not null |
| body | text | not null |
| status_id | integer | not null default 2 |
| index_level | integer | default 2 |
| date_created | timestamp without time | not null default now( ) |
| | zone | |

Indexes:
“posts_pkey” PRIMARY KEY, btree (post_id)

Table “blog.reported”

| Column | Type | Modifiers |
|---|---|---|
| reported_id | integer | not null default |
| | | nextval(‘blog.reported_reported_id_seq’::regclass) |
| blog_entry_id | integer | not null |
| user_id | integer | not null |
| reported_reason_id | smallint | not null |
| reviewer | character | |
| | varying(50) | |
| reviewer_comments | text | |
| date_created | timestamp | not null default now( ) |
| | without time | |
| | zone | |
| date_modified | timestamp | |
| | without time | |
| | zone | |
| flag_comment | text | |

Indexes:
“reported_pkey” PRIMARY KEY, btree (reported_id)

Table “blog.tags”

| Column | Type | Modifiers |
|---|---|---|
| tag_id | integer | not null default |
| | | nextval(‘blog.tags_tag_id_seq’::regclass) |
| blog_id | bigint | not null |
| tag | character | not null |
| | varying(50) | |
| date_created | timestamp | not null default now( ) |
| | without | |
| | time zone | |
| category | boolean | not null default false |
| tag_type_id | integer | not null default 1 |

Indexes:
“tags_pkey” PRIMARY KEY, btree (tag_id)

Table “blog.user_favorites”

| Column | Type | Modifiers |
|---|---|---|
| user_favorite_id | integer | not null default |
| | | nextval(‘blog.user_favorites_user_favorite_id_seq’::regclass) |
| user_id | bigint | not null |
| blog_id | bigint | not null |
| date_created | timestamp | not null default now( ) |
| | without | |
| | time zone | |
| last_accessed | date | |

Indexes:
“user_favorites_pkey” PRIMARY KEY, btree (user_favorite_id)

Table “catholic.bible_books”

| Column | Type | Modifiers |
|---|---|---|
| id | integer | not null default |
| | | nextval(‘catholic.bible_books_bible_book_id_seq’::regclass) |
| bible_book_name | character | not null |
| | varying(25) | |
| language_id | integer | not null |
| date_created | timestamp without | not null default now( ) |
| | time zone | |
| bible_book_id | integer | not null |
| enus_bible_book_name | character | |
| | varying(25) | |
| esus_bible_book_name | character | |
| | varying(25) | |
| zhcn_bible_book_name | character | |
| | varying(25) | |

Indexes:
“bible_books_pkey” PRIMARY KEY, btree (id)

Table “catholic.bible_chapters”

| Column | Type | Modifiers |
|---|---|---|
| bible_chapter_id | integer | not null default |
| | | nextval(‘catholic.bible_chapters_bible_chapter_id_seq’::regclass) |
| chapter | character | not null |
| | varying(3) | |
| number_of_verses | integer | not null |
| bible_book_id | smallint | not null |
| language_id | smallint | not null |
| date_created | timestamp | not null default now( ) |
| | without | |
| | time zone | |

Indexes:
“bible_chapters_pkey” PRIMARY KEY, btree (bible_chapter_id)

Table “catholic.catechisms”

| Column | Type | Modifiers |
|---|---|---|
| catechism_id | integer | not null default |
| | | nextval(‘catholic.catechisms_catechism_id_seq1’::regclass) |
| parent_catechism_id | integer | |
| name | character | not null |
| | varying(100) | |
| date_created | timestamp | not null default now( ) |
| | without time | |
| | zone | |
| enus_catechism | character | |
| | varying(100) | |
| esus_catechism | character | |
| | varying(100) | |
| zhcn_catechism | character | |
| | varying(100) | |

Indexes:
“catechisms_pkey” PRIMARY KEY, btree (catechism_id)

Table “catholic.catholic_genres”

| Column | Type | Modifiers |
|---|---|---|
| catholic_genre_id | integer | not null default |
| | | nextval(‘catholic.genres_catholic_genre_id_seq’::regclass) |
| catholic_genre | character | not null |
| | varying(25) | |
| language_id | smallint | not null |
| date_created | timestamp | not null default now( ) |
| | without | |
| | time zone | |
| enus_catholic_genre | character | |
| | varying(25) | |
| esus_catholic_genre | character | |
| | varying(25) | |
| zhcn_catholic_genre | character | |
| | varying(25) | |

Indexes:
“genres_pkey” PRIMARY KEY, btree (catholic_genre_id)

Table “catholic.feasts”

| Column | Type | Modifiers |
|---|---|---|
| feast_id | integer | not null default |
| | | nextval(‘catholic.feasts_feast_id_seq’::regclass) |
| feast | character | not null |
| | varying(50) | |
| feast_type_id | smallint | |
| enus_feast | character | |
| | varying(50) | |
| esus_feast | character | |
| | varying(50) | |
| zhcn_feast | character varying | |

Indexes:
“feasts_pkey” PRIMARY KEY, btree (feast_id)
“feasts_feast_key” UNIQUE, btree (feast)

Table “catholic.liturgical_date_to_feasts”

| Column | Type | Modifiers |
|---|---|---|
| liturgical_date_to_feast_id | integer | not null default |
| | | nextval(‘catholic.liturgical_date_to_feasts_liturgical_date_to_feast_id_seq’ |
| | | ::regclass) |
| liturgical_to_date_id | integer | not null |
| feast_id | integer | not null |
| date_created | timestamp | not null default now( ) |
| | without time | |
| | zone | |

Indexes:
“liturgical_date_to_feasts_pkey” PRIMARY KEY, btree (liturgical_date_to_feast_id)

Table “catholic.liturgical_day”

| Column | Type | Modifiers |
|---|---|---|
| liturgical_day_id | integer | not null default |
| | | nextval(‘catholic.liturgical_day_liturgical_day_id_seq’::regclass) |
| season_id | integer | not null |
| year_cycle | character(2) | |
| day | character | not null |
| | varying(50) | |

Indexes:
“liturgical_day_pkey” PRIMARY KEY, btree (liturgical_day_id)

Table “catholic.liturgical_readings”

| Column | Type | Modifiers |
|---|---|---|
| liturgical_readings_id | integer | not null default |
| | | nextval(‘catholic.liturgical_readings_liturgical_readings_id_seq’::regclass) |
| liturgical_day_id | integer | not null |
| bible_book_id | integer | not null |
| bible_chapter_id | integer | not null |
| verse_start | smallint | not null |
| verse_end | smallint | not null |
| verse_type_id | smallint | |

Indexes:
“liturgical_readings_pkey” PRIMARY KEY, btree (liturgical_readings_id)

Table “catholic.liturgical_to_date”

| Column | Type | Modifiers |
|---|---|---|
| liturgical_to_date_id | integer | not null default |
| | | nextval(‘catholic.liturgical_to_date_liturgical_to_date_id_seq’::regclass) |
| liturgical_day_id | integer | not null |
| date | date | not null |

Indexes:
“liturgical_to_date_pkey” PRIMARY KEY, btree (liturgical_to_date_id)
“liturgical_to_date_date_key” UNIQUE, btree (date)

Table “catholic.mass_types”

| Column | Type | Modifiers |
|---|---|---|
| mass_type_id | integer | not null default |
| | | nextval(‘catholic.mass_types_mass_type_id_seq’::regclass) |
| type | character | not null |
| | varying(100) | |

Indexes:
“mass_type_id_pk” PRIMARY KEY, btree (mass_type_id)

Table “catholic.masses”

| Column | Type | Modifiers |
|---|---|---|
| mass_id | integer | not null default |
| | | nextval(‘catholic.masses_mass_id_seq’::regclass) |
| mass | character | not null |
| | varying(100) | |
| mass_type_id | smallint | not null |
| date_created | timestamp without | not null default now( ) |
| | time zone | |

Indexes:
“masses_pkey” PRIMARY KEY, btree (mass_id)

Table “catholic.sacraments”

| Column | Type | Modifiers |
|---|---|---|
| sacrament_id | integer | not null default |
| | | nextval(‘catholic.sacraments_sacrament_id_seq’::regclass) |
| language_id | smallint | not null |
| date_created | timestamp | not null default now( ) |
| | without time | |
| | zone | |
| sacrament | character | not null |
| | varying(75) | |

Indexes:
“sacraments_pkey” PRIMARY KEY, btree (sacrament_id)

Table “catholic.seasons”

| Column | Type | Modifiers |
|---|---|---|
| season_id | integer | not null default |
| | | nextval(‘catholic.seasons_season_id_seq’::regclass) |
| season | character | not null |
| | varying(25) | |
| color | character | not null |
| | varying(10) | |
| language_id | smallint | not null |
| date_created | timestamp | not null default now( ) |
| | without time zone | |

Indexes:
“seasons_pkey” PRIMARY KEY, btree (season_id)

Table “commerce.coupon_use”

| Column | Type | Modifiers |
|---|---|---|
| coupon_use_id | integer | not null default |
| | | nextval(‘commerce.coupon_use_coupon_use_id_seq’::regclass) |
| coupon_id | integer | |
| invoice_id | integer | |
| user_id | integer | |
| date_created | timestamp | default now( ) |
| | without | |
| | time zone | |
| amount_used | double | |
| | precision | |

Indexes:
“coupon_use_pkey” PRIMARY KEY, btree (coupon_use_id)

Table “commerce.coupons”

| Column | Type | Modifiers |
|---|---|---|
| coupon_id | integer | not null default |
| | | nextval(‘commerce.coupons_coupon_id_seq’::regclass) |
| coupon_code | character | |
| | varying(12) | |
| amount | double | |
| | precision | |
| amount_type | integer | |
| coupon_title | text | |
| coupon_desc | text | |
| publisher_id | integer | |
| issuer_type | integer | |
| start_date | timestamp | |
| | without time | |
| | zone | |
| end_date | timestamp | |
| | without time | |
| | zone | |
| uses | integer | |
| date_created | timestamp | default now( ) |
| | without time | |
| | zone | |
| date_modified | time with time | |
| | zone | |
| publisher_split | integer | |
| max_items | integer | |

Indexes:
“coupons_pkey” PRIMARY KEY, btree (coupon_id)
“coupons_coupon_code_key” UNIQUE, btree (coupon_code)

Table “commerce.discounts_log”

| Column | Type | Modifiers |
|---|---|---|
| discount_id | integer | not null default |
| | | nextval(‘commerce.discounts_log_discount_id_seq’::regclass) |
| invoice_id | integer | |
| publisher_id | integer | |
| coupon_id | integer | |
| date_created | timestamp | default now( ) |
| | without | |
| | time zone | |
| discount_amount | double | |
| | precision | |

Indexes:
“discounts_log_pkey” PRIMARY KEY, btree (discount_id)

Table “commerce.invoice_items”

| Column | Type | Modifiers |
|---|---|---|
| invoice_item_id | bigint | not null default |
| | | nextval(‘commerce.invoice_items_invoice_item_id_seq’::regclass) |
| invoice_id | integer | not null |
| item_code | character | |
| | varying(20) | |
| charge_type_id | integer | not null |
| charge_info | text | |
| date_created | timestamp | not null default now( ) |
| | without time | |
| | zone | |
| price | double | |
| | precision | |

Indexes:
“invoice_items_pkey” PRIMARY KEY, btree (invoice_item_id)

Table “commerce.invoices”

| Column | Type | Modifiers |
|---|---|---|
| invoice_id | bigint | not null default |
| | | nextval(‘commerce.invoices_invoice_id_seq’::regclass) |
| user_id | bigint | not null |
| invoice_status_id | smallint | not null |
| first_name | character varying(50) | |
| last_name | character varying(50) | |
| address_1 | character varying(25) | |
| city | character varying(25) | |
| state | character varying(10) | |
| zip | character varying(10) | |
| date_created | timestamp without time | not null default now( ) |
| | zone | |
| c_number | character varying(20) | |
| c_expires | character varying(7) | |
| c_type | text | |
| total_price | double precision | |
| transaction_code | character varying(50) | |
| num_trans | integer | |
| appr_code | character varying(6) | |
| user_ip | inet | |

Indexes:
“invoices_pkey” PRIMARY KEY, btree (invoice_id)

Table “commerce.shopping_cart”

| Column | Type | Modifiers |
|---|---|---|
| cart_item_id | integer | not null default |
| | | nextval(‘commerce.shopping_cart_cart_item_id_seq’::regclass) |
| charge_type_id | integer | not null |
| charge_info | text | |
| user_id | integer | not null |
| date_created | timestamp without | not null default now( ) |
| | time zone | |
| item_code | character varying(20) | |

Indexes:
“shopping_cart_pkey” PRIMARY KEY, btree (cart_item_id)

Table “commerce.transaction_log”

| Column | Type | Modifiers |
|---|---|---|
| transaction_id | integer | not null default |
| | | nextval(‘commerce.transaction_log_transaction_id_seq’::regclass) |
| transaction_code | character | |
| | varying | |
| status_code | integer | |
| date_created | timestamp | default now( ) |
| | without | |
| | time zone | |
| data_recieved | text | |
| data_sent | text | |

Indexes:
“transaction_pkey” PRIMARY KEY, btree (transaction_id)

Table “community.active_modules”

| Column | Type | Modifiers |
|---|---|---|
| active_modules_id | integer | not null default |
| | | nextval(‘community.active_modules_active_modules_id_seq’::regclass) |
| community_id | integer | not null |
| module_id | integer | not null |
| display_order | integer | not null default 1 |
| date_created | timestamp | not null default now( ) |
| | without | |
| | time zone | |

Indexes:
“active_modules_pkey” PRIMARY KEY, btree (active_modules_id)
Foreign-key constraints:
“active_modules_community_id_fkey” FOREIGN KEY (community_id) REFERENCES community.communities(community_id) ON DELETE CASCADE
“active_modules_module_id_fkey” FOREIGN KEY (module_id) REFERENCES module.modules(module_id) ON DELETE CASCADE

Table “community.bans”

| Column | Type | Modifiers |
|---|---|---|
| ban_id | integer | not null default |
| | | nextval(‘community.bans_ban_id_seq’::regclass) |
| user_id | bigint | not null |
| community_id | integer | not null |
| reason | text | not null |
| date_created | timestamp without | not null default now( ) |
| | time zone | |

Indexes:
“bans_pkey” PRIMARY KEY, btree (ban_id)
Foreign-key constraints:
“bans_community_id_fkey” FOREIGN KEY (community_id) REFERENCES community.communities(community_id) ON DELETE CASCADE
“bans_user_id_fkey” FOREIGN KEY (user_id) REFERENCES usr.users(user_id) ON DELETE CASCADE

Table “community.categories”

| Column | Type | Modifiers |
|---|---|---|
| com_category_id | integer | not null default |
| | | nextval(‘community.categories_com_category_id_seq’::regclass) |
| community_id | bigint | not null |
| category_id | integer | not null |
| date_created | timestamp | not null default now( ) |
| | without | |
| | time zone | |

Indexes:
“categories_pkey” PRIMARY KEY, btree (com_category_id)
Foreign-key constraints:
“categories_community_id_fkey” FOREIGN KEY (community_id) REFERENCES community.communities(community_id) ON DELETE CASCADE

Table “community.communities”

| Column | Type | Modifiers |
|---|---|---|
| community_id | integer | not null default |
| | | nextval(‘community.communities_community_id_seq’::regclass) |
| name | character varying(75) | not null |
| description | text | |
| language_id | integer | not null |
| created_at | timestamp without time zone | not null default now( ) |
| date_modified | timestamp without time zone | |
| owner_id | integer | |
| url | character varying(200) | |
| privacy | integer | |
| community_type_id | integer | |
| media_filename | character(72) | |
| password | character(72) | |
| parent_community_id | integer | not null default 0 |
| pricing_type_id | integer | default 0 |
| approved | boolean | default false |
| media_active | boolean | default false |
| explicit | boolean | default false |
| featured | boolean | default false |
| locking_time | timestamp without time zone | |
| featured_media_id | integer | not null default 0 |
| active | boolean | not null default true |
| private | boolean | not null default false |
| join_requires_approval | boolean | not null default false |
| subscription_id | integer | default 1 |
| show_members | boolean | not null default true |
| contact_email | character varying(50) | |
| donate_url | character varying(200) | |
| welcome_email | text | |
| permission_create_blog | boolean | not null default true |
| permission_create_media | boolean | not null default true |
| permission_create_group | boolean | not null default true |
| permission_create_discussion | boolean | not null default true |
| autojoin | boolean | default false |
| admin_email | character varying(50) | |
| banner_media_id | integer | |
| permission_create_link | boolean | not null default true |
| join_requires_name | boolean | default false |
| member_count | integer | default 0 |
| banner_path | character varying | |
| show_url | boolean | |
| show_donate_url | boolean | |
| show_contact_email | boolean | |
| group_status_id | integer | |
| index_level | integer | default 1 |

Indexes:
“communities_pkey” PRIMARY KEY, btree (community_id)
Foreign-key constraints:
“communities_community_id_fkey” FOREIGN KEY (community_id) REFERENCES community.communities(community_id) ON DELETE CASCADE

Table “community.community_color”

| Column | Type | Modifiers |
|---|---|---|
| community_id | integer | not null |
| header_color | character varying(50) | |
| bg_header_color | character varying(50) | not null |
| content_color | character varying(50) | |
| bg_content_color | character varying(50) | not null |
| image_bg_content_color | character varying(255) | not null |
| navigator_color | character varying(255) | not null |
| bg_navigator_color | character varying(255) | not null |
| image_pos | character varying(255) | |

Indexes:
“community_color_pkey” PRIMARY KEY, btree (community_id)
Foreign-key constraints:
“community_color_community_id_fkey” FOREIGN KEY (community_id) REFERENCES community.communities(community_id) ON DELETE CASCADE

Table “community.membership”

| Column | Type | Modifiers |
|---|---|---|
| membership_id | integer | not null default |
| | | nextval(‘community.membership_membership_id_seq’::regclass) |
| user_id | bigint | not null |
| community_id | integer | not null |
| banned | boolean | not null default false |
| cfca_id | integer | |
| date_joined | timestamp | not null default now( ) |
| | without time | |
| | zone | |
| access | integer | default 0 |
| allow_post_blog | boolean | |
| allow_post_media | boolean | |
| allow_add_group | boolean | |
| allow_create_discussion | boolean | |
| date_created | timestamp | |
| | without time | |
| | zone | |
| allow_add_link | boolean | |

Indexes:
“membership_pkey” PRIMARY KEY, btree (membership_id)
“membership_uniq” UNIQUE, btree (user_id, community_id)
Foreign-key constraints:
“membership_community_id_fkey” FOREIGN KEY (community_id) REFERENCES community.communities(community_id) ON DELETE CASCADE
“membership_user_id_fkey” FOREIGN KEY (user_id) REFERENCES usr.users(user_id) ON DELETE CASCADE

Table “community.navigator_color”

| Column | Type | Modifiers |
|---|---|---|
| community_id | integer | not null |
| header_color | character varying(50) | |
| bg_header_color | character varying(50) | not null |
| content_color | character varying(50) | |
| bg_content_color | character varying(50) | not null |
| image_bg_content_color | character varying(255) | not null |
| image_pos | character varying(255) | |

Indexes:
“navigator_color_pkey” PRIMARY KEY, btree (community_id)

Table “community.site_color”

| Column | Type | Modifiers |
|---|---|---|
| community_id | integer | not null |
| header_color | character varying(50) | |
| bg_header_color | character varying(50) | not null |
| content_color | character varying(50) | |
| bg_content_color | character varying(50) | not null |
| image_bg_content_color | character varying(255) | not null |
| image_pos | character varying(255) | |
| applied_header_color | boolean | default false |
| applied_bg_header_color | boolean | default false |
| applied_bg_content_color | boolean | default false |
| applied_image_bg_content | boolean | default false |
| site_image_pos | character varying | |
| site_image_bg_color | character varying | |
| site_bg_color | character varying | |

Indexes:
“site_color_pkey” PRIMARY KEY, btree (community_id)

Table “community.tags”

| Column | Type | Modifiers |
|---|---|---|
| tag_id | integer | not null default |
| | | nextval(‘community.tags_tag_id_seq’::regclass) |
| community_id | bigint | not null |
| tag | character | not null |
| | varying(50) | |
| date_created | timestamp | not null default now( ) |
| | without time zone | |
| category | boolean | not null default false |
| tag_type_id | integer | not null default 1 |

Indexes:
“tags_pkey” PRIMARY KEY, btree (tag_id)
Foreign-key constraints:
“tags_community_id_fkey” FOREIGN KEY (community_id) REFERENCES community.communities(community_id) ON DELETE CASCADE

Table “community.user_queue”

| Column | Type | Modifiers |
|---|---|---|
| user_queue_id | integer | not null default |
| | | nextval(‘community.user_queue_user_queue_id_seq’::regclass) |
| user_id | bigint | not null |
| community_id | integer | not null |
| approved | boolean | |
| date_created | timestamp | not null default now( ) |
| | without | |
| | time zone | |
| group_id | integer | |

Indexes:
“user_queue_pkey” PRIMARY KEY, btree (user_queue_id)
Foreign-key constraints:
“user_queue_community_id_fkey” FOREIGN KEY (community_id) REFERENCES community.communities(community_id) ON DELETE CASCADE
“user_queue_user_id_fkey” FOREIGN KEY (user_id) REFERENCES usr.users(user_id) ON DELETE CASCADE

Table “discussion.comment”

| Column | Type | Modifiers |
|---|---|---|
| comment_id | integer | default |
| | | nextval(‘comment_comment_id_seq’::regclass) |
| discussion_id | integer | not null |
| user_id | bigint | not null |
| comment | text | not null |
| parent_comment_id | integer | not null |
| date_created | timestamp | |
| | without time | |
| | zone | |

Indexes:
“comment_pkey” PRIMARY KEY, btree (discussion_id, user_id, comment, parent_comment_id)
Foreign-key constraints:
“comment_user_id_fkey” FOREIGN KEY (user_id) REFERENCES usr.users(user_id) ON DELETE CASCADE

Table “discussion.discussion_comment_ratings”

| Column | Type | Modifiers |
|---|---|---|
| discussion_comment_rating_id | integer | not null default |
| | | nextval(‘discussion.discussion_comment_ratings_id_seq’ |
| | | ::regclass) |
| discussion_id | integer | |
| user_id | integer | |
| date_created | timestamp | not null default now( ) |
| | without time | |
| | zone | |
| discussion_comment_id | bigint | |
| rating | text | |

Indexes:
“discussion_comment_ratings_pkey” PRIMARY KEY, btree (discussion_comment_rating_id)
Foreign-key constraints:
“discussion_comment_ratings_user_id_fkey” FOREIGN KEY (user_id) REFERENCES usr.users(user_id) ON DELETE CASCADE

Table “discussion.discussion_topic”

| Column | Type | Modifiers |
|---|---|---|
| discussion_id | integer | not null default |
| | | nextval(‘discussion_discussion_id_seq’::regclass) |
| community_id | integer | |
| user_id | bigint | |
| title | character | |
| | varying(255) | |
| content | text | |
| date_created | timestamp | |
| | without time | |
| | zone | |
| sharing_option_id | integer | |
| active | boolean | default true |
| last_updated | timestamp | default now( ) |
| | without time | |
| | zone | |

Indexes:
“discussion_topic_pkey” PRIMARY KEY, btree (discussion_id)
Foreign-key constraints:
“discussion_topic_color_community_id_fkey” FOREIGN KEY (community_id) REFERENCES community.communities(community_id) ON DELETE CASCADE
“discussion_topic_user_id_fkey” FOREIGN KEY (user_id) REFERENCES usr.users(user_id) ON DELETE CASCADE

Table “discussion.reported”

| Column | Type | Modifiers |
|---|---|---|
| reported_id | integer | not null default |
| | | nextval(‘discussion.reported_reported_id_seq’::regclass) |
| discussion_id | integer | not null |
| user_id | integer | not null |
| reported_reason_id | smallint | not null |
| reviewer | character | |
| | varying(50) | |
| reviewer_comments | text | |
| date_created | timestamp without | not null default now( ) |
| | time zone | |
| date_modified | timestamp without | |
| | time zone | |
| flag_comment | text | |

Indexes:
“reported_pkey” PRIMARY KEY, btree (reported_id)

Table “faq.categories”

| Column | Type | Modifiers |
|---|---|---|
| category_id | integer | not null default |
| | | nextval(‘faq.categories_category_id_seq’::regclass) |
| category_name | text | |
| language_id | integer | |
| date_created | timestamp | default now( ) |
| | without time | |
| | zone | |
| display_order | integer | |
| active | boolean | default false |

Indexes:
“categories_pkey” PRIMARY KEY, btree (category_id)

Table “faq.questions”

| Column | Type | Modifiers |
|---|---|---|
| question_id | integer | not null default |
| | | nextval(‘faq.questions_question_id_seq’::regclass) |
| category_id | integer | |
| question_text | text | |
| answer_text | text | |
| date_created | timestamp | default now( ) |
| | without time zone | |
| active | boolean | default false |
| display_order | integer | |

Indexes:
“questions_pkey” PRIMARY KEY, btree (question_id)
“questions_answer_text_key” UNIQUE, btree (answer_text)
“questions_question_text_key” UNIQUE, btree (question_text)

Table “general.addresses”

| Column | Type | Modifiers |
|---|---|---|
| address_id | bigint | not null default |
| | | nextval(‘general.addresses_address_id_seq’::regclass) |
| address_type_id | smallint | not null |
| address_1 | character varying(100) | not null |
| address_2 | character varying(100) | not null |
| city | character varying(50) | not null |
| zipcode | character varying(10) | not null |
| country_id | smallint | not null |
| date_created | timestamp without time | not null default now( ) |
| | zone | |
| state_id | integer | |
| email | character(200) | |
| phone | character(20) | |
| fax | character(20) | |
| name | character(50) | |
| show_address | boolean | |
| show_community_phone | boolean | |

Indexes:
“addresses_pkey” PRIMARY KEY, btree (address_id)

Table “general.comments”

| Column | Type | Modifiers |
|---|---|---|
| comment_id | integer | not null default |
| | | nextval(‘general.comments_comment_id_seq’::regclass) |
| parent_id | integer | default 0 |
| comment | text | |
| score | integer | |
| status_id | integer | default 2 |
| object_id | integer | not null |
| object_type_id | integer | not null |
| user_id | integer | not null |
| date_created | timestamp | not null default now( ) |
| | without time | |
| | zone | |

Indexes:
“comments_pkey” PRIMARY KEY, btree (comment_id)

Table “general.content”

| Column | Type | Modifiers |
|---|---|---|
| content_id | integer | not null default |
| | | nextval(‘general.content_content_id_seq’::regclass) |
| block_id | integer | not null default 1 |
| content | text | not null |
| date_start | timestamp without time zone | not null |
| date_end | timestamp without time zone | not null default now( ) |
| date_created | timestamp without time zone | not null default now( ) |

Indexes:
“content_pkey” PRIMARY KEY, btree (content_id)

Table “general.dessert_clicks”

| Column | Type | Modifiers |
|---|---|---|
| dessert_click_id | integer | not null default |
| | | nextval(‘general.dessert_clicks_dessert_click_id_seq’::regclass) |
| dessert_id | integer | |
| ip_address | inet | |
| cost | real | |
| date_created | timestamp | not null default now( ) |
| | without | |
| | time zone | |
| user_id | integer | |
| url | text | |

Indexes:
“dessert_clicks_pkey” PRIMARY KEY, btree (dessert_click_id)
Foreign-key constraints:
“dessert_clicks_user_id_fkey” FOREIGN KEY (user_id) REFERENCES
usr.users(user_id) ON DELETE CASCADE

Table “general.email”

| Column | Type | Modifiers |
|---|---|---|
| email_id | integer | not null default |
| | | nextval(‘general.email_email_id_seq’::regclass) |
| from_email | character varying(100) | |
| to_email | character varying(100) | not null |
| subject | text | not null |
| body | text | not null |
| headers | text | |
| date_created | timestamp without time | not null default now( ) |
| | zone | |
| date_sent | timestamp without time | |
| | zone | |
| content_type | text | |

Indexes: none

Table “general.message_text”

| Column | Type | Modifiers |
|---|---|---|
| message_text_id | integer | not null default |
| | | nextval(‘general.message_text_id_seq’::regclass) |
| from_user_id | integer | |
| from_username | character | |
| | varying | |
| subject | character | |
| | varying | |
| text | text | |
| touserarray | character | |
| | varying | |
| date_created | timestamp | default now( ) |
| | without time | |
| | zone | |

Indexes:
“pmtext_pkey” PRIMARY KEY, btree (message_text_id)

Table “general.messages”

| Column | Type | Modifiers |
|---|---|---|
| message_id | integer | not null default |
| | | nextval(‘general.messages_message_id_seq’::regclass) |
| message_text_id | integer | |
| user_id | integer | |
| folder_id | integer | |
| message_read | boolean | default false |

Indexes:
“messages_pkey” PRIMARY KEY, btree (message_id)

Table “general.meta_data”

| Column | Type | Modifiers |
|---|---|---|
| page_id | integer | not null default |
| | | nextval(‘general.meta_data_page_id_seq’::regclass) |
| page | text | not null |
| title | text | |
| keywords | text | |
| description | text | |
| expire | text | |
| date_created | timestamp | default now( ) |
| | without time zone | |

Indexes:
“meta_data_pkey” PRIMARY KEY, btree (page_id)

Table “general.redirects”

| Column | Type | Modifiers |
|---|---|---|
| redirect_id | integer | not null default |
| | | nextval(‘general.redirects_redirect_id_seq’::regclass) |
| source | character | not null |
| | varying | |
| target | character | not null |
| | varying | |
| date_created | timestamp | not null default now( ) |
| | without time zone | |

Indexes:
“redirects_pkey” PRIMARY KEY, btree (redirect_id)

Table “general.review_log”

| Column | Type | Modifiers |
|---|---|---|
| review_id | integer | not null |
| reviewer_id | bigint | |
| review_date | timestamp with time zone | |
| media_id | integer | |
| email | character varying(50) | |
| media_type | smallint | |
| media_title | text | |
| action_type | smallint | |
| system_type | smallint | |
| reason | text | |
| comment | text | |

Indexes:
“review_log_pkey” PRIMARY KEY, btree (review_id)
Foreign-key constraints:
“review_log_media_id_fkey” FOREIGN KEY (media_id) REFERENCES
media.media(media_id) ON DELETE CASCADE

Table “general.shopping_cart”

| Column | Type | Modifiers |
|---|---|---|
| cart_item_id | integer | not null default |
| | | nextval(‘general.shopping_cart_cart_item_id_seq’::regclass) |
| user_id | integer | not null |
| object_id | integer | not null |
| object_type_id | integer | not null |

Indexes:
“shopping_cart_pkey” PRIMARY KEY, btree (cart_item_id)

Table “general.site_msgs”

| Column | Type | Modifiers |
|---|---|---|
| msg_id | integer | not null default |
| | | nextval(‘general.site_msgs_msg_id_seq’::regclass) |
| user_id | integer | |
| msg_type | character | |
| | varying(10) | |
| message | text | |
| active | boolean | default true |
| date_created | timestamp without | default now( ) |
| | time zone | |
| date_expires | timestamp without | |
| | time zone | |
| session_id | character varying | |

Indexes:
“site_msgs_pkey” PRIMARY KEY, btree (msg_id)
Foreign-key constraints:
“site_msgs_user_id_fkey” FOREIGN KEY (user_id) REFERENCES
usr.users(user_id) ON DELETE CASCADE

Table “general.templates”

| Column | Type | Modifiers |
|---|---|---|
| tmpl_id | integer | not null default |
| | | nextval(‘general.templates_tpl_id_seq’::regclass) |
| tmpl_name | character varying(50) | not null |
| tmpl_content | text | |
| date_created | timestamp without | not null default now( ) |
| | time zone | |
| language_id | integer | |
| txt_tmpl | text | |
| Subject | character | |
| | varying(200) | |
| from_email | character varying(50) | |

Indexes:
“templates_pkey” PRIMARY KEY, btree (tmpl_id)

Table “general.whats_new”

| Column | Type | Modifiers |
|---|---|---|
| wn_id | integer | not null default |
| | | nextval(‘general.whats_new_wn_id_seq’::regclass) |
| wn_text | text | |
| start_date | timestamp | not null |
| | without time | |
| | zone | |
| date_created | timestamp | not null default now( ) |
| | without time zone | |
| title | text | |

Indexes:
“whats_new_pkey” PRIMARY KEY, btree (wn_id)

Table “information_schema.sql_features”

| | | |
|---|---|---|
| Column | Type | Modifiers |

| | |
|---|---|
| feature_id | information_schema.character_data |
| feature_name | information_schema.character_data |
| sub_feature_id | information_schema.character_data |
| sub_feature_name | information_schema.character_data |
| is_supported | information_schema.character_data |
| is_verified_by | information_schema.character_data |
| comments | information_schema.character_data |

Table “information_schema.sql_implementation_info”

| | | |
|---|---|---|
| Column | Type | Modifiers |

| | |
|---|---|
| implementation_info_id | information_schema.character_data |
| implementation_info_name | information_schema.character_data |
| integer_value | information_schema.cardinal_number |
| character_value | information_schema.character_data |
| comments | information_schema.character_data |

Table “information_schema.sql_languages”

| | | |
|---|---|---|
| Column | Type | Modifiers |

| | |
|---|---|
| sql_language_source | information_schema.character_data |
| sql_language_year | information_schema.character_data |
| sql_language_conformance | information_schema.character_data |
| sql_language_integrity | information_schema.character_data |
| sql_language_implementation | information_schema.character_data |
| sql_language_binding_style | information_schema.character_data |
| sql_language_programming_language | information_schema.character_data |

Table “information_schema.sql_packages”

| Column | Type | Modifiers |
|---|---|---|
| feature_id | information_schema.character_data | |
| feature_name | information_schema.character_data | |
| is_supported | information_schema.character_data | |
| is_verified_by | information_schema.character_data | |
| comments | information_schema.character_data | |

Table “information_schema.sql_parts”

| Column | Type | Modifiers |
|---|---|---|
| feature_id | information_schema.character_data | |
| feature_name | information_schema.character_data | |
| is_supported | information_schema.character_data | |
| is_verified_by | information_schema.character_data | |
| comments | information_schema.character_data | |

Table “information_schema.sql_sizing”

| Column | Type | Modifiers |
|---|---|---|
| sizing_id | information_schema.cardinal_number | |
| sizing_name | information_schema.character_data | |
| supported_value | information_schema.cardinal_number | |
| comments | information_schema.character_data | |

Table “information_schema.sql_sizing_profiles”

| Column | Type | Modifiers |
|---|---|---|
| sizing_id | information_schema.cardinal_number | |
| sizing_name | information_schema.character_data | |
| profile_id | information_schema.character_data | |
| required_value | information_schema.cardinal_number | |
| comments | information_schema.character_data | |

Table “inspiration.images”

| Column | Type | Modifiers |
|---|---|---|
| image_id | integer | not null default |
| | | nextval(‘inspiration.- |
| | | images_image_id_seq’::reg |
| | | class) |
| filename | character | not null |
| | varying(250) | |
| ssi_min | smallint | not null default 0 |
| ssi_max | smallint | not null default 5 |
| date_created | timestamp | not null default now( ) |
| | without | |
| | time zone | |
| inspirational_season_id | smallint | |
| reviewed | boolean | not null default false |
| date_start | timestamp | |
| | without | |
| | time zone | |
| date_end | timestamp | |
| | without | |
| | time zone | |

Indexes:
“images_pkey” PRIMARY KEY, btree (image_id)
“images_filename_key” UNIQUE, btree (filename)

Table “inspiration.quotes”

| Column | Type | Modifiers |
|---|---|---|
| quote_id | integer | not null default |
| | | nextval(‘inspiration.- |
| | | quotes_quote_id_seq’::regclass) |
| quote | text | not null |
| season_id | integer | |
| source | character | |
| | varying(100) | |
| date_created | timestamp without | not null default now( ) |
| | time zone | |

Indexes:
“quote_id_pk” PRIMARY KEY, btree (quote_id)

Table “inspiration.seasons”

| Column | Type | Modifiers |
|---|---|---|
| inspirational_season_id | integer | not null default |
| | | nextval(‘inspiration.seasons_inspirational_season_id_seq’ |
| | | ::regclass) |
| season | character varying | not null |

Indexes:
“seasons_pkey” PRIMARY KEY, btree (inspirational_season_id)

Table “language.translations”

| Column | Type | Modifiers |
|---|---|---|
| translation_id | integer | not null default |
| | | nextval(‘language.- |
| | | translations_translation_id_seq’::reg |
| | | class) |
| key | character | not null |
| | varying(50) | |
| translation | text | not null |
| language_id | smallint | not null |
| date_created | timestamp | not null default now( ) |
| | without | |
| | time zone | |

Indexes:
“translations_pkey” PRIMARY KEY, btree (translation_id)

Table “media.average_ssi_rating”

| Column | Type | Modifiers |
|---|---|---|
| average_ssi_rating_id | integer | not null default |
| | | nextval(‘media.average_ssi_rating_average_ssi_rating_id_seq’ |
| | | ::regclass) |
| media_id | bigint | not null |
| ssi_id | smallint | not null |
| average_rating | real | not null |
| date_created | timestamp without | not null default now( ) |
| | time zone | |
| rating_count | bigint | |

Indexes:
“average_ssi_rating_pkey” PRIMARY KEY, btree (average_ssi_rating_id)
Foreign-key constraints:
“average_ssi_rating_media_id_fkey” FOREIGN KEY (media_id) REFERENCES media.media(media_id) ON DELETE CASCADE

Table “media.comment_ratings”

| Column | Type | Modifiers |
|---|---|---|
| comment_rating_id | integer | not null default |
| | | nextval(‘media.-comment_ratings_comment_rating_id_seq’ |
| | | ::regclass) |
| media_id | integer | |
| user_id | integer | |
| date_created | timestamp without | not null default now( ) |
| | time zone | |
| comment_id | bigint | |
| rating | text | |

Indexes:
“comment_ratings_pkey” PRIMARY KEY, btree (comment_rating_id)
Foreign-key constraints:
“comment_ratings_media_id_fkey” FOREIGN KEY (media_id) REFERENCES media.media(media_id) ON DELETE CASCADE
“comment_ratings_user_id_fkey” FOREIGN KEY (user_id) REFERENCES usr.users(user_id) ON DELETE CASCADE

Table “media.comments”

| Column | Type | Modifiers |
|---|---|---|
| comment_id | integer | not null default |
| | | nextval(‘media.comments_comment_id_seq’::regclass) |
| media_id | bigint | not null |
| user_id | bigint | not null |
| comment | text | not null |
| score | smallint | not null default 0 |
| parent_comment_id | bigint | |
| date_created | timestamp | not null default now( ) |
| | without | |
| | time zone | |
| deleted | boolean | |

Indexes:
“comments_pkey” PRIMARY KEY, btree (comment_id)
Foreign-key constraints:
“comments_media_id_fkey” FOREIGN KEY (media_id) REFERENCES media.media(media_id) ON DELETE CASCADE
“comments_user_id_fkey” FOREIGN KEY (user_id) REFERENCES usr.users(user_id) ON DELETE CASCADE
Triggers:
update_comment_count AFTER INSERT OR UPDATE ON media.comments FOR EACH ROW EXECUTE PROCEDURE media.stats_comment_count( )

Table “media.desserts”

| Column | Type | Modifiers |
|---|---|---|
| dessert_id | integer | not null default |
| | | nextval(‘media.- |
| | | desserts_dessert_id_seq’::regclass) |
| title | character | |
| | varying(100) | |
| description | text | |
| link_url | character | not null |
| | varying(250) | |
| image_url | text | not null |
| date_created | time with time zone | not null default now( ) |
| cost | double precision | not null default 0.99 |

Indexes:
“dessert_id_pk” PRIMARY KEY, btree (dessert_id)

Table “media.downloads”

| Column | Type | Modifiers |
|---|---|---|
| download_id | integer | not null default |
| | | nextval(‘media.- |
| | | downloads_download_id_seq’::regclass) |
| media_id | bigint | not null |
| user_id | integer | not null |
| time_started | timestamp | not null default now( ) |
| | without | |
| | time zone | |
| time_completed | timestamp | |
| | without | |
| | time zone | |
| downloads | integer | not null default 5 |

Indexes:
“downloads_pkey” PRIMARY KEY, btree (download_id)
Foreign-key constraints:
“downloads_media_id_fkey” FOREIGN KEY (media_id) REFERENCES media.media(media_id) ON DELETE CASCADE
“downloads_user_id_fkey” FOREIGN KEY (user_id) REFERENCES usr.users(user_id) ON DELETE CASCADE

Table “media.featured”

| Column | Type | Modifiers |
|---|---|---|
| featured_id | integer | not null default |
| | | nextval(‘media.- |
| | | featured_featured_id_seq’::regclass) |
| media_id | bigint | not null |
| featured_type_id | smallint | not null |
| begin_date | date | default now( ) |
| end_date | date | |
| date_created | tmestamp | not null default now( ) |
| | without time | |
| | zone | |
| comment | text | |

Indexes:
“featured_pkey” PRIMARY KEY, btree (featured_id)
Foreign-key constraints:
“featured_media_id_fkey” FOREIGN KEY (media_id) REFERENCES media.media(media_id) ON DELETE CASCADE

Table “media.files”

| Column | Type | Modifiers |
|---|---|---|
| file_id | integer | not null default |
| | | nextval(‘media.- |
| files_file_id_seq’::regclass) | | |
| media_id | bigint | not null |
| filename | character varying | |
| size | bigint | not null |
| file_store_id | smallint | not null |
| date_created | timestamp without | not null default |
| | time zone | now( ) |
| to_delete | boolean | default false |
| date_deleted | timestamp without | |
| | time zone | |
| original_filename | character | |
| | varying(100) | |

Indexes:
“files_pkey” PRIMARY KEY, btree (file_id)
“meda_id_index” btree (media_id)
Foreign-key constraints:
“files_media_id_fkey” FOREIGN KEY (media_id) REFERENCES media.media(media_id) ON DELETE CASCADE

Table “media.media”

| Column | Type | Modifiers |
|---|---|---|
| media_id | bigint | not null default |
| | | nextval(‘media.media_media_id_seq’::regclass) |
| media_key | character varying(25) | not null |
| media_type_id | smallint | |
| user_id | bigint | not null |
| title | text | not null default ‘Untitled’::character varying |
| description | text | |
| explicit | boolean | not null default false |
| active | boolean | not null default false |
| language_id | smallint | not null default 1 |
| date_recorded | date | |
| catholic_genre_id | smallint | |
| price | double precision | |
| artist | character varying(100) | |
| duration | integer | |
| target_age_id | smallint | |
| allow_comments | boolean | not null default true |
| allow_ratings | boolean | not null default true |
| start_date | date | not null default now( ) |
| end_date | date | |
| author_user_id | bigint | |
| snack_file_id | integer | |
| meal_file_id | integer | |
| date_created | timestamp without time zone | not null default now( ) |
| contract_id | smallint | |
| locking_time | timestamp without time zone | |
| reviewed | boolean | default false |
| sharing_option_id | integer | |
| deleted | boolean | not null default false |
| media_status_id | integer | |
| thumbnail_id | integer | |
| last_view | timestamp without time zone | default ‘2000-01-01 00:00:00’::timestamp |
| | | without time zone |
| num_streams | integer | default 0 |
| num_comments | integer | |
| reindex | boolean | default false |
| index_level | integer | |
| date_modified | timestamp without time zone | |
| average_rating | integer | default 0 |

Indexes:
“media_id_pkey” PRIMARY KEY, btree (media_id)
“media_key_unique” UNIQUE, btree (media_key)
“user_id_index” btree (user_id)
Foreign-key constraints:
“media_user_id_fkey” FOREIGN KEY (user_id) REFERENCES usr.users(user_id) ON DELETE CASCADE
Triggers:
tg_update_media_status BEFORE UPDATE ON media.media FOR EACH ROW EXECUTE PROCEDURE media.update_media_status( ) update_index_level BEFORE INSERT OR UPDATE ON media.media FOR EACH ROW EXECUTE PROCEDURE media.index_level_update( )

Table “media.media_winner”

| Column | Type | Modifiers |
|---|---|---|
| media_winner_id | integer | not null default |
| | | nextval(‘media.media_media_winner_id_seq’::regclass) |
| media_id | integer | not null |
| win_date | timestamp | not null |
| | without | |
| | time zone | |
| type | character | not null default 1 |
| | varying | |
| module_id | integer | |
| active | boolean | not null default true |

Indexes:
“media_winner_pkey” PRIMARY KEY, btree (media_id, win_date, type)
“media_winner_media_winner_id_key” UNIQUE, btree (media_winner_id)

Table “media.processing_queue”

| Column | Type | Modifiers |
|---|---|---|
| processing_queue_id | bigint | not null default |
| | | nextval(‘media.- |
| | | processing_queue_processing_queue_id_seq’::regclass) |
| file_id | bigint | |
| convert_to | character varying(25) | |
| destination_file_store_id | smallint | |
| conversion_time | integer | |
| output_file_id | integer | |
| date_created | timestamp without time zone | not null default now( ) |
| attempts | integer | default 0 |
| date_start | timestamp without time zone | |
| date_end | timestamp without time zone | |
| successful | boolean | |

Indexes:
“processing_queue_pkey” PRIMARY KEY, btree (processing_queue_id)

Table “media.publisher_contracts”

| Column | Type | Modifiers |
|---|---|---|
| contract_id | integer | not null default |
| | | nextval(‘media.publisher_contracts_contract_id_seq’::regclass) |
| mcv_split | double | |
| | precision | |
| pub_split | double | |
| | precision | |
| date_created | timestamp | default now( ) |
| | without time | |
| | zone | |

Table “media.purchased”

| Column | Type | Modifiers |
|---|---|---|
| purchased_id | integer | not null default |
| | | nextval(‘media.- |
| | | purchased_purchased_id_seq’::regclass) |
| user_id | bigint | not null |
| media_id | bigint | not null |
| expiration_date | timestamp | |
| | with time | |
| | zone | |
| date_created | timestamp | not null default now( ) |
| | without | |
| | time zone | |
| downloads | integer | |

Indexes:
“purchased_pkey” PRIMARY KEY, btree (purchased_id)
Foreign-key constraints:
“purchased_media_id_fkey” FOREIGN KEY (media_id) REFERENCES media.media(media_id) ON DELETE CASCADE
“purchased_user_id_fkey” FOREIGN KEY (user_id) REFERENCES usr.users(user_id) ON DELETE CASCADE

Table “media.rating”

| Column | Type | Modifiers |
|---|---|---|
| media_rating_id | integer | not null default |
| | | nextval(‘media.- |
| | | rating_media_rating_id_seq’::regclass) |
| media_id | bigint | not null |
| rating | smallint | not null |
| user_id | integer | not null |
| ssi_id | smallint | |
| date_created | timestamp | not null default now( ) |
| | without | |
| | time zone | |

Indexes:
“rating_pkey” PRIMARY KEY, btree (media_rating_id)
Foreign-key constraints:
“rating_media_id_fkey” FOREIGN KEY (media_id) REFERENCES media.media(media_id) ON DELETE CASCADE
“rating_user_id_fkey” FOREIGN KEY (user_id) REFERENCES usr.users(user_id) ON DELETE CASCADE

Table “media.related_media”

| Column | Type | Modifiers |
|---|---|---|
| related_id | integer | not null default |
| | | nextval(‘media.related_media_related_id_seq’::regclass) |
| media_id | integer | not null |
| related_media_id | integer | not null |
| score | integer | |
| date_created | timestamp | default now( ) |
| | without time | |
| | zone | |

Indexes:
“related_media_pkey” PRIMARY KEY, btree (related_id)
“related_media_index” btree (related_id, media_id)

Table “media.reported”

| Column | Type | Modifiers |
|---|---|---|
| reported_id | integer | not null default |
| | | nextval(‘media.reported_reported_id_seq’::regclass) |
| media_id | integer | not null default |
| | | nextval(‘media.reported_media_id_seq’::regclass) |
| user_id | integer | not null |
| media_reported_reason_id | smallint | not null |
| reviewer | character | |
| | varying(50) | |
| reviewer_comments | text | |
| date_created | timestamp | not null default now( ) |
| | without time | |
| | zone | |
| date_modified | timestamp | |
| | without time | |
| | zone | |
| flag_comment | text | |

Indexes:
“reported_pkey” PRIMARY KEY, btree (reported_id)
Foreign-key constraints:
“reported_media_id_fkey” FOREIGN KEY (media_id) REFERENCES media.media(media_id) ON DELETE CASCADE
“reported_user_id_fkey” FOREIGN KEY (user_id) REFERENCES usr.users(user_id) ON DELETE CASCADE

Table “media.scribd_data”

| Column | Type | Modifiers |
|---|---|---|
| scribd_data_id | integer | not null default |
| | | nextval(‘media.scribd_data_scribd_data_id_seq’::regclass) |
| file_id | integer | |
| doc_id | integer | |
| access_key | text | |
| secret_password | text | |
| date_created | timestamp | not null default now( ) |
| | without | |
| | time zone | |

Indexes:
“scribd_data_pkey” PRIMARY KEY, btree (scribd_data_id)

Table “media.sets”

| Column | Type | Modifiers |
|---|---|---|
| set_id | integer | not null default |
| | | nextval(‘media.- |
| | | sets_set_id_seq’::regclass) |
| title | character varying(200) | not null |
| description | text | |
| date_created | timestamp without time | not null default now( ) |
| | zone | |

Indexes:
“sets_pkey” PRIMARY KEY, btree (set_id)

Table “media.snacks”

| Column | Type | Modifiers |
|---|---|---|
| snack_id | integer | not null default |
| | | nextval(‘media.- |
| | | snacks_snack_id_seq’::regclass) |
| title | character varying(25) | not null |
| publisher_id | integer | not null |

Indexes:
“snack_id_pk” PRIMARY KEY, btree (snack_id)

Table “media.statistics”

| Column | Type | Modifiers |
|---|---|---|
| statistic_id | integer | not null default |
| | | nextval(‘media.- |
| | | statistics_statistic_id_seq’::regclass) |
| media_id | bigint | not null |
| num_downloads | bigint | not null default 0 |
| num_streams | bigint | not null default 0 |
| average_rating | real | not null default 0 |
| date_created | timestamp | not null default now( ) |
| | without | |
| | time zone | |
| rating_count | integer | default 0 |
| date_modified | timestamp | |
| | without | |
| | time zone | |
| comment_count | integer | default 0 |
| updated | boolean | default true |

Indexes:
“statistics_pkey” PRIMARY KEY, btree (statistic_id)
Triggers:
update_stats BEFORE INSERT OR UPDATE ON media.statistics FOR EACH ROW EXECUTE PROCEDURE media.stats_update( )

Table “media.status_log”

| Column | Type | Modifiers |
|---|---|---|
| status_log_id | integer | not null default |
| | | nextval(‘media.- |
| | | status_log_status_log_id_seq’::regclass) |
| media_id | integer | not null |
| old_status_id | integer | |
| new_status_id | integer | not null |
| date_created | timestamp | not null default now( ) |
| | without | |
| | time | |
| | zone | |

Indexes:
“status_log_pkey” PRIMARY KEY, btree (status_log_id)
Foreign-key constraints:
“status_log_media_id_fkey” FOREIGN KEY (media_id) REFERENCES media.media(media_id) ON DELETE CASCADE

Table “media.tags”

| Column | Type | Modifiers |
|---|---|---|
| tag_id | integer | not null default |
| | | nextval(‘media.tags_tag_id_seq’::regclass) |
| media_id | bigint | not null |
| tag | character | not null |
| varying(50) | | |
| date_created | timestamp | not null default now( ) |
| | without time | |
| | zone | |
| category | boolean | not null default false |
| tag_type_id | integer | not null default 1 |

Indexes:
“tags_pkey” PRIMARY KEY, btree (tag_id)
“media_id_index” btree (media_id)
Foreign-key constraints:
“tags_media_id_fkey” FOREIGN KEY (media_id) REFERENCES media.media(media_id) ON DELETE CASCADE

Table “media.upload_log”

| Column | Type | Modifiers |
|---|---|---|
| upload_log_id | integer | not null default |
| | | nextval(‘media.upload_log_upload_log_id_seq’::regclass) |
| media_key | character | not null |
| | varying | |
| user_id | bigint | |
| date_created | timestamp | not null default now( ) |
| | without time | |
| | zone | |
| date_upload_start | timestamp | |
| | without time | |
| | zone | |
| date_upload_end | timestamp | |
| | without time | |
| | zone | |
| file_id | integer | |

Indexes:
“upload_log_pkey” PRIMARY KEY, btree (upload_log_id)
“upload_log_media_key_key” UNIQUE, btree (media_key)
Foreign-key constraints:
“upload_log_user_id_fkey” FOREIGN KEY (user_id) REFERENCES usr.users(user_id) ON DELETE CASCADE

Table “media.user_favorites”

| Column | Type | Modifiers |
|---|---|---|
| user_favorite_id | integer | not null default nextval |
| | | (‘media.user_favorites_user_favorite_id_seq’::regclass) |
| user_id | bigint | not null |
| media_id | bigint | not null |
| date_created | timestamp | not null default now( ) |
| | without | |
| | time zone | |
| last_accessed | date | |

Indexes:
“user_favorites_pkey” PRIMARY KEY, btree (user_favorite_id)
Foreign-key constraints:
“user_favorites_media_id_fkey” FOREIGN KEY (media_id) REFERENCES media.media(media_id) ON DELETE CASCADE
“user_favorites_user_id_fkey” FOREIGN KEY (user_id) REFERENCES usr.users(user_id) ON DELETE CASCADE

Table “media.views”

| Column | Type | Modifiers |
|---|---|---|
| view_id | integer | not null default nextval |
| | | (‘media.views_view_id_seq’::regclass) |
| media_id | bigint | not null |
| user_id | bigint | |
| date_created | timestamp | not null default now( ) |
| | without | |
| | time zone | |
| ssi_id | integer | |
| ip_address | inet | |
| uri | character | |
| | varying(200) | |
| referer | text | |
| user_agent | text | |
| feature | character | |
| | varying(30) | |

Foreign-key constraints
“views_media_id_fkey” FOREIGN KEY (media_id) REFERENCES media.media(media_id) ON DELETE CASCADE
“views_user_id_fkey” FOREIGN KEY (user_id) REFERENCES usr.users(user_id) ON DELETE CASCADE

Table “module.blog_to_module”

| Column | Type | Modifiers |
|---|---|---|
| blog_to_module_id | integer | not null default nextval |
| | | (‘module.blog_to_module_blog_to_module_id_seq’::regclass) |
| module_id | integer | not null |
| blog_id | integer | not null |
| date_created | timestamp | not null default now( ) |
| | without | |
| | time zone | |

Indexes:
“blog_to_module_pkey” PRIMARY KEY, btree (blog_to_module_id)
Foreign-key constraints:
“blog_to_module_module_id_fkey” FOREIGN KEY (module_id) REFERENCES module.modules(module_id) ON DELETE CASCADE

Table “module.community_to_module”

| Column | Type | Modifiers |
|---|---|---|
| community_to_module_id | integer | not null default nextval |
| | | (‘module.community_to_module_community_to_module_id_seq’::regclass) |
| module_id | integer | not null |
| community_id | integer | not null |
| date_created | timestamp | not null default now( ) |
| | without | |
| | time zone | |

Indexes:
“community_to_module_pkey” PRIMARY KEY, btree (community_to_module_id)
Foreign-key constraints:
“community_to_module_community_id_fkey” FOREIGN KEY (community_id) REFERENCES community.communities(community_id) ON DELETE CASCADE
“community_to_module_module_id_fkey” FOREIGN KEY (module_id) REFERENCES module.modules(module_id) ON DELETE CASCADE

Table “module.discussion_to_module”

| Column | Type | Modifiers |
|---|---|---|
| discussion_to_module_id | integer | not null default nextval |
| | | (‘module.discussion_to_module_discussion_to_module_id_seq’::regclass) |
| module_id | integer | not null |
| discussion_id | integer | not null |
| date_created | timestamp | not null default now( ) |
| | without time | |
| | zone | |

Indexes:
“discussion_to_module_pkey” PRIMARY KEY, btree (discussion_to_module_id)
Foreign-key constraints:
“discussion_to_module_module_id_fkey” FOREIGN KEY (module_id) REFERENCES module.modules(module_id) ON DELETE CASCADE

Table “module.feed_to_module”

| Column | Type | Modifiers |
|---|---|---|
| feed_to_module_id | integer | not null default nextval |
| | | (‘module.feed_to_module_feed_to_module_id_seq’::regclass) |
| module_id | integer | not null |
| feed_id | integer | not null |
| date_created | timestamp without time zone | not null default now( ) |

Indexes:
“feed_to_module_pkey” PRIMARY KEY, btree (feed_to_module_id)
Foreign-key constraints:
“feed_to_module_feed_id_fkey” FOREIGN KEY (feed_id) REFERENCES reader.feeds(feed_id) ON DELETE CASCADE
“feed_to_module_module_id_fkey” FOREIGN KEY (module_id) REFERENCES module.modules(module_id) ON DELETE CASCADE

Table “module.link_to_module”

| Column | Type | Modifiers |
|---|---|---|
| link_to_module_id | integer | not null default nextval |
| | | (‘module.link_to_module_link_to_module_id_seq’::regclass) |
| module_id | integer | not null |
| url | character | not null |
| | varying(200) | |
| date_created | timestamp | not null default now( ) |
| | without time | |
| | zone | |
| title | character | |
| | varying(255) | |
| description | text | |
| active | boolean | default false |
| created_by | integer | |

Indexes:
“link_to_module_pkey” PRIMARY KEY, btree (link_to_module_id)
Foreign-key constraints:
“link_to_module_module_id_fkey” FOREIGN KEY (module_id) REFERENCES module.modules(module_id) ON DELETE CASCADE

Table “module.media_to_module”

| Column | Type | Modifiers |
|---|---|---|
| media_to_module_id | integer | not null default nextval |
| | | (‘module.media_to_module_media_to_module_id_seq’::regclass) |
| module_id | integer | not null |
| media_id | integer | not null |
| date_created | timestamp | not null default now( ) |
| | without | |
| | time zone | |
| featured | boolean | not null default false |
| owned | boolean | default false |

Indexes:
“media_to_module_pkey” PRIMARY KEY, btree (media_to_module_id)
Foreign-key constraints:
“media_to_module_module_id_fkey” FOREIGN KEY (module_id) REFERENCES module.modules(module_id) ON DELETE CASCADE

Table “module.module_color”

| Column | Type | Modifiers |
|---|---|---|
| module_id | integer | not null |
| header_color | character varying(50) | |
| bg_header_color | character varying(50) | not null |
| content_color | character varying(50) | |
| bg_content_color | character varying(50) | not null |
| image_bg_content_color | character varying(255) | not null |
| image_pos | character varying(255) | |

Indexes:
“module_color_pkey” PRIMARY KEY, btree (module_id)
Foreign-key constraints:
“module_color_module_id_fkey” FOREIGN KEY (module_id) REFERENCES module.modules(module_id) ON DELETE CASCADE

Table “module.module_to_contest”

| Column | Type | Modifiers |
|---|---|---|
| module_id | integer | not null |
| start_date | date | not null default now( ) |
| end_date | date | not null default now( ) |
| start_vote | date | not null default now( ) |
| end_vote | date | not null default now( ) |
| type | character varying | default 1 |

Indexes:
“module_to_contest_pkey” PRIMARY KEY, btree (module_id)

Table “module.modules”

| Column | Type | Modifiers |
|---|---|---|
| module_id | integer | not null default nextval |
| | | (‘module.modules_module_id_seq’::regclass) |
| module_type_id | integer | not null |
| title | character | not null |
| | varying(75) | |
| active | boolean | not null default true |
| owner_user_id | integer | not null |
| owner_community_id | integer | |
| sharing_option_id | integer | |
| date_created | timestamp | not null default now( ) |
| | without time | |
| | zone | |
| description | text | |
| num_row | integer | not null default 0 |
| applied_user_permission | boolean | default true |
| sort_by | text | |

Indexes:
“modules_pkey” PRIMARY KEY, btree (module_id)

Table “object.comment_ratings”

| Column | Type | Modifiers |
|---|---|---|
| comment_rating_id | integer | not null default nextval |
| | | (‘object.comment_ratings_comment_rating_id_seq’::regclass) |
| comment_id | integer | not null |
| user_id | integer | not null |
| rating | integer | not null default 0 |
| date_created | timestamp | not null default now( ) |
| | without | |
| | time zone | |

Indexes
“comment_ratings_pkey” PRIMARY KEY, btree (comment_rating_id)
Foreign-key constraints:
“comment_ratings_comment_id_fkey” FOREIGN KEY (comment_id) REFERENCES object.comments(comment_id)
“comment_ratings_user_id_fkey” FOREIGN KEY (user_id) REFERENCES usr.users(user_id)

Table “object.comments”

| Column | Type | Modifiers |
|---|---|---|
| comment_id | integer | not null default nextval |
| | | (‘object.comments_comment_id_seq’::regclass) |
| object_type_id | integer | not null |
| object_id | integer | not null |
| parent_id | integer | default 0 |
| user_id | integer | not null |
| comment | text | |
| rating | integer | |
| status_id | integer | default 2 |
| date_created | timestamp | not null default now( ) |
| | without time zone | |

Indexes:
“comments_pkey” PRIMARY KEY, btree (comment_id)
Foreign-key constraints:
“comments_object_type_id_fkey” FOREIGN KEY (object_type_id) REFERENCES reference.object_types(object_type_id)
“comments_status_id_fkey” FOREIGN KEY (status_id) REFERENCES reference.statuses(status_id)
“comments_user_id_fkey” FOREIGN KEY (user_id) REFERENCES usr.users(user_id)

Table “object.statistics”

| Column | Type | Modifiers |
|---|---|---|
| statistic_id | integer | not null default nextval |
| | | (‘object.statistics_statistic_id_seq’::regclass) |
| object_type_id | integer | not null |
| object_id | integer | not null |
| view_count | integer | not null default 0 |
| comment_count | integer | not null default 0 |
| average_rating | integer | not null default 0 |
| date_created | timestamp without | not null default now( ) |
| | time zone | |

Indexes:
“statistics_pkey” PRIMARY KEY, btree (statistic_id)
Foreign-key constraints:
“statistics_object_type_id_fkey” FOREIGN KEY (object_type_id) REFERENCES reference.object_types(object_type_id)

Table “object.tags”

| Column | Type | Modifiers |
|---|---|---|
| tag_id | integer | not null default nextval |
| | | (‘object.tags_tag_id_seq’::regclass) |
| object_type_id | integer | not null |
| object_id | integer | not null |
| tag | character varying(50) | not null |
| category | boolean | not null |
| date_created | timestamp without time zone | not null default now( ) |

Indexes:
“tags_pkey” PRIMARY KEY, btree (tag_id)
Foreign-key constraints:
“tags_object_type_id_fkey” FOREIGN KEY (object_type_id) REFERENCES reference.object_types(object_type_id)

Table “object.views”

| Column | Type | Modifiers |
|---|---|---|
| view_id | integer | not null default nextval(‘object.- |
| | | views_view_id_seq’::regclass) |
| object_type_id | integer | not null |
| object_id | integer | not null |
| user_id | integer | |
| ssi_id | integer | |
| ip_address | inet | not null |
| url | character | |
| | varying(200) | |
| referer | text | |
| user_agent | text | |
| date_created | timestamp without | not null default now( ) |
| | time zone | |

Indexes:
“views_pkey” PRIMARY KEY, btree (view_id)
Foreign-key constraints:
“views_object_type_id_fkey” FOREIGN KEY (object_type_id) REFERENCES reference.object_types(object_type_id)

Table “pg_catalog.pg_aggregate”

| Column | Type | Modifiers |
|---|---|---|
| aggfnoid | regproc | not null |
| aggtransfn | regproc | not null |
| aggfinalfn | regproc | not null |
| aggsortop | oid | not null |
| aggtranstype | oid | not null |
| agginitval | text | |

Indexes:
“pg_aggregate_fnoid_index” UNIQUE, btree (aggfnoid)

Table “pg_catalog.pg_am”

| Column | Type | Modifiers |
|---|---|---|
| amname | name | not null |
| amstrategies | smallint | not null |
| amsupport | smallint | not null |
| amcanorder | boolean | not null |
| amcanunique | boolean | not null |
| amcanmulticol | boolean | not null |
| amoptionalkey | boolean | not null |
| amindexnulls | boolean | not null |
| amsearchnulls | boolean | not null |
| amstorage | boolean | not null |
| amclusterable | boolean | not null |
| aminsert | regproc | not null |
| ambeginscan | regproc | not null |
| amgettuple | regproc | not null |
| amgetmulti | regproc | not null |
| amrescan | regproc | not null |
| amendscan | regproc | not null |
| ammarkpos | regproc | not null |
| amrestrpos | regproc | not null |
| ambuild | regproc | not null |
| ambulkdelete | regproc | not null |
| amvacuumcleanup | regproc | not null |
| amcostestimate | regproc | not null |
| amoptions | regproc | not null |

Indexes:
“pg_am_name_index” UNIQUE, btree (amname)
“pg_am_oid_index” UNIQUE, btree (oid)

Table “pg_catalog.pg_amop”

| Column | Type | Modifiers |
|---|---|---|
| amopfamily | oid | not null |
| amoplefttype | oid | not null |
| amoprighttype | oid | not null |
| amopstrategy | smallint | not null |
| amopreqcheck | boolean | not null |
| amopopr | oid | not null |
| amopmethod | oid | not null |

Indexes:
“pg_amop_fam_strat_index” UNIQUE, btree (amopfamily, amoplefttype, amoprighttype, amopstrategy)
“pg_amop_oid_index” UNIQUE, btree (oid)
“pg_amop_opr_fam_index” UNIQUE, btree (amopopr, amopfamily)

Table “pg_catalog.pg_amproc”

| Column | Type | Modifiers |
|---|---|---|
| amprocfamily | oid | not null |
| amproclefttype | oid | not null |
| amprocrighttype | oid | not null |
| amprocnum | smallint | not null |
| amproc | regproc | not null |

Indexes:
“pg_amproc_fam_proc_index” UNIQUE, btree (amprocfamily, amproclefttype, amprocrighttype, amprocnum)
“pg_amproc_oid_index” UNIQUE, btree (oid)

Table “pg_catalog.pg_attrdef”

| Column | Type | Modifiers |
|---|---|---|
| adrelid | oid | not null |
| adnum | smallint | not null |
| adbin | text | |
| adsrc | text | |

Indexes:
“pg_attrdef_adrelid_adnum_index” UNIQUE, btree (adrelid, adnum)
“pg_attrdef_oid_index” UNIQUE, btree (oid)

Table “pg_catalog.pg_attribute”

| Column | Type | Modifiers |
|---|---|---|
| attrelid | oid | not null |
| attname | name | not null |
| atttypid | oid | not null |
| attstattarget | integer | not null |
| attlen | smallint | not null |
| attnum | smallint | not null |
| attndims | integer | not null |
| attcacheoff | integer | not null |
| atttypmod | integer | not null |
| attbyval | boolean | not null |
| attstorage | “char” | not null |
| attalign | “char” | not null |
| attnotnull | boolean | not null |
| atthasdef | boolean | not null |
| attisdropped | boolean | not null |
| attislocal | boolean | not null |
| attinhcount | integer | not null |

Indexes:
“pg_attribute_relid_attnam_index” UNIQUE, btree (attrelid, attname)
“pg_attribute_relid_attnum_index” UNIQUE, btree (attrelid, attnum)

Table “pg_catalog.pg_auth_members”

| Column | Type | Modifiers |
|---|---|---|
| roleid | oid | not null |
| member | oid | not null |
| grantor | oid | not null |
| admin_option | boolean | not null |

Indexes:
“pg_auth_members_member_role_index” UNIQUE, btree (member, roleid), tablespace “pg_global”
“pg_auth_members_role_member_index” UNIQUE, btree (roleid, member), tablespace “pg_global”
Triggers:
pg_sync_pg_auth_members AFTER INSERT OR DELETE OR UPDATE ON pg_auth_members FOR EACH STATEMENT EXECUTE PROCEDURE flatfile_update_trigger( )
Tablespace:
“pg_global”

Table “pg_catalog.pg_authid”

| Column | Type | Modifiers |
|---|---|---|
| rolname | name | not null |
| rolsuper | boolean | not null |
| rolinherit | boolean | not null |
| rolcreaterole | boolean | not null |
| rolcreatedb | boolean | not null |
| rolcatupdate | boolean | not null |
| rolcanlogin | boolean | not null |
| rolconnlimit | integer | not null |
| rolpassword | text | |
| rolvaliduntil | timestamp with time zone | |
| rolconfig | text[ ] | |

Indexes:
“pg_authid_oid_index” UNIQUE, btree (oid), tablespace “pg_global”
“pg_authid_rolname_index” UNIQUE, btree (rolname), tablespace “pg_global”
Triggers:
pg_sync_pg_authid AFTER INSERT OR DELETE OR UPDATE ON pg_authid FOR EACH STATEMENT EXECUTE PROCEDURE flatfile_update_trigger( )
Tablespace:
“pg_global”

Table “pg_catalog.pg_autovacuum”

| Column | Type | Modifiers |
|---|---|---|
| vacrelid | oid | not null |
| enabled | boolean | not null |
| vac_base_thresh | integer | not null |
| vac_scale_factor | real | not null |
| anl_base_thresh | integer | not null |
| anl_scale_factor | real | not null |
| vac_cost_delay | integer | not null |
| vac_cost_limit | integer | not null |
| freeze_min_age | integer | not null |
| freeze_max_age | integer | not null |

Indexes:
“pg_autovacuum_vacrelid_index” UNIQUE, btree (vacrelid)

Table “pg_catalog.pg_cast”

| Column | Type | Modifiers |
|---|---|---|
| castsource | oid | not null |
| casttarget | oid | not null |
| castfunc | oid | not null |
| castcontext | “char” | not null |

Indexes:
“pg_cast_oid_index” UNIQUE, btree (oid)
“pg_cast_source_target_index” UNIQUE, btree (castsource, casttarget)

Table “pg_catalog.pg_class”

| Column | Type | Modifiers |
|---|---|---|
| relname | name | not null |
| relnamespace | oid | not null |
| reltype | oid | not null |
| relowner | oid | not null |
| relam | oid | not null |
| relfilenode | oid | not null |
| reltablespace | oid | not null |
| relpages | integer | not null |
| reltuples | real | not null |
| reltoastrelid | oid | not null |
| reltoastidxid | oid | not null |
| relhasindex | boolean | not null |
| relisshared | boolean | not null |
| relkind | “char” | not null |
| relnatts | smallint | not null |
| relchecks | smallint | not null |
| reltriggers | smallint | not null |
| relukeys | smallint | not null |
| relfkeys | smallint | not null |
| relrefs | smallint | not null |
| relhasoids | boolean | not null |
| relhaspkey | boolean | not null |
| relhasrules | boolean | not null |
| relhassubclass | boolean | not null |
| relfrozenxid | xid | not null |
| relacl | aclitem[ ] | |
| reloptions | text[ ] | |

Indexes:
“pg_class_oid_index” UNIQUE, btree (oid)
“pg_class_relname_nsp_index” UNIQUE, btree (relname, relnamespace)

Table “pg_catalog.pg_constraint”

| Column | Type | Modifiers |
|---|---|---|
| conname | name | not null |
| connamespace | oid | not null |
| contype | “char” | not null |
| condeferrable | boolean | not null |
| condeferred | boolean | not null |
| conrelid | oid | not null |
| contypid | oid | not null |
| confrelid | oid | not null |
| confupdtype | “char” | not null |
| confdeltype | “char” | not null |
| confmatchtype | “char” | not null |
| conkey | smallint[ ] | |
| confkey | smallint[ ] | |
| conpfeqop | oid[ ] | |
| conppeqop | oid[ ] | |
| conffeqop | oid[ ] | |
| conbin | text | |
| consrc | text | |

Indexes:
“pg_constraint_oid_index” UNIQUE, btree (oid)
“pg_constraint_conname_nsp_index” btree (conname, connamespace)
“pg_constraint_conrelid_index” btree (conrelid)
“pg_constraint_contypid_index” btree (contypid)

Table “pg_catalog.pg_conversion”

| Column | Type | Modifiers |
|---|---|---|
| conname | name | not null |
| connamespace | oid | not null |
| conowner | oid | not null |
| conforencoding | integer | not null |
| contoencoding | integer | not null |
| conproc | regproc | not null |
| condefault | boolean | not null |

Indexes:
“pg_conversion_default_index” UNIQUE, btree (connamespace, conforencoding, contoencoding, oid)
“pg_conversion_name_nsp_index” UNIQUE, btree (conname, connamespace)
“pg_conversion_oid_index” UNIQUE, btree (oid)

Table “pg_catalog.pg_database”

| Column | Type | Modifiers |
|---|---|---|
| datname | name | not null |
| datdba | oid | not null |
| encoding | integer | not null |
| datistemplate | boolean | not null |
| datallowconn | boolean | not null |
| datconnlimit | integer | not null |
| datlastsysoid | oid | not null |
| datfrozenxid | xid | not null |
| dattablespace | oid | not null |
| datconfig | text[ ] | |
| datacl | aclitem[ ] | |

Indexes:
“pg_database_datname_index” UNIQUE, btree (datname), tablespace “pg_global”
“pg_database_oid_index” UNIQUE, btree (oid), tablespace “pg_global”
Triggers:
pg_sync_pg_database AFTER INSERT OR DELETE OR UPDATE ON pg_database FOR EACH STATEMENT EXECUTE PROCEDURE flatfile_update_trigger( )
Tablespace:
“pg_global”

Table “pg_catalog.pg_depend”

| Column | Type | Modifiers |
|---|---|---|
| classid | oid | not null |
| objid | oid | not null |
| objsubid | integer | not null |
| refclassid | oid | not null |
| refobjid | oid | not null |
| refobjsubid | integer | not null |
| deptype | “char” | not null |

Indexes:
“pg_depend_depender_index” btree (classid, objid, objsubid)
“pg_depend_reference_index” btree (refclassid, refobjid, refobjsubid)

Table “pg_catalog.pg_description”

| Column | Type | Modifiers |
|---|---|---|
| objoid | oid | not null |
| classoid | oid | not null |
| objsubid | integer | not null |
| description | text | |

Indexes:
“pg_description_o_c_o_index” UNIQUE, btree (objoid, classoid, objsubid)

Table “pg_catalog.pg_enum”

| Column | Type | Modifiers |
|---|---|---|
| enumtypid | oid | not null |
| enumlabel | name | not null |

Indexes:
“pg_enum_oid_index” UNIQUE, btree (oid)
“pg_enum_typid_label_index” UNIQUE, btree (enumtypid, enumlabel)

Table “pg_catalog.pg_index”

| Column | Type | Modifiers |
|---|---|---|
| indexrelid | oid | not null |
| indrelid | oid | not null |
| indnatts | smallint | not null |
| indisunique | boolean | not null |
| indisprimary | boolean | not null |
| indisclustered | boolean | not null |
| indisvalid | boolean | not null |
| indcheckxmin | boolean | not null |
| indisready | boolean | not null |
| indkey | int2vector | not null |
| indclass | oidvector | not null |
| indoption | int2vector | not null |
| indexprs | text | |
| indpred | text | |

Indexes:
“pg_index_indexrelid_index” UNIQUE, btree (indexrelid)
“pg_index_indrelid_index” btree (indrelid)

Table “pg_catalog.pg_inherits”

| Column | Type | Modifiers |
|---|---|---|
| inhrelid | oid | not null |
| inhparent | oid | not null |
| inhseqno | integer | not null |

Indexes:
“pg_inherits_relid_seqno_index” UNIQUE, btree (inhrelid, inhseqno)

Table “pg_catalog.pg_language”

| Column | Type | Modifiers |
|---|---|---|
| lanname | name | not null |
| lanowner | oid | not null |
| lanispl | boolean | not null |
| lanpltrusted | boolean | not null |
| lanplcallfoid | oid | not null |
| lanvalidator | oid | not null |
| lanacl | aclitem[ ] | |

Indexes:
“pg_language_name_index” UNIQUE, btree (lanname)
“pg_language_oid_index” UNIQUE, btree (oid)

Table “pg_catalog.pg_largeobject”

| Column | Type | Modifiers |
|---|---|---|
| loid | oid | not null |
| pageno | integer | not null |
| data | bytea | |

Indexes:
“pg_largeobject_loid_pn_index” UNIQUE, btree (loid, pageno)

Table “pg_catalog.pg_listener”

| Column | Type | Modifiers |
|---|---|---|
| relname | name | not null |
| listenerpid | integer | not null |
| notification | integer | not null |

Table “pg_catalog.pg_namespace”

| Column | Type | Modifiers |
|---|---|---|
| nspname | name | not null |
| nspowner | oid | not null |
| nspacl | aclitem[ ] | |

Indexes:
“pg_namespace_nspname_index” UNIQUE, btree (nspname)
“pg_namespace_oid_index” UNIQUE, btree (oid)

Table “pg_catalog.pg_opclass”

| Column | Type | Modifiers |
|---|---|---|
| opcmethod | oid | not null |
| opcname | name | not null |
| opcnamespace | oid | not null |
| opcowner | oid | not null |
| opcfamily | oid | not null |
| opcintype | oid | not null |
| opcdefault | boolean | not null |
| opckeytype | oid | not null |

Indexes:
“pg_opclass_am_name_nsp_index” UNIQUE, btree (opcmethod, opcname, opcnamespace)
“pg_opclass_oid_index” UNIQUE, btree (oid)

Table “pg_catalog.pg_operator”

| Column | Type | Modifiers |
|---|---|---|
| oprname | name | not null |
| oprnamespace | oid | not null |
| oprowner | oid | not null |
| oprkind | “char” | not null |
| oprcanmerge | boolean | not null |
| oprcanhash | boolean | not null |
| oprleft | oid | not null |
| oprright | oid | not null |
| oprresult | oid | not null |
| oprcom | oid | not null |
| oprnegate | oid | not null |
| oprcode | regproc | not null |
| oprrest | regproc | not null |
| oprjoin | regproc | not null |

Indexes:
“pg_operator_oid_index” UNIQUE, btree (oid)
“pg_operator_oprname_l_r_n_index” UNIQUE, btree (oprname, oprleft, oprright, oprnamespace)

Table “pg_catalog.pg_opfamily”

| Column | Type | Modifiers |
|---|---|---|
| opfmethod | oid | not null |
| opfname | name | not null |
| opfnamespace | oid | not null |
| opfowner | oid | not null |

Indexes:
“pg_opfamily_am_name_nsp_index” UNIQUE, btree (opfmethod, opfname, opfnamespace)
“pg_opfamily_oid_index” UNIQUE, btree (oid)

Table “pg_catalog.pg_pltemplate”

| Column | Type | Modifiers |
|---|---|---|
| tmplname | name | not null |
| tmpltrusted | boolean | not null |
| tmpldbacreate | boolean | not null |
| tmplhandler | text | |
| tmplvalidator | text | |
| tmpllibrary | text | |
| tmplacl | aclitem[ ] | |

Indexes:
“pg_pltemplate_name_index” UNIQUE, btree (tmplname), space “pg_global” space: “pa_global”

Table “pg_catalog.pg_proc”

| Column | Type | Modifiers |
|---|---|---|
| proname | name | not null |
| pronamespace | oid | not null |
| proowner | oid | not null |
| prolang | oid | not null |
| procost | real | not null |
| prorows | real | not null |
| proisagg | boolean | not null |
| prosecdef | boolean | not null |
| proisstrict | boolean | not null |
| proretset | boolean | not null |
| provolatile | “char” | not null |
| pronargs | smallint | not null |
| prorettype | oid | not null |
| proargtypes | oidvector | not null |
| proallargtypes | oid[ ] | |
| proargmodes | “char”[ ] | |
| proargnames | text[ ] | |
| prosrc | text | |
| probin | bytea | |
| proconfig | text[ ] | |
| proacl | aclitem[ ] | |

Indexes:
“pg_proc_oid_index” UNIQUE, btree (oid)
“pg_proc_proname_args_nsp_index” UNIQUE, btree (proname, proargtypes, pronamespace)

Table “pg_catalog.pg_rewrite”

| Column | Type | Modifiers |
|---|---|---|
| rule name | name | not null |
| ev_class | oid | not null |
| ev_attr | smallint | not null |
| ev_type | “char” | not null |
| ev_enabled | “char” | not null |
| is_instead | boolean | not null |
| ev_qual | text | |
| ev_action | text | |

Indexes:
“pg_rewrite_oid_index” UNIQUE, btree (oid)
“pg_rewrite_rel_rulename_index” UNIQUE, btree (ev_class, rulename)

Table “pg_catalog.pg_shdepend”

| Column | Type | Modifiers |
|---|---|---|
| dbid | oid | not null |
| classid | oid | not null |
| objid | oid | not null |
| refclassid | oid | not null |
| refobjid | oid | not null |
| deptype | “char” | not null |

Indexes:
“pg_shdepend_depender_index” btree (dbid, classid, objid), tablespace “pg_global”
“pg_shdepend_reference_index” btree (refclassid, refobjid), tablespace “pg_global”
Tablespace: “pg_global”

Table “pg_catalog.pg_shdescription”

| Column | Type | Modifiers |
|---|---|---|
| objoid | oid | not null |
| classoid | oid | not null |
| description | text | |

Indexes:
“pg_shdescription_o_c_index” UNIQUE, btree (objoid, classoid), tablespace “pg_global”
Tablespace: “pg_global”

Table “pg_catalog.pg_statistic”

| Column | Type | Modifiers |
|---|---|---|
| starelid | oid | not null |
| staattnum | smallint | not null |
| stanullfrac | real | not null |
| stawidth | integer | not null |
| stadistinct | real | not null |
| stakind1 | smallint | not null |
| stakind2 | smallint | not null |
| stakind3 | smallint | not null |
| stakind4 | smallint | not null |
| staop1 | oid | not null |
| staop2 | oid | not null |
| staop3 | oid | not null |
| staop4 | oid | not null |
| stanumbers1 | real[ ] | |
| stanumbers2 | real[ ] | |
| stanumbers3 | real[ ] | |
| stanumbers4 | real[ ] | |
| stavalues1 | anyarray | |
| stavalues2 | anyarray | |
| stavalues3 | anyarray | |
| stavalues4 | anyarray | |

Indexes:
“pg_statistic_relid_att_index” UNIQUE, btree (starelid, staattnum)

Table “pg_catalog.pg_tablespace”

| Column | Type | Modifiers |
|---|---|---|
| spcname | name | not null |
| spcowner | oid | not null |
| spclocation | text | |
| spcacl | aclitem[ ] \| | |

Indexes:
“pg_tablespace_oid_index” UNIQUE, btree (oid), tablespace “pg_global”
“pg_tablespace_spcname_index” UNIQUE, btree (spcname), tablespace “pg_global”
Tablespace: “pg_global”

Table “pg_catalog.pg_trigger”

| Column | Type | Modifiers |
|---|---|---|
| tgrelid | oid | not null |
| tgname | name | not null |
| tgfoid | oid | not null |
| tgtype | smallint | not null |
| tgenabled | “char” | not null |
| tgisconstraint | boolean | not null |
| tgconstrname | name | not null |
| tgconstrrelid | oid | not null |
| tgconstraint | oid | not null |
| tgdeferrable | boolean | not null |
| tginitdeferred | boolean | not null |
| tgnargs | smallint | not null |
| tgattr | int2vector | not null |
| tgargs | bytea | |

Indexes:
“pg_trigger_oid_index” UNIQUE, btree (oid)
“pg_trigger_tgrelid_tgname_index” UNIQUE, btree (tgrelid, tgname)
“pg_trigger_tgconstrname_index” btree (tgconstrname)

Table “pg_catalog.pg_ts_config”

| Column | Type | Modifiers |
|---|---|---|
| cfgname | name | not null |
| cfgnamespace | oid | not null |
| cfgowner | oid | not null |
| cfgparser | oid | not null |

Indexes:
“pg_ts_config_cfgname_index” UNIQUE, btree (cfgname, cfgnamespace)
“pg_ts_config_oid_index” UNIQUE, btree (oid)

Table “pg_catalog.pg_ts_config_map”

| Column | Type | Modifiers |
|---|---|---|
| mapcfg | oid | not null |
| maptokentype | integer | not null |
| mapseqno | integer | not null |
| mapdict | oid | not null |

Indexes:
“pg_ts_config_map_index” UNIQUE, btree (mapcfg, maptokentype, mapseqno)

Table “pg_catalog.pg_ts_dict”

| Column | Type | Modifiers |
|---|---|---|
| dictname | name | not null |
| dictnamespace | oid | not null |
| dictowner | oid | not null |
| dicttemplate | oid | not null |
| dictinitoption | text | |

Indexes:
“pg_ts_dict_dictname_index” UNIQUE, btree (dictname, dictnamespace)
“pg_ts_dict_oid_index” UNIQUE, btree (oid)

Table “pg_catalog.pg_ts_parser”

| Column | Type | Modifiers |
|---|---|---|
| prsname | name | not null |
| prsnamespace | oid | not null |
| prsstart | regproc | not null |
| prstoken | regproc | not null |
| prsend | regproc | not null |
| prsheadline | regproc | not null |
| prslextype | regproc | not null |

Indexes:
“pg_ts_parser_oid_index” UNIQUE, btree (oid)
“pg_ts_parser_prsname_index” UNIQUE, btree (prsname, prsnamespace)

Table “pg_catalog.pg_ts_template”

| Column | Type | Modifiers |
|---|---|---|
| tmplname | name | not null |
| tmplnamespace | oid | not null |
| tmplinit | regproc | not null |
| tmpllexize | regproc | not null |

Indexes:
“pg_ts_template_oid_index” UNIQUE, btree (oid)
“pg_ts_template_tmplname_index” UNIQUE, btree (tmplname, tmplnamespace)

Table “pg_catalog.pg_type”typreceive |regproc |not null

| Column | Type | Modifiers |
|---|---|---|
| typname | name | not null |
| typnamespace | oid | not null |
| typowner | oid | not null |
| typlen | smallint | not null |
| typbyval | boolean | not null |
| typtype | “char” | not null |
| typisdefined | boolean | not null |
| typdelim | “char” | not null |
| typrelid | oid | not null |
| typelem | oid | not null |
| typarray | oid | not null |
| typinput | regproc | not null |
| typoutput | regproc | not null |
| typsend | regproc | not null |
| typmodin | regproc | not null |
| typmodout | regproc | not null |
| typanalyze | regproc | not null |
| typalign | “char” | not null |
| typstorage | “char” | not null |
| typnotnull | boolean | not null |
| typbasetype | oid | not null |
| typtypmod | integer | not null |
| typndims | integer | not null |
| typndims | integer | not null |
| typdefaultbin | text | |
| typdefault | text | |

Indexes:
“pg_type_oid_index” UNIQUE, btree (oid)
“pg_type_typname_nsp_index” UNIQUE, btree (typname, typnamespace)

Table “queue.queue_messaging”

| Column | Type | Modifiers |
|---|---|---|
| message_id | integer | not null |
| | | defaultnextval(‘queue.- |
| | | queue_messaging_message_id_seq’:: |
| | | regclass) |
| message | text | |
| read_count | integer | not null default 0 |
| date_created | timestamp | not null default now( ) |
| | without time | |
| | zone | |
| date_received | timestamp | |
| | without time | |
| | zone | |
| deleted | boolean | not null default false |

Indexes:
“queue_messaging_message_id_key” UNIQUE, btree (message_id)

Table “queue.queues”

| Column | Type | Modifiers |
|---|---|---|
| queue_id | integer | not null default |
| | | nextval(‘queue.- |
| | | queues_queue_id_seq’::regclass) |
| queue | character | not null default 30 |
| | varying(50) | |
| timeout | integer | |
| message_count | integer | not null default 0 |
| date_created | timestamp | not null default now( ) |
| | without time | |
| | zone | |

Indexes:
“queues_pkey” PRIMARY KEY, btree (queue_id)
“queue_unique_key” UNIQUE, btree (queue)

Table “reader.feeds”

| Column | Type | Modifiers |
|---|---|---|
| feed_id | integer | not null default |
| | | nextval(‘reader.- |
| | | feeds_feed_id_seq’::regclass) |
| url | character varying | not null |
| title | character varying | not null |
| interval | integer | |
| date_created | timestamp without | not null default now( ) |
| | time zone | |
| last_checked | timestamp without | default now( ) |
| | time zone | |

Indexes:
“feeds_pkey” PRIMARY KEY, btree (feed_id)
“feeds_url_key” UNIQUE, btree (url)

Table “reader.items”

| Column | Type | Modifiers |
|---|---|---|
| item_id | integer | not null default |
| | | nextval(‘reader.- |
| | | items_item_id_seq’::regclass) |
| feed_id | integer | not null |
| title | character varying | |
| link | character varying | |
| description | text | |
| author | character varying | |
| category | character varying | |
| comments | character varying | |
| guid | character varying | |
| pubdate | character varying | |
| enclosure_url | character varying | |
| enclosure_length | character varying | |
| enclosure_type | character varying | |
| image_url | character varying | |
| image_title | character varying | |
| image_link | character varying | |
| image_width | character varying | |
| image_height | character varying | |
| image_description | character varying | |
| raw | text | |
| date_created | timestamp | not null default now( ) |
| | without | |
| | time zone | |

Indexes:
“items_pkey” PRIMARY KEY, btree (item_id)
“items_raw_key” UNIQUE, btree (raw)
Foreign-key constraints:
“items_feed_id_fkey” FOREIGN KEY (feed_id) REFERENCES reader.feeds(feed_id) ON DELETE CASCADE

Table “reader.reported”

| Column | Type | Modifiers |
|---|---|---|
| reported_id | integer | not null default |
| | | nextval(‘reader.- |
| | | reported_reported_id_seq’::regclass) |
| feed_id | integer | not null |
| user_id | integer | not null |
| reported_reason_id | smallint | not null |
| reviewer | character | |
| | varying | |
| | (50) | |
| reviewer_comments | text | |
| date_created | timestamp | not null default now( ) |
| | without | |
| | time | |
| | zone | |
| date_modified | timestamp | |
| | without | |
| | time | |
| | zone | |
| flag_comment | text | |

Indexes:
“reported_pkey” PRIMARY KEY, btree (reported_id)

Table “reference.address_types”

| Column | Type | Modifiers |
|---|---|---|
| address_type_id | integer | not null default |
| | | nextval(‘reference.address_types_address_type_id_seq’::reg |
| | | class) |
| address_type | character | not null |
| | varying(32) | |
| date_created | timestamp with | not null default now( ) |
| | time zone | |

Indexes:
“address_types_pkey” PRIMARY KEY, btree (address_type_id)
“address_types_address_type_key” UNIQUE, btree (address_type)

Table “reference.admin_permissions”

| Column | Type | Modifiers |
|---|---|---|
| admin_permission_id | integer | not null |
| permission | character varying(50) | |

Indexes:
“admin_permissions_pkey” PRIMARY KEY, btree (admin_permission_id)

Table “reference.badwords”

| Column | Type | Modifiers |
|---|---|---|
| word_id | integer | not null default |
| | | nextval(‘reference.- |
| | | badwords_word_id_seq’::regclass) |
| word | text | |
| regex | text | |
| allowed | boolean | default false |

Indexes:
“badwords_pkey” PRIMARY KEY, btree (word_id)

Table “reference.categories”

| Column | Type | Modifiers |
|---|---|---|
| category_id | integer | not null default |
| | | nextval(‘reference.- |
| | | categories_category_id_seq’::regclass) |
| category | character | not null |
| | varying(25) | |
| language_id | integer | not null default 1 |
| date_created | timestamp | not null default now( ) |
| | without time | |
| | zone | |
| family | character | |
| | varying | |
| sort | character | |
| | varying | |
| family_sort | integer | not null default 1 |

Indexes:
“categories_pkey” PRIMARY KEY, btree (category_id)

Table “reference.charge_types”

| Column | Type | Modifiers |
|---|---|---|
| charge_type_id | integer | not null default |
| | | nextval(‘reference.charge_types_charge_type_id_seq’::regclass) |
| name | character varying(30) | not null |
| date_created | timestamp without | not null default now( ) |
| | time zone | |

Indexes:
“charge_types_pkey” PRIMARY KEY, btree (charge_type_id)

Table “reference.common_words”

| Column | Type | Modifiers |
|---|---|---|
| word_id | integer | not null default |
| | | nextval(‘reference.- |
| | | common_words_word_id_seq’::regclass) |
| word | text | |
| language_id | integer | |

Indexes:
“common_words_pkey” PRIMARY KEY, btree (word_id)

Table “reference.countries”

| Column | Type | Modifiers |
|---|---|---|
| country_id | integer | not null default |
| | | nextval(‘reference.- |
| | | countries_country_id_seq’::regclass) |
| name | character | not null |
| | varying(50) | |
| code | character | not null |
| | varying(2) | |
| domain | character | not null |
| | varying(25) | |
| language_id | smallint | not null |
| date_created | timestamp | not null default now( ) |
| | without time | |
| | zone | |

Indexes:
“countries_pkey” PRIMARY KEY, btree (country_id)
“countries_name_key” UNIQUE, btree (name)

Table “reference.default_preferences”

| Column | Type | Modifiers |
|---|---|---|
| pref_id | in- | not null default |
| | teger | nextval(‘reference.- |
| | | default_preferences_pref_id_seq’::regclass) |
| key | text | |
| value | text | |
| pref_description | text | |

Indexes:
“default_preferences_pkey” PRIMARY KEY, btree (pref_id)

Table “reference.file_formats”

| Column | Type | Modifiers |
|---|---|---|
| file_format_id | integer | not null default |
| | | nextval(‘reference.file_formats_file_format_id_seq’::regclass) |
| extension | character | not null |
| | varying(10) | |
| description | character | not null |
| | varying(100) | |
| media_type_id | smallint | not null |
| uploadable | boolean | not null |
| date_created | timestamp | not null default now( ) |
| | without time | |
| | zone | |

Indexes:
“file_formats_pkey” PRIMARY KEY, btree (file_format_id)

Table “reference.file_stores”

| Column | Type | Modifiers |
|---|---|---|
| file_store_id | integer | not null default |
| | | nextval(‘reference.- |
| | | file_stores_file_store_id_seq’::regclass) |
| name | character | not null |
| | varying(50) | |
| description | text | not null |
| path | character | |
| | varying(50) | |
| secured | boolean | not null default false |

Indexes:
“file_stores_pkey” PRIMARY KEY, btree (file_store_id)

Table “reference.id3_genres”

| Column | Type | Modifiers |
|---|---|---|
| id3_genre_id | integer | not null default |
| | | nextval(‘reference.- |
| | | id3_genres_id3_genre_id_seq’::reg |
| | | class) |
| genre | character | not null |
| | varying(50) | |
| display | boolean | default false |
| date_created | timestamp | default now( ) |
| | without | |
| | time zone | |

Indexes:
“id3_genres_pkey” PRIMARY KEY, btree (id3_genre_id)

Table “reference.invoice_status”

| Column | Type | Modifiers |
|---|---|---|
| status_id | integer | not null default |
| | | nextval(‘reference.- |
| | | invoice_status_status_id_seq’::regclass) |
| status | character | |
| | varying(30) | |

Indexes:
“invoice_status_pkey” PRIMARY KEY, btree (status_id)

Table “reference.languages”

| Column | Type | Modifiers |
|---|---|---|
| language_id | integer | not null default |
| | | nextval(‘reference.- |
| | | languages_language_id_seq’::regclass) |
| language | character | not null |
| | varying(30) | |
| date_created | timestamp | not null default now( ) |
| | without | |
| | time zone | |
| date_modified | timestamp | |
| | without | |
| | time zone | |
| language_code | character | |
| | varying(5) | |
| translated | character | |
| | varying(25) | |

Indexes:
“languages_pkey” PRIMARY KEY, btree (language_id)
“languages_language_key” UNIQUE, btree (language)

Table “reference.media_reported_reasons”

| Column | Type | Modifiers |
|---|---|---|
| media_reported_reason_id | integer | not null default |
| | | nextval(‘reference.media_reported_reasons_media_reported_reason_id_seq’ |
| | | ::regclass) |
| reason | character varying(50) | not null |
| date_created | timestamp without | not null default now( ) |
| | time zone | |

Indexes:
“media_reported_reasons_pkey” PRIMARY KEY, btree (media_reported_reason_id)

Table “reference.media_statuses”

| Column | Type | Modifiers |
|---|---|---|
| media_status_id | integer | not null default |
| | | nextval(‘reference.media_statuses_media_status_id_seq’::reg |
| | | class) |
| media_status | character | not null |
| | varying | |
| date_created | timestamp | default now( ) |
| | without time | |
| | zone | |

Indexes:
“media_statuses_pkey” PRIMARY KEY, btree (media_status_id)

Table “reference.media_types”

| Column | Type | Modifiers |
|---|---|---|
| media_type_id | integer | not null default |
| | | nextval(‘reference.media_types_media_type_id_seq’::regclass) |
| name | character | not null |
| | varying(25) | |
| date_created | timestamp | not null default now( ) |
| | without | |
| | time zone | |
| display_order | integer | |

Indexes:
“media_types_pkey1” PRIMARY KEY, btree (media_type_id)

Table “reference.message_types”

| Column | Type | Modifiers |
|---|---|---|
| message_type_id | integer | not null default |
| | | nextval(‘reference.message_types_message_type_id_seq’::regclass) |
| message_type | character | |
| | varying(25) | |
| date_created | timestamp | not null default now( ) |
| | without | |
| | time zone | |

Indexes:
“message_types_pkey” PRIMARY KEY, btree (message_type_id)

Table “reference.module_types”

| Column | Type | Modifiers |
|---|---|---|
| module_type_id | integer | not null default |
| | | nextval(‘reference.module_types_module_type_id_seq’::regclass) |
| module_type | character | not null |
| | varying(25) | |
| class | character | |
| | varying(25) | |

Indexes:
“module_types_pkey” PRIMARY KEY, btree (module_type_id)

Table “reference.object_types”

| Column | Type | Modifiers |
|---|---|---|
| object_type_id | integer | not null default |
| | | nextval(‘reference.object_types_object_type_id_seq’::regclass) |
| obect_type | text | not null |
| date_created | timestamp | not null |
| | without | |
| | time zone | |

Indexes:
“object_types_pkey” PRIMARY KEY, btree (object_type_id)

Table “reference.pricing_types”

| Column | Type | Modifiers |
|---|---|---|
| pricing_type_id | integer | not null |
| type | character varying(255) | not null |
| price | numeric | not null |
| duration | smallint | default 0 |
| description | text | not null |

Indexes:
“pricing_types_pkey” PRIMARY KEY, btree (pricing_type_id)

Table “reference.privacy_types”

| Column | Type | Modifiers |
|---|---|---|
| privacy_type_id | integer | not null default |
| | | nextval(‘reference.- |
| | | privacy_types_privacy_type_id_seq’ |
| | | ::regclass) |
| privacy_type | character | not null |
| | varying(25) | |

Indexes:
“privacy_types_pkey” PRIMARY KEY, btree (privacy_type_id)

Table “reference.religions”

| Column | Type | Modifiers |
|---|---|---|
| religion_id | integer | not null default |
| | | nextval(‘reference.- |
| | | religions_religion_id_seq’::regclass) |
| name | character | not null |
| | varying(25) | |
| language_id | smallint | not null |
| date_created | timestamp | not null default now( ) |
| | without time | |
| | zone | |

Indexes:
“religions_pkey” PRIMARY KEY, btree (religion_id)
“religions_name_key” UNIQUE, btree (name)

Table “reference.ssi”

| Column | Type | Modifiers |
|---|---|---|
| ssi_id | integer | not null default |
| | | nextval(‘reference.- |
| | | ssi_ssi_id_seq’::regclass) |
| ssi | smallint | not null |
| title | character | not null |
| | varying(50) | |
| description | text | |
| language_id | smallint | not null |
| media_filename | character | not null |
| | varying(72) | |
| date_created | timestamp without | not null default now( ) |
| | time zone | |

Indexes:
“ssi_pkey” PRIMARY KEY, btree (ssi_id)

Table “reference.states”

| Column | Type | Modifiers |
|---|---|---|
| state_id | integer | not null default |
| | | nextval(‘reference.- |
| | | states_state_id_seq’::regclass) |
| name | character | not null |
| | varying(25) | |
| abbreviation | character | not null |
| | varying(2) | |
| country_id | smallint | not null |
| date_created | timestamp | not null default now( ) |
| | without time zone | |

Indexes:
“states_pkey” PRIMARY KEY, btree (state_id)

Table “reference.statuses”

| Column | Type | Modifiers |
|---|---|---|
| status_id | integer | not null default |
| | | nextval(‘reference.- |
| | | statuses_status_id_seq’::regclass) |
| status | text | not null |

Indexes:
“statuses_pkey” PRIMARY KEY, btree (status_id)

Table “reference.target_ages”

| Column | Type | Modifiers |
|---|---|---|
| target_age_id | integer | not null default |
| | | nextval(‘reference.target_ages_target_age_id_seq’::regclass) |
| min_age | smallint | not null |
| max_age | smallint | |
| description | character | not null |
| | varying(25) | |
| date_created | time with | not null default now( ) |
| | time zone | |

Indexes:
“target_ages_pkey” PRIMARY KEY, btree (target_age_id)

Table “reference.user_types”

| Column | Type | Modifiers |
|---|---|---|
| user_type_id | integer | not null default |
| | | nextval(‘reference.user_types_user_type_id_seq’::regclass) |
| type | character | |
| | varying(50) | |

Indexes:
“user_types_pkey” PRIMARY KEY, btree (user_type_id)

Table “reports.search_log”

| Column | Type | Modifiers |
|---|---|---|
| search_id | integer | not null default |
| | | nextval(‘reports.- |
| | | search_log_search_id_seq’::regclass) |
| search_query | text | |
| querystring | text | |
| matches | text | |
| user_id | integer | |
| referer | text | |
| date_created | timestamp | default now( ) |
| | without time | |
| | zone | |
| cache_expires | timestamp | |
| | without time | |
| | zone | |

Indexes:
“search_log_pkey” PRIMARY KEY, btree (search_id)

Table “search.index_err_log”

| Column | Type | Modifiers |
|---|---|---|
| err_id | bigint | not null default |
| | | nextval(‘search.- |
| | | index_err_log_err_id_seq’::regclass) |
| object_id | bigint | not null |
| object_type_id | smallint | not null |
| err_msg | text | not null |
| date_created | timestamp | not null default now( ) |
| | without tim | |
| | text e zone | |
| data | | |

Indexes:
“index_err_log_pkey” PRIMARY KEY, btree (err_id)

Table “search.log”

| Column | Type | Modifiers |
|---|---|---|
| search_id | bigint | not null default |
| | | nextval(‘search.log_search_id_seq’::regclass) |
| query | text | |
| result_count | smallint | |
| top_10 | character varying | |
| user_id | bigint | |
| user_ip | character varying | |
| page_num | smallint | |
| search_type | text | |
| date_created | timestamp without time | default now( ) |
| | zone | |

Table “search.search_index”

| Column | Type | Modifiers |
|---|---|---|
| index_id | bigint | not null default |
| | | nextval(‘search.search_index_index_id_seq’::regclass) |
| object_id | bigint | |
| title | text | |
| keywords | text | |
| body | text | |
| artist | text | |
| search_text | tsvector | |
| object_type_id | bigint | |
| object_subtype_id | smallint | |
| status_id | smallint | |
| module_id | smallint | |
| community_id | smallint | |
| price | double | |
| | precision | |
| views | bigint | |
| last_view | timestamp | |
| | without | |
| | time zone | |
| publisher_id | smallint | |
| publisher_name | character | |
| | varying | |
| rating | smallint | |
| user_id | bigint | |
| members | bigint | |
| object_date_created | timestamp | |
| | without | |
| | time zone | |
| date_created | timestamp | default now( ) |
| | without | |
| | time zone | |
| owner_id | integer | |
| owner_type_id | integer | |

Indexes:
“body_index” btree (body)
“keywords_index” btree (keywords)
“search_text_index” gist (search_text)
“title_index” btree (title)

Table “shop.cart”

| Column | Type | Modifiers |
|---|---|---|
| cart_id | integer | not null default |
| | | nextval(‘shop.cart_cart_id_seq’::regclass) |
| user_id | integer | |
| cart_type | text | not null |
| date_created | timestamp without time zone | not null default now( ) |
| active | boolean | default true |

Indexes:
“cart_pkey” PRIMARY KEY, btree (cart_id)

Table “shop.coupons”

| Column | Type | Modifiers |
|---|---|---|
| coupon_id | integer | not null default |
| | | nextval(‘shop.coupons_coupon_id_seq’::regclass) |
| coupon_code | character | |
| | varying(12) | |
| amount | double precision | |
| amount_type | integer | |
| coupon_title | text | |
| coupon_desc | text | |
| publisher_id | integer | |
| issuer_type | integer | |
| start_date | timestamp | |
| | without time | |
| | zone | |
| end_date | timestamp | |
| | without time | |
| | zone | |
| uses | integer | |
| date_created | timestamp | default now( ) |
| | without time | |
| | zone | |
| date_modified | time with time | |
| | zone | |
| publisher_split | integer | |

Indexes:
“coupons_pkey” PRIMARY KEY, btree (coupon_id)
“coupons_coupon_code_key” UNIQUE, btree (coupon_code)

Table “shop.items”

| Column | Type | Modifiers |
|---|---|---|
| id | integer | not null default |
| | | nextval(‘shop.items_id_seq’::regclass) |
| item_id_varchar | integer | |
| item_desc | text | |
| cart_id | integer | |
| invoice_id_varchar | character varying(20) | |
| price | numeric | |
| date_created | timestamp without time | not null default now( ) |
| | zone | |
| quantity | integer | |
| charge_type_id | integer | |
| item_id | integer | |
| invoice_id | integer | |

Indexes:
“items_pkey” PRIMARY KEY, btree (id)

Table “usr.activity”

| Column | Type | Modifiers |
|---|---|---|
| activity_id | integer | not null default |
| | | nextval(‘usr.activity_activity_id_seq’::regclass) |
| session_id | character | |
| | varying(32) | |
| user_agent | text | |
| page_name | text | |
| page_url | text | |
| last_activity | timestamp without time | default now( ) |
| | zone | |
| user_id | integer | |
| user_ip | character | |
| | varying(128) | |

Indexes:
“activity_pkey” PRIMARY KEY, btree (activity_id)

Table “usr.fb_inspiration”

| Column | Type | Modifiers |
|---|---|---|
| fb_id | integer | not null default |
| | | nextval(‘usr.fb_inspiration_fb_id_seq’::regclass) |
| fb_user_id | bigint | |
| user_id | integer | |
| date_created | timestamp | |
| | without time zone \| default | |
| | now( ) | |
| app_name | text | |

Indexes:
“fb_inspiration_pkey” PRIMARY KEY, btree (fb_id)
“fb_user_app_unique” UNIQUE, btree (fb_user_id, app_name)

Table “usr.invitation_request”

| Column | Type | Modifiers |
|---|---|---|
| invitation_request_id | integer | not null default |
| | | nextval(‘usr.invitation_request_invitation_request_id_seq’:: |
| | | regclass) |
| email | character | not null |
| | varying(100) | |
| user_id | bigint | |
| date_created | timestamp | not null default now( ) |
| | without time | |
| | zone | |

Indexes:
“invitation_request_pkey” PRIMARY KEY, btree (invitation_request_id)

Table “usr.invitations”

| Column | Type | Modifiers |
|---|---|---|
| invitation_id | bigint | not null default |
| | | nextval(‘usr.invitations_invitation_id_seq’::regclass) |
| invitation_code | character | not null |
| | varying(50) | |
| host_user_id | bigint | not null |
| sent | boolean | default false |
| active | boolean | not null default true |
| redemptions_available | integer | default 1 |
| date_created | timestamp | not null default now( ) |
| | without | |
| | time zone | |

Indexes:
“invitations_pkey” PRIMARY KEY, btree (invitation_id)
“invitations_invitation_code_key” UNIQUE, btree (invitation_code)

Table “usr.logins”

| Column | Type | Modifiers |
|---|---|---|
| login_id | integer | not null default |
| | | nextval(‘usr.logins_login_id_seq’::regclass) |
| user_id | integer | not null |
| ip_address | inet | not null |
| magic | boolean | not null default false |
| date_created | timestamp without time | not null default now( ) |
| | zone | |
| user_agent | character varying | |
| resolution | character varying | |

Indexes:
“logins_pkey” PRIMARY KEY, btree (login_id)
Foreign-key constraints:
“logins_user_id_fkey” FOREIGN KEY (user_id) REFERENCES usr.users(user_id) ON DELETE CASCADE

Table “usr.preferences”

| Column | Type | Modifiers |
|---|---|---|
| pref_id | integer | not null default |
| | | nextval(‘usr.prefs_pref_id_seq’::regclass) |
| key | text | |
| value | text | |
| user_id | integer | |

Indexes:
“prefs_pkey” PRIMARY KEY, btree (pref_id)
Foreign-key constraints:
“preferences_user_id_fkey” FOREIGN KEY (user_id) REFERENCES usr.users(user_id) ON DELETE CASCADE

Table “usr.publishers”

| Column | Type | Modifiers |
|---|---|---|
| publisher_id | integer | not null default |
| | | nextval(‘usr.publishers_publisher_id_seq’::regclass) |
| name | character | not null |
| | varying(50) | |
| website | character | not null |
| | varying(100) | |
| date_created | timestamp | not null default now( ) |
| | without time zone | |
| featured | boolean | default true |

Indexes:
“publishers_pkey” PRIMARY KEY, btree (publisher_id)
“publishers_name_key” UNIQUE, btree (name)

Table “usr.teams”

| Column | Type | Modifiers |
|---|---|---|
| team_id | integer | not null default |
| | | nextval(‘usr.teams_team_id_seq’::regclass) |
| team_name | character varying | |
| first_name | text | |
| last_name | text | |
| email | text | |
| phone | character | |
| | varying(16) | |
| city | text | |
| state | text | |
| zip_code | character | |
| | varying(8) | |
| description | text | |
| number_members | integer | |
| average_age | char text acter | |
| | varying(8) | |
| affiliation | | |
| user_id | integer | not null default |
| | | nextval(‘usr.teams_user_id_seq’::regclass) |
| date_created | timestamp without | default now( ) |
| | time zone | |
| date_updated | timestamp without | |
| | time zone | |
| active | boolean | default true |

Indexes:
“teams_pkey” PRIMARY KEY, btree (team_id)

Table “usr.user_request_log”

| Column | Type | Modifiers |
|---|---|---|
| user_request_log_id | integer | not null default |
| | | nextval(‘usr.user_request_log_user_request_log_id_seq’::reg |
| | | class) |
| user_id | bigint | not null |
| request | character | not null |
| | varying(50) | |
| detail | text | |
| comments | text | |
| status | boolean | |
| key | character | |
| | varying(50) | |
| date_created | timestamp | not null default now( ) |
| | without time | |
| | zone | |

Indexes:
“user_request_log_pkey” PRIMARY KEY, btree (user_request_log_id)
Foreign-key constraints:
“user_request_log_user_id_fkey” FOREIGN KEY (user_id) REFERENCES usr.users(user_id) ON DELETE CASCADE

Table “usr.users”

| Column | Type | Modifiers |
|---|---|---|
| user_id | integer | not null default |
| | | nextval(‘usr.users_user_id_seq’::regclass) |
| username | character varying(21) | not null |
| password | character varying(72) | not null |
| email | character varying(50) | not null |
| first_name | character varying(25) | |
| last_name | character varying(25) | |
| user_type_id | smallint | not null |
| last_activity | timestamp without time | |
| | zone | |
| last_session_id | character varying(32) | |
| country_id | smallint | |
| religion_id | character(1) | |
| gender | character(1) | |
| reported_count | smallint | |
| reset_validate | character varying(15) | |
| active | boolean | default false |
| birth_date | date | |
| date_created | timestamp without time | not null default now( ) |
| | zone | |
| clergy | boolean | |
| publisher_id | integer | |
| zip_code | character varying(10) | |
| banner_path | character varying(300) | |
| religious_order | character varying(100) | |
| user_status_id | smallint | |
| invitation_id | integer | |
| reject_num | smallint | default 0 |
| date_modified | timestamp without time | |
| | zone | |
| church | text | |
| career | text | |
| aboutme | text | |
| favorite_verse | text | |
| favorite_music | text | |
| picture_url | text | |
| religion | text | |
| index_level | integer | default 2 |

Indexes:
“user_id_pkey” PRIMARY KEY, btree (user_id)
“username_unique” UNIQUE, btree (username)
“users_username_key” UNIQUE, btree (username)
Foreign-key constraints:
“users_id_fkey” FOREIGN KEY (user_id) REFERENCES usr.users(user_id) ON DELETE CASCADE
Triggers:
update_index_level BEFORE INSERT OR UPDATE ON usr.users FOR EACH ROW EXECUTE PROCEDURE usr.index_level_update( )

In the foregoing description, reference is made to particular user interface displays generated by a web server and displayed on a client computing system, such as through a browser software program. The user interfaces are provided as just one example of the many possible embodiments of such user interfaces, and embodiments including minor changes to such user interfaces are intended to be within the scope of this disclosure. As one example, the present disclosure makes reference to various web page controls, such as buttons, links, check boxes, drop-down menus, and the like. Other embodiments can be made by selecting alternative web page controls.

Moreover, the various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A media distribution system for distributing media items across a data communication network, the system comprising:
a media database device storing media items received from a publisher including at least a publisher media item and storing media items received from at least one user including at least one user generated media item; and
a web server device including a processor and memory, the memory containing computer executable instructions, which when executed by the processor cause the processor to generate web page data and to communicate the web page data across the data communication network, the web server being communicatively connected to the media database, wherein the web page data generated by the processor defines at least a first media web page directed to the publisher media item and a second web page directed to the user generated media item.

2. The media distribution system of claim 1, wherein the publisher media item is available for distribution from the media distribution system for a fee and wherein the user generated media item is available from the media distribution system for free.

3. The media distribution system of claim 1, wherein the web page data defining the first media web page further defines a snack window for generating a sample of the publisher media item, a meal window defining a tool for purchasing and downloading the publisher media item, and a dessert window defining a link associated with the publisher.

4. The media distribution system of claim 3, wherein the web page data defines an arrangement of the snack window, meal window, and dessert window of the first media web page, wherein the arrangement results in the snack window being displayed in a browser window to a side of a meal window, and wherein the arrangement results in a dessert window being displayed below the meal window.

5. The media distribution system of claim 3, wherein the web page data further defines a publisher upload module including at least one publisher upload page, wherein the at least one publisher upload page is arranged and configured to receive data from the publisher defining a snack content and a dessert content, wherein the web page data includes the snack content in the snack window and the dessert content in the dessert window.

6. The media distribution system of claim 1, wherein the web page data further defines a media browsing page including a plurality of media snapshot displays, wherein a first media snapshot display is associated with the first publisher media item, and wherein a second media snapshot display is associated with the user generated media item.

7. A method of generating web page data associated with media items, the method comprising:
associating a user with a first segment identifier of a plurality of segment identifiers using a web server device, the plurality of segment identifiers being associated with distinct segments of a vertical group of users; and
generating web page data with the web server using the segment identifier, the web page data identifying at least one media item available from the web server.

8. The method of claim 6, wherein associating a user with a segment identifier further comprises:
sending a web page from the web server device including an identification of the plurality of segment identifiers and including a request for the user to select one of the plurality of segment identifiers, the plurality of segment identifiers including the first segment identifier; and
receiving a response with the web server device identifying the first segment identifier; and
associating a user profile record in a user database device with the first segment identifier.

9. The method of claim 7, wherein the plurality of segment identifiers includes a quantity of segment identifiers in a range from about three to about ten.

10. The method of claim 7, wherein generating web page data further comprises generating a media page associated with a media item, the media page including a first segment rating display, the first segment rating display being associated with feedback received from users that are also associated with the first segment identifier.

11. The method of claim 10, wherein the media page further includes a composite rating display, the composite rating display being associated with feedback received from users associated with any of the plurality of segment identifiers.

12. The method of claim 11, wherein generating web page data further comprises:
determining that the first segment identifier is associated with the user;
retrieving from a database a first content associated with the first segment identifier; and
wherein generating web page data comprises generating a web page including the first content.

13. The method of claim 12, wherein the database is an inspiration database storing content including a collection of images and text-based messages.

14. The method of claim 12, wherein the database is a database of advertisements.

15. A method of distributing media items across a network, the method comprising:
packaging a plurality of media items into a single file as a kit, the plurality of media items including a first media item from a first publisher and a second media item from a second publisher;
generating a web page with a web server, the web page including information about the kit;
receiving payment information from a user to purchase the kit with a payment processing module;
sending the kit after receiving payment with a download module; and
making royalty payments to the first publisher and to the second publisher with a royalty payment module.

16. The method of claim 15, wherein the plurality of media items include a first media item having a first type and a second media having a second type, and wherein the first type is not the same as the second type.

17. The method of claim 16, wherein the first type is a media type selected from the group consisting of: music, video, photo, document, spoken word, and podcast.

18. A method of identifying a media item, the method comprising:
storing a plurality of media items in a media database device;
associating Catholic identifiers with the plurality of media items in the media database device;
prompting a user to select at least one of the plurality of Catholic identifiers from a list of the plurality of Catholic identifiers;
receiving the input; and
searching through the plurality of media items in the media database device to locate media items associated with the input by comparing the input to the plurality of Catholic identifiers associated with the plurality of media items.

19. The method of claim 18, further comprising prompting a user to enter a key word, wherein searching through the plurality of media items comprises searching in a metadata field associated with the input for the keyword.

20. The method of claim 18, wherein the plurality of Catholic identifiers are selected from the group consisting of: liturgical date, Bible reference, Catholic catechism, Catholic feast, liturgical reading, Catholic mass, type of Catholic mass, sacrament, and Catholic season
